(19) United States
(12) Patent Application Publication
(10) Pub. No.: US 2011/0104327 A1
(43) Pub. Date: May 5, 2011

(54) PROBIOTIC PET FOOD

(75) Inventor: Vygantas Kirejevas, Tallinn (EE)

(73) Assignee: Bacterfield International S.A., Luxembourg (LU)

(21) Appl. No.: 12/869,725

(22) Filed: Aug. 26, 2010

Related U.S. Application Data
(63) Continuation-in-part of application No. PCT/EP2010/055346, filed on Apr. 22, 2010.
Application No. PCT/EP2010/055346 is a continuation-in-part of application No. PCT/EP2010/055353, filed on Apr. 22, 2010.
Application No. PCT/EP2010/055353 is a continuation-in-part of application No. PCT/EP2010/055461, filed on Apr. 23, 2010.
(60) Provisional application No. 61/237,597, filed on Aug. 27, 2009.

(30) Foreign Application Priority Data
Apr. 23, 2009 (EP) 09158590.1
Apr. 23, 2009 (EP) 09158592.7
Apr. 23, 2009 (EP) 09158595.0

(51) Int. Cl. A23K 1/16; A23K 1/18; B65B 3/04

(52) U.S. Cl. 426/2; 426/61; 141/99

(57) ABSTRACT

A pet food including a mixture of at least one probiotic micro-organism and oil, wherein the pet food is vacuum coated with said mixture, a production plant for making the same, and methods of making and using the same are provided.

### CROSS-REFERENCE TO RELATED APPLICATIONS

This application is a continuation-in-part of, and claims the benefit of priority to PCT Application No. PCT/EP2010/055346, filed Apr. 22, 2010, which was written in English and designated the United States of America, and which claims priority to European Patent Application No. EP09158590.1, filed Apr. 23, 2009; this application is also a continuation-in-part of, and claims the benefit of priority to PCT Application No. PCT/EP2010/055353, filed Apr. 22, 2010, which was written in English and designated the United States of America, and which claims priority to European Patent Application No. EP09158592.7, filed Apr. 23, 2009; this application is also a continuation-in-part of, and claims the benefit of priority to PCT Application No. PCT/EP2010/055461, filed Apr. 23, 2010, which was written in English and designated the United States of America, and which claims priority to European Patent Application No. EP09158595.0, filed Apr. 23, 2009; and this application claims the benefit of priority to U.S. Provisional Application No. 61/237,597, filed on Aug. 27, 2009. All of the aforementioned applications are hereby expressly incorporated by reference in their entireties.

### FIELD OF THE INVENTION

Aspects of the present invention pertain to pet food that contains a mixture of probiotic micro-organisms and oil. Methods of making and using the aforementioned pet food are also embodiments and, in some aspects, the probiotic micro-organisms, desirably freeze-dried, are mixed with fish oil and conventional pet food is vacuum coated with the mixture in a sealed environment under the pressure of 1 bar or less.

### BACKGROUND OF THE INVENTION

The well-being of domestic animals is closely related to their feeding. Correct feeding should result in a fit and healthy pet. In addition to providing nutritional value, food composition influences the intestinal microflora equilibrium and may lead to or prevent gastrointestinal disorders. Therefore, knowledge on the gastro-intestinal tract and digestion processes of healthy animals is integral to the understanding of a practical feeding practice. As carnivores, cats and dogs are e.g. characterized by a short digestive tract and a rapid flow rate of the bolus of food.

The number and composition of this endogenous flora tend to be rather stable, although age and, to a lesser degree, food may modify it. Gastric acidity, bile, intestinal peristalsis and local immunity are factors thought to be important in the regulation of bacterial flora in the small intestine of human beings and various other mammals. Often canine and feline gastrointestinal disorders are linked to bacterial overgrowth and the production of enterotoxins produced by pathogenic bacteria.

### The Microflora

All animals are born with a relatively sterile gut. Thus the newly born animal will be more easily colonised by pathogenic micro-organisms as there is no protective microflora to reduce the colonisation of pathogens at this stage of life.

Soon after birth the newly born animal acquires a complex collection of micro-organisms, which populate its intestinal tract. This collection of micro-organisms is referred to as the microflora. The gut microflora contains a variety of different bacteria and fungi of which there are typically ˜400 different types of micro-organisms with a total population of ˜10¹⁴ throughout the length of the intestinal tract.

### Location in the Digestive System

This complex collection of gut micro-organisms is distributed throughout the whole length of the gut. Within particular regions the organisms may be found in three niches:

(a) associated with gut wall. This can either take the form of direct attachment to the epithelium, as in the case with lactobacilli in the crop, or entrapment in the mucous layer of the epithelium, as happens in the caecum;

(b) attachment to food particles; or

(c) suspension in the liquid phase of the gut contents.

### Composition

The composition of the flora varies in different regions of the intestine and is dependent on factors such as pH. The small intestine tends to be dominated by lactobacilli with smaller numbers of other facultative anaerobes such as coliforms and streptococci. The posterior regions of the gut have large numbers of obligate (able to exist under only one set of environmental conditions) anaerobic bacteria. The caecum in particular is favourable for the growth of anaerobes such as clostridia and bacteroides.

The microflora that develops in the dog's intestinal tract is characteristic for that species, which has evolved a symbiotic association with the host. This applies particularly to the caecal microflora.

### Role of Gut Flora in Digestion

The microflora forms a symbiotic relationship with the host and benefits the host by aiding digestion by producing various enzymes, which are involved in the digestion/breakdown of large feed particles/polysaccharides such as cellulose.

The bacteria in the gut can also stimulate an immune response. For example, germfree animals have lower levels of gamma-globulin than do conventional animals with a complete gut flora.

The use of antibiotics can adversely affect the gut flora. When antibiotics are used, as a treatment for clinical disease, a proportion of the beneficial micro-organisms becomes disrupted and can lead to an increased susceptibility of the gut to colonisation of pathogenic bacteria. The consequent reduction in disease resistance is manifested by an increased vulnerability to salmonella and other pathogens colonisation of the gut, which may lead to diarrhea.

There is also strong evidence that stress can affect the composition of the gut microflora. Stress can be described as a factor that stimulates homeostatic, physiological and behavioural responses in excess of the norm. The only accepted measure of the presence or absence of stress is the blood level of adrenal corticosteroids, which becomes raised during stress and which effects the peristaltic movement of the gut and the production of mucus within the gut. Stress also affects the intestinal microflora by reducing the concentration of lactobacilli and other Lactic Acid Bacteria (LAB) and increasing the concentrations of coliforms such as E. coli.

All stressful situations to which an animal is exposed contribute towards an increased intestine pH (more alkaline), the gastrointestinal tract is likely to favour the development of pathogenic species such as E. coli at the expense of beneficial species. Vaccination, antibiotic therapy, weaning, travel, rehousing or illness are a few of the factors that are considered to be stresses that may result in a change of balance of gut flora in favour of pathogenic species. Stress is also known to alter the protease content of saliva. As a result fibronectin and the autochthonous (commensal) bacterial population are lost from the oropharyngeal surface in stressed individuals. This autochthonous population is then rapidly replaced by a biofilm composed largely of Pseudomonas aeruginosa.

Stress can depress the immune response of animals and humans and some antibiotics have been shown to depress the immune response significantly leading to a reduction in weights of the spleen and thymus. Withdrawal of the antibiotics in these cases can lead to the restoration of gut flora and a return to immune function. Antibiotics can also often reduce the lactobacilli population. Hence animals enduring stress exhibit alterations and breakdown of the regulatory mechanism in the gastrointestinal tract ecosystem allowing easier establishment of pathogens within the tract.

### Probiotics

Dr Roy Fuller defined a probiotic as a live microbial feed supplement, which beneficially affects the host animal by improving its intestinal microbial balance (Fuller, 1989). This definition emphasises the importance of live cells as essential components of probiotics. Probiotics are a category of functional food including non-digestible food ingredients that beneficially affect the host by selectively stimulating the growth and/or activity of one or a limited number of bacteria in the colon, and thus improve host health (Gibson and Roberfroid, 1995).

The word probiosis originated from Greek: pro (for) and biosis (life), and is therefore opposite in meaning to antibiosis, promoting the proliferation of bacterial species within the gastrointestinal tract. Probiosis is defined as ‘the property of the normal adult flora to resist the overgrowth of component strains and the establishment of foreign strains’ and is reinforced or re-established by probiotics. The concept of probiotics applied to preventative medicine is claimed to have originated from Metchnikoff. He postulated that the longevity observed in the Balkan people was due to the regular consumption of soured milk containing Lactobacillus bulgaricus.

The gut of the newly born animal is relatively sterile and is therefore deficient in the micro-organisms, which normally populate the gut and provide resistance to disease. The intervention of a probiotic supplement establishes the gut microflora.

Probiotics have been shown to work by the following mechanisms:

### Competition for Nutrients

Within the gut, beneficial as well as pathogenic micro-organisms will be utilising the same types of nutrients. Thus, there will be a general competition for these nutrients to grow and reproduce. Hence, the more the gut is flooded with beneficial micro-organisms, the more competition is created between beneficial and pathogenic micro-organisms.

### Competition for Adhesion Sites

Adhering to adhesion sites along the wall of the gut is an important colonisation factor and many intestinal pathogens rely on adhesion to the gut wall to prevent them being swept away by peristaltic of food along the intestinal tract. Additional features include stimulation of immunity, stimulation of antibody production (local and systemic), increased macrophage activity, increased gamma interferon levels, and have direct antimicrobial effect.

This competition can either operate via bacteriocins, which are known to be produced by many species of lactic acid bacteria or by the production of organic acids, which can either have a direct effect or operate by reducing the pH.

### Improvement in Digestion

Probiotic micro-organisms act like and add to the healthy microflora by producing enzymes, which aid the breakdown of polysaccharides molecules and hence utilise more nutrients form the diet. The microflora also produces vitamins, which supply a secondary source to the host.

To produce the desirable effect, a minimum concentration of micro-organisms must be able to survive ingestion and grow in the intestine. However, the minimum effective dose of live bacteria cannot be easily identified. It is believed that once the concentration of a particular microorganism fell to 10⁷ per g of faeces, it does not play a role in the ecosystem provided that it remains below this level at all times. This is supported by observations that the host animal can tolerate populations less than 10⁷ clostridia or enterobacteria per gram of intestinal contents. It is therefore postulated that a probiotic will be effective if it provides at least 10⁷ CFU (e.g., 10⁷-10⁸ CFU per animal). It is also desirable to provide a non-pathogenic and non-toxic micororganism that remains viable during storage of the product and through the gut to ensure colonisation.

Various commercial attempts have been made to achieve food compositions containing probiotic micro-organisms with prolonged viability for long term storage, however, many of these do not provide sufficient efficacious levels of viable probiotic micro-organism due to issues associated with susceptibility of the micro-organism to standard commercial pet food manufacturing procedures such as extrusion. For example, efforts of coating or filling standard pet food kibbles with probiotic micro-organisms have been attempted but, the procedures proved impractical.

WO 01/95745, for example, provides a method of producing a food product (kibbles) characterised by a porous structure, comprising an instable substrate such as a probiotic micro-organism in an oil solution, which are included in a flowable form into the product by means of a step of “partial vacuum” followed by normalizing the pressure by releasing an inert gas into the vessel, WO 05/070232 also provides a method of producing a food product similar to WO 01/95745, further characterized in that the oil should have a solid fat index of at least 20. WO 05/070232 also discloses the essential use of fat with the solid fat index of the vehicle is at least 20 at 20° C. and the preferred vehicle are coconut oil and even more preferred palm oil. WO 03/009710 further discloses a system and method for on-line mixing and application of surface coating compositions for food products; an apparatus is also disclosed. The apparatus comprises a dry matter-liquid mixing module (wherein the dry matter may be probiotics) connected inline to a liquid-liquid mixing module, wherein one or more liquid can be mixed into the first liquid (potentially comprising the probiotics).

Consequently, there is a need for development of a pet food that promotes reduction of the effects of stress, reduction of diarrhea and other digestive problems, improvement of immunity and resistance to disease, reduction of Salmonella levels, and/or improvement in digestion. Furthermore, there is a need to provide pet food compositions that have long shelf life and are able to quickly improve the faeces condition of pets. Rapid leveling of defecation and diarrhea to more neutral stool conditions is of both great health and general nutritional concern.

### SUMMARY OF THE INVENTION

In one embodiment, a pet food includes a mixture of at least one probiotic micro-organism and oil, wherein the pet food is vacuum coated with the mixture.

In one aspect, the probiotic micro-organism is freeze dried. In another aspect, the at least one probiotic micro-organism includes Enterococcus faecium or Saccharomyces cerevisiae. In the same aspect, the Saccharomyces cerevisiae minimal amount of the pet food is 2.5×10⁷ CFU/Kg to 7.5×10¹⁴ CFU/Kg. Further in the same aspect, the Enterococcus faecium minimal amount of the pet food is 1.0×10⁷ CFU/Kg to 1.0×10¹⁴ CFU/Kg.

In another aspect of the aforementioned embodiment, the mixture is a suspension including an oil and at least one probiotic micro-organism in the concentration of 10⁶-10¹⁶ CFU/kg of the oil, and the suspension having a dynamic viscosity of less than 0.08 pascal-second (Pa·s) at 20° C.

In an additional aspect, the oil is a fish oil selected from the group consisting of mackerel, lake trout, herring, sardine, salmon, and albacore tuna oil. In the same aspect, the fish oil is heated to 20° C. to 25° C.

In another embodiment, a method of making the pet food of the aforementioned embodiment includes mixing the at least one probiotic micro-organism with the oil and vacuum coating the conventional pet food with the mixture. In one aspect, the oil is heated to 20° C. to 25° C. prior to mixing. In the same aspect, the coating is carried out in a sealed environment under the pressure of 1 bar or less.

In a further embodiment, a production plant for making the pet food of the aforementioned embodiment includes a first storage tank for storing the mixture of the aforementioned embodiment as a first solution, the first storage tank being connected to a first dosage tank for dosing the mixture of the aforementioned embodiment; and a second storage tank for storing a second solution, the second storage tank being connected to a second dosage tank for dosing the second solution, wherein the first dosage tank and the second dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

In one aspect, the production plant further includes at least a third storage tank for storing a solution, the third storage tank being connected to a third dosage tank for dosing the third solution through one or more spraying nozzles.

In another aspect, the production plant further includes at least a fourth storage tank for storing a solution, the fourth storage tank being connected to a fourth dosage tank for dosing a solution through one or more spraying nozzles.

In a further aspect, the orifice of each of the spraying nozzles has a cross-sectional area of 1-250 mm².

In an additional aspect, the production plant further includes a first mixing tank connected to the first storage tank through a bottom outlet in the first mixing tank, wherein the mixture is capable of being passed from the first mixing tank to the first storage tank by gravity. In the same aspect, the connection between the first mixing tank and the first storage tank does not include a vacuum suction unit.

In an additional embodiment, a method of managing defecation in a dog includes providing the dog with the pet food of the aforementioned embodiments. In one aspect, the feces condition of the dog is changed to score 3 or 4 of the PURINA feces scoring system. In another aspect, the change in feces consistency is reached in less than 14 days.

### BRIEF DESCRIPTION OF THE DRAWINGS

FIG. 1 provides a graph indicating the stability of product.

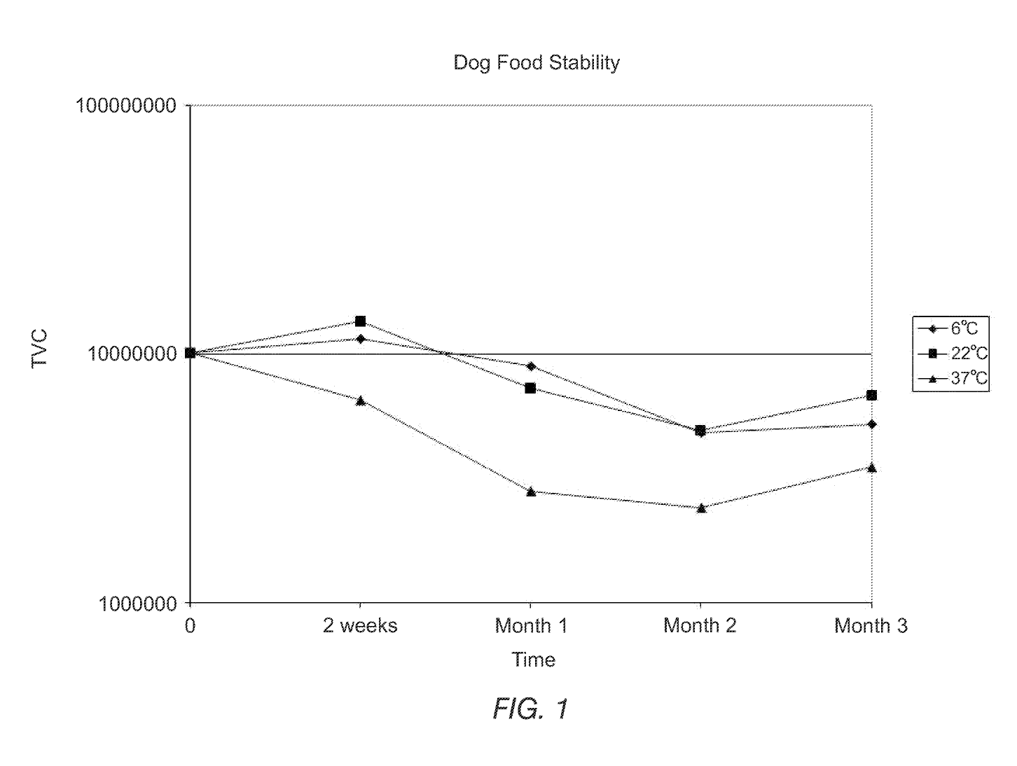

FIG. 2 indicates viscosity of selected oil types vs temperature. The viscosity was measured using a rheometer. Delta viscosity between 20° C. and 25° C. is indicated. For further details see Example 3.

FIG. 3 displays the viscosity of selected oil types versus temperature within the temperature interval of 20-25° C. 1: Crude fish oil, 2: Salmon oil A, 4: Cod liver oil, 5: Salmon oil B. For further details see Example 3.

FIG. 4 shows the viscosity of selected oil types versus temperature within the temperature interval of 20-25° C.

FIG. 5 shows the viscosity of selected vegetable oil types versus temperature within the temperature interval of 20-25° C.

FIG. 6 shows the viscosity of linseed oil versus temperature within the temperature interval of 15-35° C.

FIG. 7 shows the viscosity of salmon oil A with (susp) or without (raw oil). Suspension comprises probiotics at a concentration/inclusion rate 1.2 kg/ton of final product. Data are shown for an increasing temperature from 5 to 50° C. (arrow pointing to the right) and for a decreasing temperature from 50 to 5° C. (arrow pointing to the left). Exact data points are indicated in FIG. 2 (see also Example 7).

FIG. 8 shows one embodiment of the invention illustrating tanks, vessels connections and the like which may form part of the production plant according to the invention.

FIG. 9 shows one embodiment of the invention illustrating tanks, vessels connections and the like which may form part of the production plant according to the invention.

FIG. 10 shows the Purina score system. FIG. 10A-G corresponds to a Purina score of 1-7, respectively.

FIG. 11 shows a Bristol Stool Chart. The Bristol Stool Chart uses a scoring system that is similar to the Purina score with type 1-7.

FIG. 12 shows the Purina score of dog no. 1—Elodi during the 5 week testing period.

FIG. 13 shows the Purina score of dog no. 2—Galicia during the 5 week testing period.

FIG. 14 shows the Purina score of dog no. 3—Georges during the 5 week testing period.

FIG. 15 shows the Purina score of dog no. 4—Esteban during the 5 week testing period.

FIG. 16 shows the Purina score of dog no. 5—Doyka during the 5 week testing period.

FIG. 17 shows the Purina score of dog no. 6—Grisa during the 5 week testing period.

FIG. 18 shows the Purina score of dog no. 7—Gripala during the 5 week testing period.

FIG. 19 shows the Purina score of dog no. 8—Weimie during the 5 week testing period.

### DETAILED DESCRIPTION OF THE PREFERRED EMBODIMENT

In some contexts, the term “suspension” refers to a fluid (such as an oil) containing particles that will not dissolve in the fluid and are sufficiently large for sedimentation such as freeze dried micro-organisms. A homogenous suspension refers to a suspension, wherein the particles are dispersed throughout the external phase (the fluid) through mechanical agitation (such as mixing). The suspended particles (e.g. micro-organisms) are visible under a microscope and will settle over time if left undisturbed. It is to be understood that an oil vehicle is also a suspension comprising probiotics.

In some embodiments, the oil may be any edible vegetable and animal oils or a combination of at least one edible vegetable and one edible animal oils. Accordingly, in one embodiment the oil is selected from the group consisting of vegetable oils and animal oils or a combination thereof. Animal oils include fish oil. In a further embodiment, the oil is selected the group consisting of vegetable oils and fish oils. In embodiment of the present invention the oil is a fish oil. The fish oils in the context of the present invention include but are not limited to salmon oil, mackerel oil, lake trout oil, herring oil, sardine oil, albacore tuna oil, cod liver oil, sand eel oil (Ammodytes tobianus), and menhaden oil. Thus, in an embodiment, the fish oil can be selected from the group consisting of salmon oil, mackerel oil, lake trout oil, herring oil, sardine oil, albacore tuna oil, cod liver oil, sand eel oil (Ammodytes tobianus), and menhaden oil. In a further embodiment, the fish oil is salmon oil. The oil may be refined oil, a crude oil or a mixture of oils. Thus, in one embodiment the oil is crude fish oil.

The source of the oil may also be suitable vegetable oils. Thus in one embodiment, the oil is a vegetable oil, such as oil of flax or flax seed (commonly known as linseed). In another embodiment, the oil is selected from linseed oil, olive oil, borage oil, lin oil, camelina oil, grape seed oil, chia oil, kiwifruit seeds oil, perilla oil, lingonberry, purslane oil, seabuckthorn oil, hemp oil, refined maize oil, soy bean oil, sunflower oil. In a further embodiment, the oil is linseed oil. Linseed oil has unique viscosity properties, as described in the present application, which may make it a unique oil vehicle.

In the context of the present invention the term “oil” can also refer to any edible vegetable and/or animal oils. Oil in the context of the present invention is in a viscous liquid state (“oily”) at room temperature. Oil includes “fatty acids”, which are carboxylic acids often with a long un-branched aliphatic tail (chain), which is either saturated or unsaturated (such as monounsaturated or polyunsaturated). The ratio of saturated to unsaturated fatty acids varies among oils. For example, flaxseed oil comprises 9% of saturated fatty acids, 18% mono-unsaturated fatty acids, and 73% of polyunsaturated fatty acids. In contrast, coconut oil comprise 91% saturated fatty acids, 7% mono-unsaturated fatty acids, and 2% poly-unsaturated fatty acids. For dietary application, oils rich in unsaturated fatty acids are highly preferred due to the health benefits of the unsaturated fatty acids over the saturated fatty acids. Thus, in order to sustain the key health benefits and features of the food product, the products described in this invention preferably comprises a high level of unsaturated fatty acids. Fish oils fall within the definition of oil. Fish oils include but are not limited to salmon oil, mackerel oil, lake trout oil, herring oil, sardine oil, albacore tuna oil, cod liver oil, sand eel oil (Ammodytes tobianus), and menhaden oil.

The term “omega-3 fatty acids” are a family of unsaturated fatty acids that have in common a final carbon-carbon double bond in the n−3 position; that is, the third bond from the methyl end of the fatty acid. Examples of important nutritionally essential omega-3 fatty acids are α-linolenic acid (ALA), eicosapentaenoic acid (EPA), and docosahexaenoic acid (DHA). The term “omega-6 fatty acids” are a family of unsaturated fatty acids, which have in common a final carbon-carbon double bond in the n−6 position; that is, the sixth bond from the end of the fatty acid. Examples of omega-6 fatty acids are linoleic acid and arachidonic acid.

In some contexts, the term “vehicle” or “carrier” refer to a fluid component (such as an oil) that carries at least one substance. In some embodiments, an oil is used as vehicle for vacuum infusion of at least one probiotic micro-organism into an extruded food product. The vehicle may have the additional function of preserving the at least one probiotic micro-organism embedded in the extruded food product. Accordingly, at least one oil used in some embodiments functions as a vehicle for infusion of probiotic micro-organisms in the manufacturing of an extruded food product. The manufacturing is performed at room temperature in order to optimize the probiotic count (CFU) in the final food product. In this respect the viscosity properties of the oil (e.g. dynamic viscosity) influence whether or not the oil is suitable for the vacuum infusion of the food product. Oils having an optimal viscosity at a temperature above room temperature may not be applicable at room temperature due to the change in viscosity.

The term “viscosity” refers a measure of the resistance of a fluid which is being deformed by either shear stress or extensional stress. In everyday terms (and for fluids only), viscosity is “thickness”. The coefficient of viscosity is most often used as a value for viscosity. The shear viscosity and dynamic viscosity are most frequently used. “Dynamic viscosity” (or absolute viscosity) is a unit of measuring viscosity. The SI physical unit of dynamic viscosity is the pascal-second (Pa·s), which is identical to kg·m⁻¹·s⁻¹. If a fluid with a viscosity of one Pa·s is placed between two plates, and one plate is pushed sideways with a shear stress of one pascal, it moves a distance equal to the thickness of the layer between the plates in one second. The cgs physical unit for dynamic viscosity is the poise. It is more commonly expressed, particularly in ASTM standards, as centipoise (cP). The relation between poise and pascal-seconds is: 1 cP=0.001 Pa·s=1 mPa·s. Water at 20° C. has a viscosity of 1.0020 cP. Dynamic viscosity is measured with various types of rheometer, for example Physica MCR 301 as used in Example 3. The temperature dependence of the viscosity of the fluid is the phenomenon by which fluid viscosity generally decrease (or, alternatively, its fluidity generally increases) as its temperature increases. Thus, close temperature control of the fluid is essential to accurate measurements, particularly in materials like lubricants, whose viscosity can double with a change of only 5° C. The dynamic viscosity referred to in the context of the present invention is the dynamic viscosity at 20° C. if noting else is stated. In the context of the present invention, the change in dynamic viscosity of an oil is expressed as ΔPa·s/° C. Alternatively, the change in dynamic viscosity of an oil is described as the difference between the dynamic viscosity at 25° C. and 20° C. (Pa·s at 25° C.−Pa·s at 20° C.=ΔPa·s). The term “viscosity” as used herein also refers to the resistance of a fluid which is being deformed by either shear stress or extensional stress. In everyday terms (and for fluids only), viscosity is “thickness”. The SI physical unit of dynamic viscosity is the pascal-second (Pa·s), which is identical to kg·m−1·s−1.

The term “room temperature” or (also referred to as ambient temperature) is denoting the temperature within enclosed space at which humans are accustomed. The room temperature (RT) can be defined by the range of 5° C. to 30° C., for example (such as, at least, equal to, or any number in between, 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., or 30° C.).

The term “Solid fat index” (SFI) is used herein (SFI) is a measure of the percentage of fat in crystalline (solid) phase to total fat (the remainder being in liquid phase) across a temperature gradient.

The best test for autoxidation (oxidative rancidity) is a determination of the “peroxide value”. Peroxides are intermediates in the autoxidation reaction. The number of peroxides present in edible fats and oils is an index of their primary oxidative level and consequently of its tendency to go rancid. The lower is the peroxide value, the better is fat or oil quality and its status of preservation. Other methods are available but peroxide value is the most widely used. The double bonds found in fats and oils play a role in autoxidation. Oils with a high degree of unsaturation are most susceptible to autoxidation. Autoxidation is a free radical reaction involving oxygen that leads to deterioration of fats and oils which form off-flavours and off-odours. Peroxide value, concentration of peroxide in an oil or fat, is useful for assessing the extent to which spoilage has advanced. The peroxide value is defined as the amount of peroxide oxygen per 1 kilogram of fat or oil. Typically this is expressed in units of milliequivalents (mequiv or meq). If SI units are used the appropriate unit is millimoles per kilogram (1 millimole=2 milliequivalents). The peroxide value of the oil also affects the preservation of the probiotic organism for which the oil is used as vehicle in the vacuum inclusion of the probiotic organism in an extruded food product. An oil with a low peroxide value is preferred as vehicle due to the better probiotic preservative properties over an oil with a higher peroxide value.

The term “preservative” refers to a natural or synthetic substance that is added to the food product to preserve the product. “Probiotic preservative” refers to a substance that preserves the probiotic organism in the sense of the ability of the organism to establish and populate the gastro-intestinal system of the host (e.g. a human being or an animal such as a pet animal). The preservation is reflected in the colony-forming unit (CFU) of the final food product and/or the sustained CFU of the final food product over time of storage.

The term “antioxidant” refers to a substance capable of slowing or preventing the oxidation of other substances. Antioxidants are frequently used as food additives to reduce food deterioration. Both synthetic and natural antioxidants are used. Natural antioxidants have been identified among a wide range of classes of compounds such as flavanoids, cartonoids, tocotrienol, tocopherol and terpenes (such as astaxanthin). In one embodiment of the invention the synthetic antioxidant is selected from the group consisting of BHA and BHT and natural antioxidant is selected from the group consisting of Vitamin E flavonoids, and polyphenolics. The natural antioxidant may be provided in the form of an extract for example rosemary or grape seed extracts (comprising resveratrol).

The term “colony-forming unit (CFU)” is a measure of the number viable bacterial or fungal organisms. Unlike in direct microscopic counts where all cells, dead and living, are counted, CFU measures viable cells. CFU is typically given in CFU per unit of the matter comprising the CFU. Thus, CFU is typically given in CFU/l or CFU/g of matter comprising the colony-forming unit. The CFU of a matter is typically assessed by suspending a known amount of the matter in a suitable liquid. The liquid may subsequently be subjected to further dilution, which is used for inoculation in a suitable growth media such as plates of clear nutrient agar or a suitable alternative. The number of colonies formed on a nutrient agar after e.g. 24 hour incubation may be used to calculate the CFU of the matter in question.

The terms “extrusion” or “extruded” refers to “cooking extrusion,” which is a combination of heating of food products with the act of extrusion to create a cooked and shaped food product and is a process in which moistened, starchy, proteinaceous foods are cooked and worked into a viscous, plastic-like dough. The results of cooking the food ingredients during extrusion may be: 1) gelatinization of starch, 2) denaturation of protein, 3) inactivation of raw food enzymes, 4) destruction of naturally occurring toxic substances, and 5) diminishing of microbial counts originating from the pre-extruded product. Upon discharge through the die, the hot, plastic extrudate expands rapidly with loss of moisture and heat because of sudden decrease in pressure. After expansion cooling, and drying, the extruded product develops a rigid structure and maintains a porous texture. A further object of the extrusion is to eliminate any bacteria present in the ingredients.

The term “density” of a material is defined as the mass of the material per unit volume (g/L).

The term “food product” as used herein refers to any food product to which the beneficial function of probiotics is wished to be added. For example, it may be a breakfast cereals, pet food, treats. However, it may be any food, intended for any humans and/or animals. For example, the food product may be a particulate food or food ingredient, such as extruded snack products, tortilla chips, breakfast cereal, cookies, crisp bread, food foams, Rice brokens, blend of peanut, soybean and corn, puffed wheat, low density foamed corn and rice breakfast, Co-extruded products, muesli bars and any other extruded products that are formed by extrusion process. “Pet food” in the context of the present invention refers to food products obtained by methods of extrusion. For example, a food kibble such as a dog food kibble.

As used herein refers kibble to pellets of dry dog food that are produced by one of two methods, extrusion and baking. During the extrusion process, cut dough or a mixture of raw materials is fed into an expander, while pressurized steam or hot water is added. When removed from the high pressure that results, the pellets puff up like popcorn. The resultant kibble is allowed to dry, and is then sprayed with vitamins, fats and oils, or any other ingredients that are not heat-tolerant. The exact procedure for the production of kibble can vary according to the desired product.

The term “pet” refers to an animal kept for companionship and enjoyment or a household animal, as opposed to livestock, laboratory animals, or working animals, which are kept for economic reasons. Term pet in this document as used includes Dogs, Cats, Rabbits, other Rodents and companion Horses, including all ages and breeds of these animals. Accordingly, pet food is a food product intended for consumption by a pet, such as dog food, cat food, rabbit food, rodent food, and horse food.

The term “probiotic” or “probiotic micro-organism” as used herein is defined as a live microbial feed supplement which beneficially affects the host animal by improving its intestinal microbial balance. The probiotic micro-organism may be in an ametabolic state of life such a cryptobiosis (e.g. anhydrobiosis) as a consequence of cryopreservation (such as freeze-drying). However, the probiotic micro-organism will revert into a metabolic state of life when exposed to an environment enabling the metabolic state of life. Accordingly, a dead organism such as a dead micro-organism does not fall within the definition of a probiotic organism due to the fact that it is not capable of populating and the improving the intestinal microbial balance of the host in question.

A probiotic bacteria refers to a bacteria with probiotic properties. Non-limiting examples of suitable probiotic micro-organisms include yeasts such as Saccharomyces, Debaromyces, Candidaw Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. casei L. curvatus, L. cellobiosus, L. delbrueckii ss. bulgaricus, L farciminis, L. fermentum, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, Strep. lactis.

As used herein, the term “shelf life” refers to that property of the products of the invention whereby about 1% or more, alternatively about 5% or more, alternatively about 10% or more, alternatively about 25% or more, alternatively about 50% or more, alternatively about 75% or more, of the probiotic micro-organisms are viable (see also definitions of CFU) at the referenced time period after exposure to ambient environmental conditions (e.g., at least, equal to, more than, or any number in between 1, 5, 10, 15, 20, 25, 30, 35, 30, 45, 50, 55, 60, 65, 70, 75, 80, 85, 90, 95 percent viability). The shelf life of the products of the invention is 6-36 month, such as 6-24 month, such as 9-20 month, and such as 12-16 month (e.g., at least, equal to, more than, or any number in between 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, or 36 months). The probiotic comprising products of the invention may also have a superior shelf-life. Thus, in an embodiment of the invention the count of at least one probiotic in the food product is about 10⁴-10¹⁶ CFU/kg, such as 10⁵-10¹⁶, such as about 10⁶-10¹⁶, such as about 10⁷-10¹⁶, such as about 10⁷-10¹⁴, such as about 10⁷-10¹², such as about 10⁷-10¹⁰ or such as about 10⁸-10¹⁰ CFU/kg after at least 3 month after the date of manufacturing. In another embodiment of the invention the count of at least one probiotic in the food product is about 10⁴-10¹⁶ CFU/kg, such as about 10⁵-10¹⁶, such as about 10⁶-10¹⁶, such as about 10⁷-10¹⁶ such as about 10⁷-10¹⁴, such as about 10⁷-10¹², such as about 10⁷-10¹⁰, or such as about 10⁸-10¹⁰ CFU/kg after at least 6 month after the date of manufacturing. In a further embodiment of the invention the count of at least one probiotic in the food product is about 10⁴-10¹⁶ CFU/kg, such as about 10⁵-10¹⁶, such as about 10⁶-10¹⁶, such as about 10⁷-10¹⁶, such as about 10⁷-10¹⁴, such as about 10⁷-10¹², such as about 10⁷-10¹⁰, or such as about 10⁸-10¹⁰ CFU/kg after at least 10 month after the date of manufacturing. In yet a further embodiment of the invention the count of at least one probiotic in the food product is about 10⁴-10¹⁶ CFU/kg, such as about 10⁵-10¹⁶, such as about 10⁶-10¹⁶, such as about 10⁷-10¹⁶, such as about 10⁷-10¹⁴, such as about 10⁷-10¹², such as about 10⁷-10¹⁰, or such as about 10⁸-10¹⁰ CFU/kg after at least 15 month after the date of manufacturing. In an additional embodiment of the invention the count of at least one probiotic in the food product is about 10⁴-10¹⁶ CFU/kg, such as about 10⁵-10¹⁶, such as about 10⁶-10¹⁶, such as about 10⁷-10¹⁶, such as about 10⁷-10¹⁴, such as about 10⁷-10¹², such as about 10⁷-10¹⁰, or such as about 10⁸-10¹⁰ CFU/kg after at least 20 month after the date of manufacturing. In one embodiment, the minimal amount of the probiotic in the product is in the range of about 10⁵ CFU/Kg to 10¹⁵ CFU/Kg, such as about 1×10⁹ CFU/Kg to about 7.5×10¹¹, such as about 2.5×10⁹ CFU/Kg to about 7.5×10¹¹. That is, in some embodiments, the count of at least one probiotic in the food product is about at least, equal to, or any number in between about 10⁴-10¹⁶ CFU/kg for 3, 6, 9, 12, 15, 18, 21, or 24 months after the date of manufacturing (e.g., at least, equal to, or any number in between about 10⁴, 10⁵, 10⁶, 10⁷, 10⁸, 10⁹, 10¹⁰, 10¹¹, 10¹², 10¹³, 10¹⁴, 10¹⁵, or 10¹⁶ CFU/kg for 3, 4, 5, 6, 7, 8, 9, 10, 11, 12, 13, 14, 15, 16, 17, 18, 19, 20, 21, 22, 23, or 24 months after the date of manufacturing).

In another embodiment, the product % moisture is above 7%, preferably 8-10% (for example, at least, equal to, or any number in between about 7, 8, 9, or 10%). It is to be understood that these counts may achieved following standard storing conditions (shelf-life) known to the person skilled in the art.

In a more specific embodiment is the change in feces consistency or condition is achievable 12 months after the production date of the kibble. The pet food product of the present invention will even be stable for at least 24 months (e.g., at least, equal to, or any number in between about 3, 4, 5, 6, 7, 8, 9, 10, 11, 12, 13, 14, 15, 16, 17, 18, 19, 20, 21, 22, 23, or 24 months), at needed concentration to achieve sufficient levelling of score 3 and 4 of the PURINA faeces scoring system. In a even more specific embodiment is the change in faeces consistency or condition is achievable at least 10 months, such as at least 9 months, such as at least 8 months, such as at least 7 months such as at least 6 months such as at least 5 months such as at least 4 months such as at least 3 months, such as at least 2 months such as at least 1 month after the production date of the kibble. The consistency and condition of faeces refers to the general state of the dog's defecation. Central elements in a dog's consistency and condition are the visual characteristics—these can be evaluated in scoring systems, which are discussed below.

Refrigerated conditions refer to the conditions that apply to a conventional refrigerator. A refrigerator should stay at 5° C. or less. At a temperature of 5° C. or less is important because it slows the growth of most bacteria. The temperature will not kill the bacteria, but it will keep them from multiplying. Hence, if a product is not kept at refrigerated conditions bacteria can possibly grow in the product. This can have both dramatic and positive effects depending on the product and the bacteria. In an embodiment of the present invention is the kibble stored under refrigerated conditions. In an even more specific embodiment of the present invention is the kibble not stored under refrigerated conditions.

The term “vacuum infusion” refers to inclusion of a substance and dispersion of the substance throughout the body of an object by means of vacuum. For example, vacuum infusion may be infusion of a suspension (comprising a vehicle and at least one probiotic micro-organism) in a of porous food matrices such as a pet food kibble by means of a vacuum infusion process, vacuum infusion of a fat, and vacuum infusion of a digest in e.g. a pet food product such as a pet food kibble.

Protexin is a brand of the probiotic product used in this invention due to its specific manufacturing methods (available at Probiotics International Ltd). Protexin is a highly concentrated probiotic, which contains millions of beneficial micro-organisms, which occur naturally in the gut of all healthy birds and animals. These micro-organisms colonise the immature gut or re-establish the disrupted gut, thus promoting the mechanism of competitive exclusion against potential pathogenic bacteria. The probiotics and the minimum inclusion rates used in this invention will be as follows. The probiotic strains are classed as Feed Additives under Regulation EC No. 183/2003

### Dog Food

Probiotic strain registered for use in dogs:
Enterococcus faecium NCIMB 10415 EC No. 13
Date of first entry into registration: Jul. 11, 2005
Min CFU/Kg complete feed: 1.0×10⁹
Min CFU/Kg complete feed: 1.0×10¹⁰

### Rabbit Food

Probiotic strain registered for use in rabbits:
Saccharomyces cerevisiae NCYC SC47 EC E1702
Date of first entry into registration: Jul. 11, 2005
Min CFU/Kg complete feed: 2.5×10⁹
Min CFU/Kg complete feed: 7.5×10¹⁰

Preferably, the product's longevity is tested as follows. The product longevity can be tested for Total Viable Count (TVC) to give the number of Colony Forming Units (CFU) per gram of product under the following conditions:
Refrigeration (6-8° Celsius)
Room Temperature (21+/−3° Celsius)
Accelerated temperature (37+/−1° Celsius)

The relative humidity should also be recoded. For example the relative humidity of the UK lab is the following:
Refrigeration 39% RH
Room Temperature 52% RH
Accelerated temperature 54% RH

Typically, about 40 grams of product sealed in final type of product packaging (i.e. foil sachet) is available for each monthly test as below.

| | |
|---|---|
| Refrigeration | Month 0, Months 1-24 inclusive |
| Room Temperature | Month 0, Months 1-24 inclusive |
| Accelerated temperature | Month 0, Months 1-12 inclusive |

Under the accelerated temperature, one month of accelerated stability results is equivalent to 4 months real time stability.

A Total Viable Count can be carried out ×4 for each month (and an average taken) using the methodology attached or similar. (What is important is that myristic acid is used as a diluent since this diluent ensures that the microorganisms contained within the oil component of the pellet are ‘dissolved’ sufficiently in the final product sample).

Additional details—The details of the testing should be full recorded to include:
Product packaging
Storage condition: Refrigeration (6-8° C.)
Room temperature 21° C.+/−1° C.
Accelerated testing 37+/−1° C.
Months: Refrigeration—24 months
Room temperature—24 months
Accelerated testing—12 months
All requirements in specification (to include microbiological analysis, appearance, physical properties)

By one approach, a suspension of probiotic micro-organism and oil is provided for inclusion in pet food, for example by vacuum infusion.

### Suspension of Probiotic Micro-Organism and Vehicle Oil

One aspect of the present invention relates a suspension for vacuum infusion of an extruded probiotic food product, wherein said suspension comprises an oil and at least one probiotic micro-organism in the concentration of 10⁶-10¹⁶ CFU/kg of said oil and said suspension having a dynamic viscosity of less than 0.08 pascal-second (Pa·s) at 20° C. The suspension is for use in the preparation of an extruded food product and serves as a mean of obtaining a probiotic food extruded product characterized by homogenously distribution of the probiotic micro-organisms throughout the porous matrices of the food product. Accordingly, the substances for the preparation of the suspension are carefully selected. The suspension in the final form ready for use in the manufacturing of the probiotic food extruded product will enable an efficient vacuum infusion process without interfering with the manufacturing process, such as clotting various parts of the apparatus used in the manufacturing. For example, the inventors have experienced that the use of probiotic/oil suspension may clot the fluidic system e.g. by clotting the nozzle used for spraying the suspension on the product in a vacuum coater/vacuum infusion tank. The accumulation of matter from the suspension in the system leading to clotting of the fluidics such clotting of the spraying nozzle may result in premature termination of the production in order to clean and eventually repair the line of production. One key parameter is the viscosity of the probiotic oil suspension for the vacuum infusion process. In their effort to avoid the very unfortunate terminations of the production of the manufacturing of the probiotic food extruded product, the inventors discovered the importance of the viscosity of the oil used as vehicle in the suspension. Further, the inventors discovered that although the oil may be suitable as such for vacuum infusion, the physical properties of the probiotic/oil suspension based on the oil may be different and the suspension may not be suitable for the vacuum infusion process due to a suboptimal viscosity.

The probiotic/oil suspension of the invention comprises at least one oil and at least one probiotic micro-organism. In one embodiment, the suspension comprises additionally at least one additive. The present invention provides a suspension comprising at least one oil and at least one probiotic micro-organism for application in a vacuum having a dynamic viscosity of less than 0.08 pascal-second (Pa·s) at 20° C.

### Properties of Oil Used in the Suspension

### Dynamic Viscosity of the Vehicle Oil

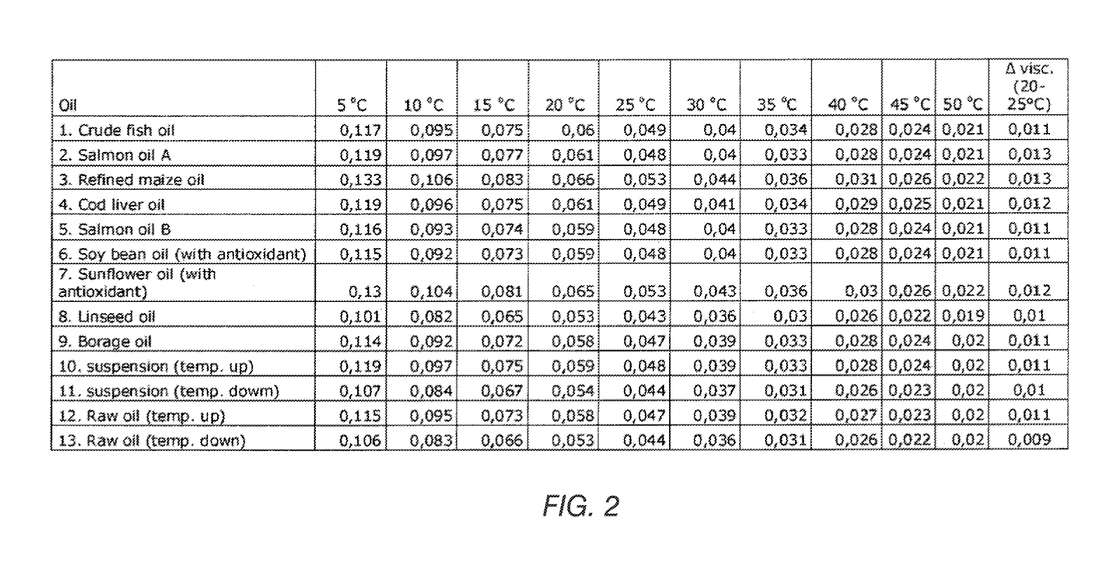

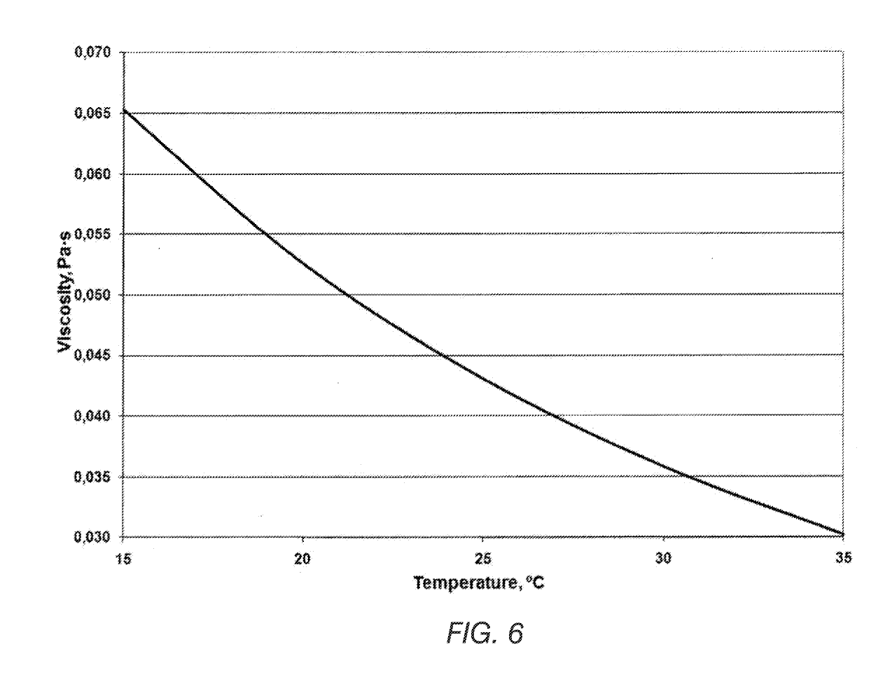

The oil component of the suspension serves the purpose of a vehicle. In one embodiment of the invention, the oil of the suspension has a dynamic viscosity of less than 0.08 pascal-second (Pa·s) at 20° C., such as less than 0.075 pascal-second (Pa·s) at 20° C., for example less than 0.070 pascal-second (Pa·s) at 20° C., such as less than 0.065 pascal-second (Pa·s) at 20° C., for example less than 0.060 pascal-second (Pa·s) at 20° C., such as less than 0.055 pascal-second (Pa·s) at 20° C., for example less than 0.050 pascal-second (Pa·s) at 20° C., such as less than 0.045 pascal-second (Pa·s) at 20° C., for example less than 0.040 pascal-second (Pa·s) at 20° C. In one embodiment, the dynamic viscosity of the vehicle oil is less than 0.060 pascal-second (Pa·s) at 20° C. An example of an oil having a viscosity at 20° C. of less than 0.060 pascal-second (Pa·s) is linseed oil (Vobra Special Petfoods BV, Netherlands) (see FIGS. 2, 4 and 6). In a further, embodiment, the dynamic viscosity of the vehicle oil within the range of 0.050 to 0.07 pascal-second (Pa·s) at 20° C., such as the range of 0.053 to 0.066 pascal-second (Pa·s) at 20° C.

Thus, in an alternative aspect the invention relates to a suspension for vacuum infusion of an extruded probiotic food product, wherein said suspension comprises an oil and at least one probiotic micro-organism in the concentration of 10⁶-10¹⁶ CFU/kg of said oil, and wherein said oil having a dynamic viscosity of less than 0.08 pascal-second (Pa·s) at 20° C. This particular aspect specifies the viscosity to the oil and not the suspension. It is to be understood that the embodiment relating to the other aspects of the invention also relate to this particular aspect.

### ΔPa·s of the Oil Vehicle Between 20° C. and 25° C.

The change in viscosity of the oil vehicle is between 20° C. and 25° C. may be an important feature. Thus, in an embodiment according to the invention the ΔPa·s between 20° C. and 25° C. of the oil vehicle is at least 0.009, such as in the range 0.009-0.05 Pa·s, such as in the range 0.01-0.05 Pa·s, such as 0.01-0.04 Pa·s, such as 0.013-0.020 Pa·s, such as in the range 0.013-0.018 Pa·s such as in the range 0.013-0.016 Pa·s. An example of an oil in these intervals is salmon oil A (see FIGS. 2, 3 and 4).

In the present context delta viscosity (ΔPa·s) is calculated by subtracting the viscosity at 20° C. from the viscosity at 25° C. Viscosity of oils is calculated using the method disclosed in Example 3.

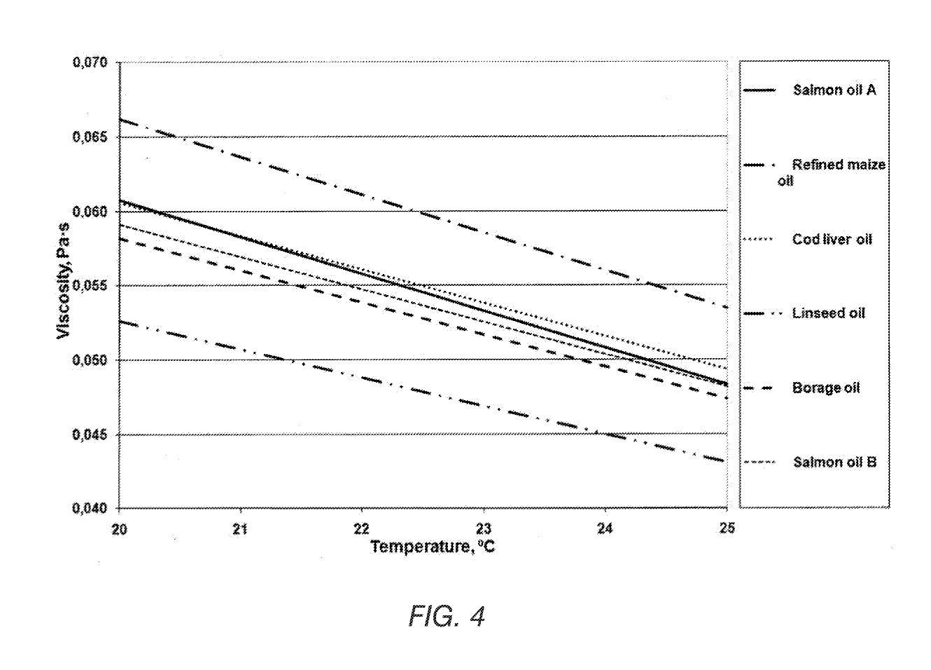

In an additional embodiment the oil vehicle has either a dynamic viscosity of less than 0.08 Pa·s or a ΔPa·s of the oil vehicle between 25° C. and 20° C. of at least 0.009 Pa·s. Examples of such oils are salmon oil A and linseed oil (see FIGS. 2 and 4).

In yet another embodiment the oil vehicle has a dynamic viscosity of less than 0.08 Pa·s and a ΔPa·s of the oil vehicle between 25° C. and 20° C. in the range 0.009-0.05 Pa·s. An example of such an oil is salmon oil A (see FIGS. 2 and 4).

It is to be understood that the intervals provided for the dynamic viscosity and the delta viscosity of the oil vehicles according to the invention also apply to the embodiments relating to the combination of the two embodiments and the embodiments which relate to an alternatives between the two embodiments.

### Classes of Oils

The oil may be any edible vegetable and animal oils or a combination of at least one edible vegetable and one edible animal oils. Accordingly, in one embodiment the oil is selected from the group consisting of vegetables oil and animal oil or a combination thereof. Animal oils include fish oil. In a further embodiment, the oil is selected the group consisting of vegetables oil and fish oil. In embodiment of the present invention the oil is a fish oil. The fish oils in the context of the present invention include but are not limited to salmon oil, mackerel oil, lake trout oil, herring oil, sardine oil, albacore tuna oil, cod liver oil, sand eel oil (Ammodytes tobianus), and menhaden oil. In one embodiment, is selected from the group consisting of salmon oil, mackerel oil, lake trout oil, herring oil, sardine oil, albacore tuna oil, cod liver oil, sand eel oil (Ammodytes tobianus), and menhaden oil. In a further embodiment, the fish oil is salmon oil. The oil may be refined oil, a crude oil or a mixture of oils. Thus, in one embodiment the oil is crude fish oil.

The source of the oil may also be suitable vegetable oils. Thus in one embodiment, the oil is a vegetable oil, such as oil of flax or flax seed (commonly known as linseed). In another embodiment, the oil is selected from linseed oil, olive oil, borage oil, lin oil, camelina oil, grape seed oil, chia oil, kiwifruit seeds oil, perilla oil, lingonberry, purslane oil, seabuckthorn oil, hemp oil, refined maize oil, soy bean oil, sunflower oil. In a further embodiment, the oil is linseed oil. Linseed oil has unique viscosity properties as described in the present application, which may make it a unique oil vehicle.

### Saturated Versus Unsaturated Fatty Acids

Oil such as vegetable oils and fish oil are compositions comprising saturated and unsaturated fatty acids. The group of unsaturated fatty acids includes mono-unsaturated fatty acids as well as poly-unsaturated fatty acids. The ratio of saturated to unsaturated fatty acids varies among oils. For dietary application oils rich in unsaturated fatty acids are highly preferred due to the health benefits of the unsaturated fatty acids over the saturated fatty acids. Thus, the oil used in the suspension is preferably rich in unsaturated fatty acids. Thus, in one embodiment, the oil is rich in unsaturated fatty acids such as mono-unsaturated and/or poly-unsaturated fatty acids. Thus in one embodiment the ratio of saturated to unsaturated fatty acids varies the oil is less than or equal to or any number in between about 5 to 1, such as less than or equal to or any number in between about 4 to 1, such as less than or equal to or any number in between about 3 to 1, such as less than or equal to or any number in between about 2 to 1, such as less than or equal to or any number in between about 1 to 1. The content of unsaturated fatty acids in the oil may be higher than the content of saturated fatty such that the ratio of unsaturated to saturated fatty acids is greater than or equal to about 2 to 1, such as greater than or equal to about 3 to 1, such as greater than or equal to about 4 to 1, such as greater than or equal to about 5 to 1, such as greater than or equal to about 6 to 1, such as greater than or equal to about 7 to 1, such as greater than or equal to about 8 to 1 or more, such as greater than or equal to about 9 to 1, such as greater than or equal to about 10 to 1.

The ratio of saturated to unsaturated fatty acids varies among oils. For example, flaxseed oil comprises 9% of saturated fatty acids, 18% mono-unsaturated fatty acids, and 73% of polyunsaturated fatty acids. In contrast, coconut oil comprise 91% saturated fatty acids, 7% mono-unsaturated fatty acids, and 2% poly-unsaturated fatty acids.

In order to sustain the key health benefits and features of the food product, the product described in this invention may comprise a high level of unsaturated fatty acids. Furthermore, the total amount of fats in the food product may range 0.5% to 45% of net weight of the product (e.g., at least, equal to, or greater than, or any number in between about 0.5%, 1%, 3%, 5%, 7%, 10%, 12%, 15%, 17%, 20%, 23%, 25%, 28%, 30%, 33%, 35%, 37%, 40%, 43%, 44%, or 45%), where preferably the ratio between saturated to unsaturated fats within the total fat content shall range 1/1-20/1 (e.g., at least, equal to, or greater than, or any number in between about 1/1, 1/2, 1/3, 1/4, 1/5, 1/6, 1/7, 1/8, 1/9, 1/10, 1/11, 1/12, 1/13, 1/14, 1/15, 1/16, 1/17, 1/18, 1/19, or 1/20).

Known health beneficial unsaturated fatty acids are omega-3 (n−3) fatty acids such as α-linolenic acid (ALA), eicosapentaenoic acid (EPA), and docosahexaenoic acid (DHA) and omega-6 (n−6) fatty acids such as linoleic acid and arachidonic acid.

Accordingly, in some embodiments of the invention, the oil of the suspension comprises the unsaturated fatty acid selected from the group consisting of α-linolenic acid (ALA), eicosapentaenoic acid (EPA), and docosahexaenoic acid (DHA) and omega-6 fatty acids such as linoleic acid and arachidonic acid. In one embodiment the oil of the suspension is rich the unsaturated fatty acids, wherein the unsaturated fatty acids are n−3 fatty acids. In general it is to be understood that the group of unsaturated fatty acids includes mono-unsaturated fatty acids and poly-unsaturated fatty acids.

Thus in yet an embodiment, the unsaturated fatty acids of the oil of the suspension comprises at least one of α-linolenic acid (ALA), eicosapentaenoic acid (EPA), docosahexaenoic acid (DHA), linoleic acid and arachidonic acid.

### Peroxide Level of Vehicle Oil

Another important parameter of the vehicle oil of the suspension is the peroxide level of the oil. Peroxides are intermediates in the autoxidation reaction and the peroxide level of the oil reflects the degree of rancidification oil and thus the quality of the oil. Apart from deterioration of fats and oils which form off-flavours and off-odor due to rancidification, a high level of peroxide also affects the preservation of the probiotic organism for which the oil is used as vehicle in the vacuum inclusion of the probiotic organism in an extruded food product. An oil with a low peroxide value is preferred as vehicle due to the better probiotic preservative properties over an oil with a higher peroxide value.

Accordingly, in one embodiment of the present invention the peroxide level of said oil is less than or equal to about 6 meq O₂/kg oil, such as less than or equal to about 5 meq O₂/kg, such as less than less than or equal to about 4 meq O₂/kg, such as less than less than or equal to about 3 meq O₂/kg, such as less than less than or equal to about 2 meq O₂/kg, or such as less than or equal to about 1 meq O₂/kg. In a preferred embodiment of the present invention the peroxide level of the oil is as less than or equal to about 2 meq O₂/kg. In another embodiment, the peroxide level of said oil is not more than about 2 meq O₂/kg such as about 2 meq O₂/kg.

### Additive

The suspension of the invention may comprise at least one additive. Thus, in one embodiment of the invention, the suspension for vacuum infusion of an extruded food product comprises an additive, such as an antioxidant. The additive may serve at least the function of preserving the oil vehicle component for example by reducing the accumulation of peroxide in the oil. By minimizing the accumulation of peroxide in the oil the quality of the oil is maintained during storage of the probiotic extruded food product. Oils with a high degree of unsaturation are most susceptible to autoxidation. The peroxide value of the oil also affects the preservation of the probiotic organism for which the oil is used as vehicle in the vacuum inclusion of the probiotic organism in an extruded food product. Accordingly, adding an antioxidant to the suspension reduce autoxidation reaction of the thereby maintaining the quality oil the oil in terms of food quality but also in terms of preserving the probiotic comprised in the probiotic food product and a fixed level of the unsaturated fats.

Thus, in one embodiment of the invention the suspension comprises at least one additive. In a further embodiment, the suspension comprises an antioxidant. In yet another embodiment, the antioxidant is selected from the group consisting of natural antioxidants and synthetic antioxidants. In one embodiment of the invention the synthetic antioxidant is selected from the group consisting of BHA and BHT and natural antioxidant is selected from the group consisting of Vitamin E, alpha lipoic acid, N-acetyl cysteine, green tea extract, carotenoids, flavonoids, and polyphenolics. The natural antioxidant may be provided in the form of an extract for example rosemary or grape seed extracts (comprising resveratrol), grape seed oil. Preferably, natural antioxidants are used. Accordingly, in yet another embodiment the antioxidant is natural antioxidant selected from the group consisting of flavanoids, cartonoids, tocotrienol, tocopherol and terpenes. In a particular embodiment, the antioxidant is astaxanthin.

### Probiotic Micro-Organism of the Suspension

The probiotic micro-organism(s) (probiotic(s)) are added to the extruded food product as supplement in order to improving the intestinal microbial balance the host animal (such as human being or pet). The probiotic micro-organism used by the present invention is preferably in preserved state such as freeze-dried. The size of the freeze-dried particles are from 1 μm and larger (e.g., at least, equal to, or greater than, or any number in between about 1, 2, 3, 4, 5, 6, 7, 8, 9, or 10 μm). In the freeze-dried form, the probiotic micro-organism is a metabolic state of life as a consequence of cryopreservation. However, the probiotic micro-organism will revert into a metabolic state of life when exposed to an environment enabling the metabolic state of life and populate the environment such as the intestinal of the host. Accordingly, a non-viable (dead) micro-organism is not a probiotic micro-organism.

The state of preservation is further sustained by the use of the oil in the suspension of the invention. Thus, apart from serving the purpose of vehicle for infusion of the probiotics into the extruded food product, the oil also function as a preservation of the probiotic micro-organism embedded in the food product. Thereby, the stability of the probiotic food product is improved and the shelf life of the final food product increased.

Probiotics are diverse and identified both among bacteria and fungi. Probiotic micro-organisms from both kingdoms are suitable in the context of the present invention. In one embodiment, the suspension of the invention comprises at least one probiotic micro-organism is selected from the group consisting of bacteria, yeast and mold. In another embodiment of the invention, the at least one probiotic micro-organism is bacteria selected from the group consisting of Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus.

In further embodiment, the at least one probiotic micro-organism is bacteria selected from the group consisting of Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus.

In yet another embodiment of the invention, the at least one probiotic is a yeast selected from the group consisting of Saccharomyces, Debaromyces, Candidaw Pichia and Torulopsis. In one embodiment of the invention, the at least one probiotic is a mold selected from the group consisting of Aspergillus, Rhizopus, Mucor, and Penicillium and Torulopsis.

In yet an embodiment of the invention, the probiotic micro-organism is selected from the group consisting of Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. casei L. curvatus, L. cellobiosus, L. delbrueckii ss. bulgaricus, L farciminis, L. fermentum, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, and Strep. lactis.

The choice of probiotic organism depends on the specific application in question e.g. pet food such as dog food. Enterococcus faecium is suitable for probiotic dog food. Thus, in a preferred embodiment the at least one probiotic micro-organism is Enterococcus faecium. The suspension may subsequently be used for the preparation of a probiotic extruded food product for dogs (e.g. a probiotic dog food kibble comprising Enterococcus faecium). In a particular embodiment, the at least one probiotic micro-organism is the NCIMB 10415 strain of Enterococcus faecium. The NCIMB 10415 strain may be EC No. 13 (E1707 (new classification)).

Enterococcus faecium can be obtained from the internationally recognised culture collection NCIMB (National Collections of Industrial and Marine Bacteria). The strain is grown in a fermentation chamber of 5000 L capacity. It is then protected using cryoprotectants and then freeze-dried to form a powder before being blended with the Pet Food and other components of Protexin Concentrate in exact concentrations. In various embodiments, Protexin pet food is also able to overcome the problem of stomach sterilisation by containing billions of micro-organisms so that some will always negotiate the pylorus and be available to colonise the gut.

Suspensions may include Lactic Acid Bacteria (LAB), which produce lactic acid that promotes the growth of the bacteria in an optimum acidic environment. By creating this acidic environment LAB-s are able to prevent the growth of coliforms such as E. coli as they prefer a more alkaline pH for growth. Furthermore, the beneficial probiotic micro-organisms contained within current invention will act to competitively exclude potentially pathogenic micro-organisms within the gut. Protexin, which contains Lactic Acid Bacteria and included in the pet food, when colonised within the gut, will produce lactic acid, which has a low pH, which effectively produces the optimum conditions required for the growth of beneficial micro-organisms. This action helps to prevent the colonisation of coliforms such as E. coli which prefer a more alkaline pH.

The very acidic, low pH of the stomach in most animals is nature's way of attempting to remove some of the load of infection present in food. It is however not a completely effective process as is made apparent by the fact that the oral/gut route is the commonest way for infectious agents to enter the body.

Protection of the micro-organisms from adverse environmental conditions, both during and after production of bacteria is important. Cryoprotectants are applied prior to freeze-drying. This gives additional protection against moisture, oxygen and heat and adds substantially to the shelf-life of the end product. Thus while using vacuum coating technology it is possible to sustain such stability in the final product. Also, the freeze drying and vacuum coating process, which is used to preserve the micro-organisms present in this invention, conveys an encapsulation, which protects against stomach acid.

In one embodiment, the probiotic micro-organism is applied to the suspension in a dry powder form, wherein the concentration of the probiotic micro-organism in the dry powder is in the range of 10⁹-10¹⁷ CFU/kg dry powder, such as 10⁹-10¹⁶, such as 10¹⁰-10¹⁶, such as 10¹⁰-10¹⁵ CFU/kg dry powder, such as 10¹⁰-10¹⁴ CFU/kg dry powder. That is, the concentration of the probiotic micro-organism in the dry powder can be at least, equal to, or any number in between about 10⁹, 10¹⁰, 10¹¹, 10¹², 10¹³, 10¹⁴, 10¹⁵, 10¹⁶ or 10¹⁷ CFU/kg dry powder.

### Properties of the Suspension of the Invention

The probiotic/oil suspension of the invention comprises at least one oil and at least one probiotic micro-organism. The probiotic/oil suspension for application in a vacuum has a dynamic viscosity of less than 0.08 pascal-second (Pa·s) at 20° C.

The component of the suspension comprising the oil and the at least one probiotic micro-organism is selected and balanced in the suspension to accomplish that the suspension is applicable for the vacuum infusion process. Accordingly, the component of the suspension is balanced to accomplish a dynamic viscosity of the suspension less than 0.08 pascal-second (Pa·s) at 20° C.

Accordingly, in one embodiment of the invention, the dynamic viscosity of the suspension is less than 0.08 pascal-second (Pa·s) at 20° C. In another embodiment of the invention, the dynamic viscosity of the suspension is less than 0.06 pascal-second (Pa·s) at 20° C. In a further embodiment, the dynamic viscosity of the suspension is in the range of 0.04 to 0.06 pascal-second (Pa·s) at 20° C.

Preparing the suspension to obtaining a suspension with the dynamic viscosity within the above ranges ensures that accumulation of matter from the suspension in the system is minimized. Clotting of the fluidics such clotting of the spraying nozzle is prevented, which reduce the frequent premature terminations of the production in order to clean and eventually repair the line of production.

In one embodiment of the invention, the concentration of the at least one probiotic micro-organism is 10⁶-10¹⁶ CFU/kg of the oil component of the suspension such as 10⁷-10¹⁶ CFU/kg, such as 10⁷-10¹⁶ CFU/kg, such as 10⁸-10¹⁶ CFU/kg, such as 10⁹-10¹⁶ CFU/kg, such as 10⁹-10¹⁴ CFU/kg, such as 10⁹-10¹⁴ CFU/kg, or such as 10¹⁰-10¹⁴ CFU/kg. That is, the concentration of the at least one probiotic micro-organism can be at least, equal to or any number in between about 10⁶, 10⁷, 10⁸, 10⁹, 10¹⁰, 10¹¹, 10¹², 10¹³, 10¹⁴, 10¹⁵, or 10¹⁶ CFU/kg of the oil component of the suspension. In a further embodiment, the concentration of the probiotic micro-organism takes into account that the probiotic extruded food product obtained using the suspension should have 1×10⁹ to 3.5×10¹⁰ CFU/kg of complete food, and that the suspension is suitable for vacuum infusion in the view of the above such as a dog food enriched by E. faecium. That is, the concentration of the probiotic micro-organism in the probiotic extruded food product can be at least, equal to, or any number in between about 1×10⁹, 2×10⁹, 3×10⁹, 4×10⁹, 5×10⁹, 6×10⁹, 7×10⁹, 8×10⁹, 9×10⁹, 1×10¹⁰, 2×10¹⁰, 3×10¹⁰, 3.5×10¹⁰ CFU/kg.

### Preparation of a Suspension of Probiotic Micro-Organism and Vehicle Oil

One aspect of the present invention relates to a method of preparing a suspension of the invention, said method comprising:
a) providing at least one probiotic micro-organism in a dry powder form having a total concentration of 10⁹-10¹⁷ CFU/kg dry powder;
b) providing an oil;
c) adding 0.3 to 15 kg of said probiotic micro-organism powder per 100 kg oil to said oil in an container at continuously stirring at RT to make a suspension premix;
d) transferring the suspension premix of c) to a storage tank comprising mixing means with the proviso that the transfer is not by vacuum suction;
e) mixing said premix suspension RT to obtain a suspension of homogenously dispersed probiotic micro-organism;
   and obtaining said suspension.

The container employed in the method may be an IBC-container or other suitable container. The container has preferably a bottom outlet for the emptying the premix. The oil employed in the method is a suitable oil in context of the invention as described above.

Bacteria powder is added gradually to the oil at continuously mixing (such as rotation speed of 5-350 RPM) at room temperature.

In one embodiment, the total concentration of the at least one probiotic micro-organism in said dry powder form is in the range of 10¹⁰ to 10¹³ CFU/kg dry powder, such as 10¹¹ to 10¹³ CFU/kg dry powder, such as 10¹² to 10¹³ CFU/kg dry powder, such as 10¹³ CFU/kg dry powder. That is, the concentration of the probiotic micro-organism in the dry powder can be at least, equal to, or any number in between about 10¹⁰, 10¹¹, 10¹², 10¹³, CFU/kg dry powder. In a further embodiment, 3.3 to 6.7 kg of said probiotic micro-organism powder per 100 kg is added to said oil in the container. That is, at least, equal to, or any number in between about 3.3, 3.5, 4.0, 4.5, 5.0, 5.5, 6.0, 6.5, or 6.7 kg is added. In yet another embodiment, the premix is mixed for no more than 3 hours of mixing. In yet another embodiment, the premix is mixed for no more than 1 hour of mixing. In an additional embodiment the premix is mixed for not less than 1 hour. In yet an embodiment the premix is mixed for not less than 1 hours and not more than 3 hours.

### Use of the Suspension of the Invention for Manufacturing a Probiotic Food Product

The concentration of the probiotic ingredient in the final probiotic food product obtained by using the suspension of the invention should be in range regulated by EU registration 1×10⁹ to 3.5×10¹⁰ CFU/kg of complete food stuff (EC nr E1707) accordingly to Official Journal of the European Union, COMMISSION REGULATION (EC) No 1520/2007 of 19 Dec. 2007.

Accordingly, the suspension is applied to the food product by vacuum infusion taking into account at least the concentration of the probiotic micro-organism in the suspension, loss of probiotic in the line of manufacturing and calibrated accordingly to accomplish a CFU within the range 10⁵ to 10¹⁵ CFU/kg of complete food stuff such as in the range of 1×10⁹ to 3.5×10¹⁰ CFU/kg of complete food stuff.

One aspect of the present invention concerns the use of a suspension of the present invention for the preparation of a extruded probiotic food product, wherein said suspension comprises an oil and at least one probiotic micro-organism in the concentration of 106-1016 CFU/kg of said oil and said suspension having a dynamic viscosity of less than 0.08 pascal-second (Pa·s) at 20° C.

Another aspect of the present invention relates to a method of producing an extruded food product comprising at least one probiotic micro-organism, wherein said probiotic micro-organism is homogenously distributed throughout the structure of the food product by vacuum inclusion of the suspension of the present invention.

In one embodiment, the food product is a pet food product. In another embodiment, the food product is a human food product.

### Extruded Probiotic Food Product

Another aspect of the present invention concerns an extruded probiotic food product obtained by a method and/or the methods described above.

In one embodiment, the minimal amount of the probiotic in the product is in the range of 10⁵ CFU/Kg to 10¹⁵ CFU/Kg, such as 1×10⁹ CFU/Kg to 7.5×10¹¹, such as 2.5×10⁹ CFU/Kg to 7.5×10¹¹. That is, the amount of the probiotic in the product can be at least, equal to, or any number in between about 10⁵, 10⁶, 10⁷, 10⁸, 10⁹, 10¹⁰, 10¹¹, 10¹², 10¹³, 10¹⁴, 10¹⁵ CFU/kg. In another embodiment, the product % moisture is above 7%, preferably 8-10%. That is the moisture level can be at least, equal to, or any number in between about 7, 8, 9, or 10%.

Vacuum multi coating technology that is available in United Pet foods manufacturing facility is the method of including the beneficial oils, powders, smells and any other ingredients that are needed for sufficient final product.

As the bacteria have to be protected from moist, heat and sun light, so the production process is carried out in sealed environment from the beginning until the end. The method of production will include freeze-dried bacteria being mixed with the fish oil at a required concentration. While constantly stirring the oil has to become liquid for the vacuum coater. This is achieved by warming the oil to temperature 20° C. to 25° C. the optimum temperature is 22° C. that is still tolerable by the bacteria. That is the oil can be warmed to a temperature of at least, equal to, or any number in between about 20, 21, 22, 23, 24, or 25° C. The oil will be vacuum coated on the kibble and thus placing the bacteria within kibble structure. This way the bacteria is protected and has a great potential for survival and recovery.

### Production Plant

By one approach, a vacuum infusion production plant is provided for infusing probiotic micro-organisms into extruded food products, such as pet food.

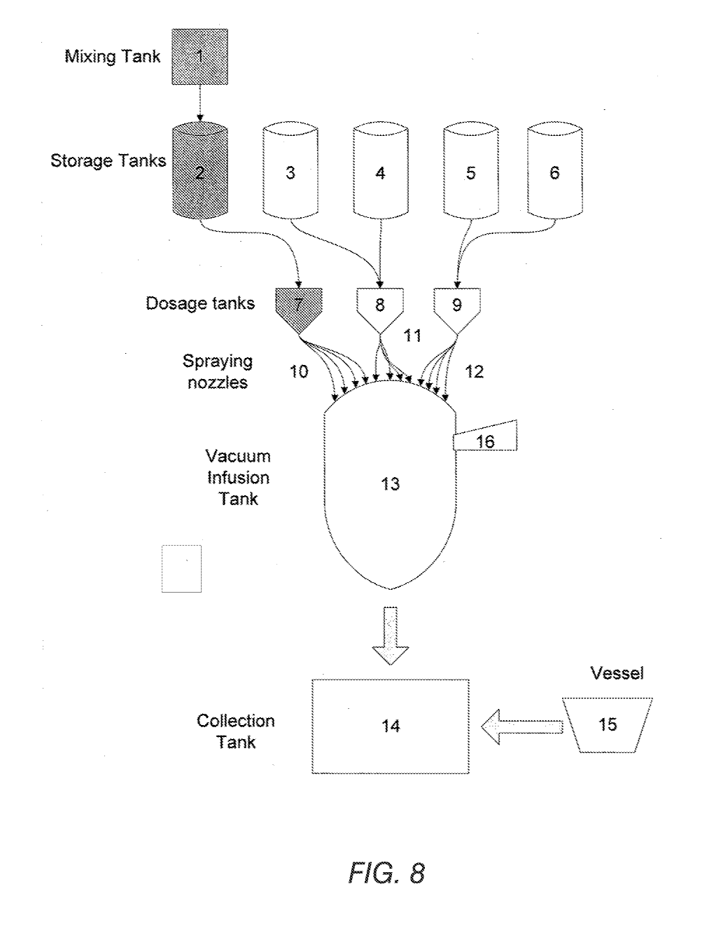

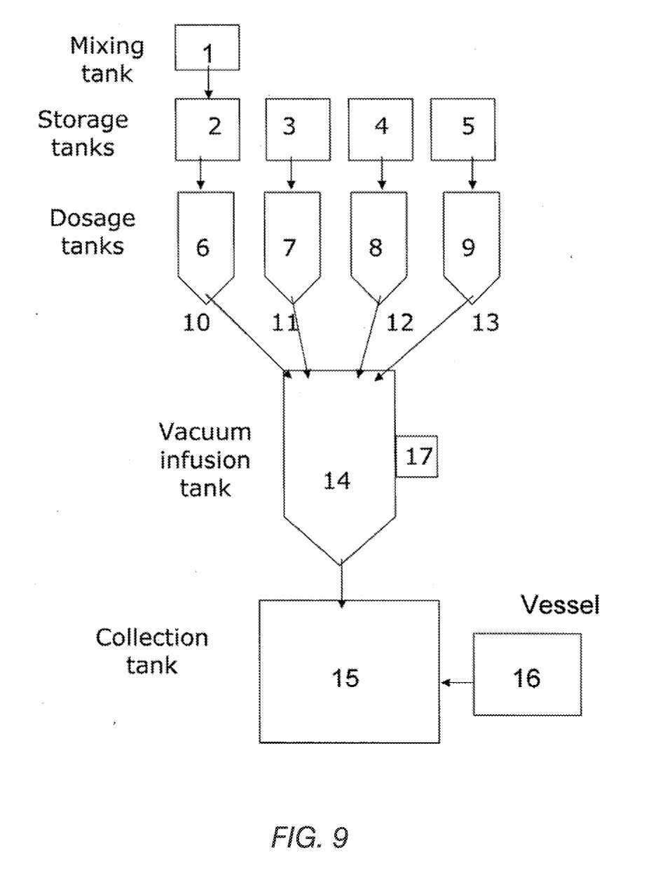

The numbering refers to FIG. 9, but the person skilled in the art would easily be able to convert this numbering to the numbering indicated in FIG. 8 where appropriate.

The plant may comprise one or more storage tanks 2-5 which can be used to store individual solutions, such as a probiotic suspension, a solution of fat, and a solution of digest. The storage tank 2 may be further connected to a mixing tank 1. The reason is that mixing of an oil/fat suspension with a freeze dried probiotic powder, may result in precipitation of the probiotics if the powder is not mixed slowly into to oil/fat suspension. This mixing may be performed manually. The mixing tank 1 may be physically positioned above the storage tank 2. In this way the suspension in the mixing tank 1 may be transferred to the storage tank 2 through an outlet positioned at the bottom of mixing tank 1. Furthermore, this setup means that the transfer can be performed only by the force of gravity, which may be beneficial for the viability of the probiotics in the suspension.

The storage tank 2 and the dosage unit tank 6 for storing and dosing a probiotic suspension may comprise means for mixing the suspension such as an impeller or a rotational tank or a combination of both. The other storage and dosage tanks may comprise similar means for mixing. Each of the storage tanks 2-5 may then be further connected to individual dosage tanks 6-9. Each of the dosage tanks 6-9 may then be further connected to a single vacuum infusion tank 14. These connections are in one embodiment spraying nozzles 10-13 connection each dosage tank individually to the vacuum infusion tank 14, allowing for spraying the content of each of the dosage unit tanks individually on the food products present in the vacuum infusion tank 14. This is important to avoid mixing of the oil/fat suspension comprising probiotics with one or more of the other solutions, since intermixing may lower the viability of the probiotics. Thus, at least the spraying nozzles leading from the probiotic-oil/fat suspension to the vacuum infusion tank should not be connected to any of the other dosage tanks. This is in contrast to WO 03/009710, which teaches away from keeping the suspension comprising the probiotics separate from all other liquids until the reach the solid food product.

The precise shape of the spraying nozzles may vary, since the form and shape of the nozzles have to be optimized to the solution/suspension which is going to be sprayed through the nozzles.

The vacuum infusion tank may furthermore comprise one or more openings 17 for receiving a food product. When the food product is in place in the tank the following steps may take place:
a) reduction of the pressure in the vacuum infusion tank to 0.2-0.95 bar,
b) vaporization of one of the solutions from one of the dosage unit tanks 6-9 through the corresponding one or more spraying nozzles 10-13 at e.g. a temperature below 29° C., and
c) restoration of pressure to 1 bar

Steps a)-c) may then be repeated with other solutions (or the same solution) to further vacuum infusions into the food product. This is important for getting the subsequent solutions infused into the product. The release of the vacuum may be performed slowly to avoid abrupt changes in pressure which may be harmful to the product and/or the probiotics.

The reduction in the pressure in the vacuum infusion tank (step a) may also be in the range 0.2-8 bar.

Similar the temperature range in step B may be 15-30° C., such as 15-29° C. or such as 20-29° C.

Some vacuum tanks are designed to release the pressure in the vacuum tank using an inert gas, which may actually be harmful for the viability of the probiotics. Thus, in an embodiment the pressure release is not performed with an inert gas such as nitrogen and carbondioxide. It is to be understood that release of the pressure using atmospheric air is part of the invention though atmospheric air comprises nitrogen and carbondioxide.

To get the sprayed solutions evenly distributed in the infusion tank some kind of mixing may be required. Thus, the mixing tank (vacuum infusion tank 14) may be able to rotate or comprise an impeller or the like. Therefore it may be advantageous if the mixing is performed during the spraying steps or after each of the spraying steps.

Thus, in an embodiment the vacuum infusion tank comprises at least one of the following means for mixing: a rotating impeller, a rotating mixing tank.

The vacuum infusion tank may also comprise an outlet leading to a collection vessel 15. The collection tank 15 may be particular useful, when a coating is also required on the food product (which is not going to be vacuum infused). Such a coating may be stored in a vessel 16 connected to the collection tank 15. Examples of coatings could be suspensions comprising honey, natural sweeteners, artificial sweeteners, vitamins, tartar or other additives or the like.

In some aspects, a production plant for vacuum infusing a food product comprises a first storage tank for storing a probiotic suspension, connected to a first dosage tank for dosing a probiotic suspension, wherein the first dosage tank is connected to a vacuum infusion tank by one or more spraying nozzles leading into the vacuum infusion tank. In this way the probiotic suspension may be sprayed onto the food product positioned in the vacuum infusion tank.

It may be advantageous to be able to vacuum infuse two suspensions/solutions without having to change the content of the storage tank and the dosage tank. Thus, in an embodiment the production plant further comprises a second storage tank for storing a second solution, connected to a second dosage tank for dosing the second solution, wherein the second dosage tank is connected to a vacuum infusion tank by one or more spraying nozzles leading into the vacuum infusion tank, and wherein the first dosage tank is individually connected to a vacuum infusion tank by one or more spraying nozzles leading into the vacuum infusion tank.

Another aspect relates to a production plant for vacuum infusing a food product comprising at least a first storage tank for storing a probiotic suspension, said first storage tank being connected to a first dosage tank for dosing a probiotic suspension, and a second storage tank for storing a second solution, said second storage tank being connected to a second dosage tank for dosing the second solution, wherein the first dosage tank and the second dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

In the production plant of preferred embodiments, the probiotic suspension is kept separate from the other solution which may be vacuum infused into the product. This is done having the first dosage tank individually connected to the vacuum infusion tank. An advantage is that optimal viability of the probiotics is maintained when the probiotic oil/fat suspension is kept distinct from the other solution. It is to be understood that the oil/fat suspension may comprise antioxidants and or other preservatives. The aspect and embodiments relating to at least two storage and dosage tanks may be especially suited for certain human product where two vacuum coating steps may be optimal. Example 10 discloses a method of coating a human food product, wherein the coating process comprises two independent vacuum coating steps (suspension and syrup).

Thus, in an embodiment the second storage tank and second tank are intended for a solution selected from the group consisting of: a syrup, a digest, a fat solution and a flavour. In a further embodiment the second storage tank and second tank are intended for a flavour component such as a syrup.

It should be noted that embodiments and features described in the context of one of the aspects of the present invention also apply to the other aspects of the invention. Thus, embodiments and features relating to the production plant in the following aspects of the invention also apply to other aspects disclosing a production plant.

### Production Plant Variations

It may be advantageous to be able to vacuum infuse more than two suspension/solution without having to change the content of the first or second storage tank and the first and second dosage tank.

Thus, in an embodiment the invention relates to a production plant further comprising at least a third storage tank (4) for storing a solution, said third storage tank (4) being connected to a third dosage tank (8) for dosing the third solution through one or more spraying nozzles.

Thus, in a third aspect the invention relates to a production plant for vacuum infusing a food product comprising at least a first storage tank for storing a probiotic suspension, said first storage tank being connected to a first dosage tank (6) for dosing a probiotic suspension, a second storage tank for storing a fat solution, said second storage tank being connected to a second dosage tank for dosing a fat solution, a third storage tank for storing a digest solution, said third storage tank being connected to a third dosage tank for dosing a digest solution, and wherein the first dosage tank, the second dosage tank and the third dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

In the production plant of preferred embodiments, the probiotic suspension is kept separate from the other components which are going to be vacuum infused into the product. This is done having the first dosage tank individually connected to the vacuum infusion tank. An advantage is that optimal viability of the probiotics is maintained when the probiotic oil/fat suspension is kept distinct from the other solutions. This aspect of the invention may be especially suited for certain pet food production lines where three vacuum coating steps may be an advantage. Example 9 shows an example of a three step coating of a pet food kibble.

It is to be understood that though the above aspect specifically relates to a production plant for coating a suspension, a fat mixture and a digest mixture, the plant may also be used for coating other substances onto a food product. Thus in an alternative aspect the invention relates to a production plant for vacuum infusing a food product comprising at least a first storage tank for storing a first solution, said first storage tank being connected to a first dosage tank (6) for dosing the first solution, a second storage tank for storing a second solution, said second storage tank being connected to a second dosage tank for dosing the second solution, a third storage tank for storing a third solution, said third storage tank being connected to a third dosage tank for dosing the third solution, and wherein the first dosage tank, the second dosage tank and the third dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank. In a preferred embodiment the first solution is a probiotic suspension.

Non-limiting examples of alternative solutions to be vacuum infused are flavour solutions, syrups and vitamin solutions. This is of course in addition to the previously mentioned solutions such as probiotic suspension, fat, digest and syrups.

The solutions in the second dosage tank and the third dosage tanks may be connected to the vacuum infusion tank through a joined connection, which may make the plant simpler to construct.

Other solutions may be vacuum infused into the product of the invention. Thus, in another embodiment the production plant further comprises at least a fourth storage tank for storing a solution, said fourth storage tank being connected to a fourth dosage tank for dosing a solution through one or more spraying nozzles.

The fourth storage tank and the fourth dosage tank may be optimized for storing additional solutions. The solutions in the second dosage tank, the third dosage tank and the fourth dosage tank may be connected to the vacuum infusion tank through a joined connection, which may make the plant simpler to construct.

It may also be advantageous to avoid intermixing of some of the solutions present in the dosage tanks. Thus, in another embodiment the invention relates to a production plant, wherein at least one of the following dosage tanks also is individually connected to the vacuum infusion tank by one or more spraying nozzles: the second dosage tank, the third dosage tank and the fourth dosage tank.

This may be advantageous, since intermixing of two or more of the different solutions may result in precipitation and clotting of the spraying nozzles.

### Intermixed Dosage Tanks

In some cases none of the solutions in the dosage tanks should be intermixed before they enter the vacuum infusion tank. Therefore, in yet another embodiment the invention relates to a production plant, wherein each of the following dosage tanks also is individually connected to the vacuum infusion tank by one or more spraying nozzles: the second dosage tank, the third dosage tank and the fourth dosage tank. This may be advantageous, since intermixing of two or more of the different solutions may result in precipitation and clotting of the spraying nozzles. Another advantage may be that e.g. the fourth storage tank and the fourth dosage tank can be saved as an extra infusion line in the case that e.g. the nozzles in one of the dosage tanks clots. In this way a fast switch can be made to the fourth infusion line and thus save expensive “down-time” where the plant may be out of order. It is to be understood that “infusion line” refers to the combination of vessels leading to the vacuum tank, e.g. the fourth storage tank leading to the fourth dosage tank leading to the vacuum infusion tank through one or more spraying nozzles.

### Spraying Nozzles Orifice

Since different solutions are being sprayed onto the food products optimal spraying is required. Thus, in a further embodiment the invention relates to a production plant according to any production plant described herein, wherein the orifice of each of the spraying nozzles has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm². The importance of having optimal nozzles for each type of solution is that the efficiency of the spraying is depending on the orifice of each of the spraying nozzles and the viscosity of the solution passing through the nozzle. Furthermore, spraying also depend on the speed the solution is passed through the nozzle. Thus, it is to be understood that each infusion line do not necessary have the same type of spraying nozzles.

### Cross-Sectional Area

Therefore, in an additional embodiment the orifice of each of the spraying nozzles connected to the first dosage tank has a cross-sectional area of at least, equal to, or any number in between about 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the second dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the third dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the fourth dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm².

Optimal spraying through the nozzles also depend on the viscosity of the fluids. The spraying nozzles for spraying the suspension is preferably designed for a suspension having a dynamic viscosity of less than or equal to about 0.08 pascal-second (Pa·s) at 20° C., such as less than 0.075 pascal-second (Pa·s) at 20° C., for example less than 0.070 pascal-second (Pa·s) at 20° C., such as less than 0.065 pascal-second (Pa·s) at 20° C., for example less than 0.060 pascal-second (Pa·s) at 20° C., such as less than 0.055 pascal-second (Pa·s) at 20° C., for example less than 0.050 pascal-second (Pa·s) at 20° C., such as less than 0.045 pascal-second (Pa·s) at 20° C., for example less than 0.040 pascal-second (Pa·s) at 20° C. In one embodiment, the dynamic viscosity of the vehicle oil is less than 0.060 pascal-second (Pa·s) at 20° C. In a further, embodiment, the dynamic viscosity of the vehicle oil within the range of at least, equal to, or any number in between about 0.050 to 0.07 pascal-second (Pa·s) at 20° C., such as the range of at least, equal to, or any number in between about 0.053 to 0.066 pascal-second (Pa·s) at 20° C.

Another parameter which may influence the efficiency of the nozzles is the change in viscosity in the range of at least, equal to, or any number in between about 20° C. and 25° C. (e.g., 20, 21, 22, 23, 24, or 25° C.), since vacuum infusion in this temperature range is optimal for maintaining a high viability of the probiotics.

### Bottom Outlet

To be able to maintain a high viability of the probiotics during the whole process of vacuum infusion, correct handling of the solution is required. Thus, in yet a further embodiment the invention relates to a production plant, wherein a first mixing tank is connected to the first storage tank through a bottom outlet in the first mixing tank, and where the probiotic suspension is intended for being passed from the first mixing tank to the first storage tank at least by means of gravity, possibly by means of gravity only. An advantage of having an additional mixing tank is that mixing dried probiotics into the oil/fat suspension may result in flakes/precipitates of microorganisms if the microorganisms are added too fast to the suspension. Furthermore, manually mixing may be advantageous. An example of a mixing tank is an IBC tank. When the suspension is transferred to the first storage tank it is also important not to supply too much force to the suspension since it may result in loss of viability of the probiotics. By having an outlet positioned at the bottom of the mixing tank and the first storage tank positioned below the mixing tank, the suspension can be transferred to the storage tank only by the force of gravity. Alternatively, the outlet may be positioned otherwise such as on side of the mixing tank 1. The mixing tank may be adapted to allow emptying the tank from e.g. an outlet positioned on side of the mixing tank.

### Vacuum Suction Unit

Thus, in an embodiment the connection between the first mixing tank and the first storage tank does not comprise a vacuum suction unit. In another embodiment the connection between the first mixing tank and the first storage tank does not comprise a positive displacement unit. Both a vacuum suction unit and a positive displacement unit may be harmful to the viability of the probiotics. Furthermore by minimizing the surfaces the probiotics come in contact with, loss of probiotics due to sticking to the surfaces of e.g. long tubes, loss of viability may also be avoided.

### Mixing

It is important that the probiotics stay/become evenly distributed in the suspension when the suspension is maintained in the first storage tank. Thus, in a further embodiment the first storage tank comprises at least one of the following means for mixing: a rotating impeller, a rotating mixing tank, or a combination of an impeller and a rotating tank. By having the first storage tank comprising means for mixing, such as an impeller, a rotating tank or a combination of both, sedimentation of the probiotics may be avoided. The person skilled in the art would know of other means for mixing which may be suitable for the described purpose. When an impeller is used for mixing the speed of the mixing may be controlled to optimize mixing, to minimize lose of viability but at the same time keep a homogenous suspension. Thus, the speed of the impeller in storage tank 2 may be at least, equal to, or any number in between about 50-1000 rpm when the impeller has a radius of approximately 5-150 cm, such as about 5-50 cm, such as about 50-150 cm, such as about 50-100 cm or such as about 100-150 cm. The person skilled in the art would now how to convert rcf (relative centrifugation force=“g”) to rpm (revolutions per minute) or vice versa. E.g. by applying the formula:

rcf=11.18*r*(rpm/1000)̂2.

Thus, by knowing the radius (r) the skilled person would be able to calculate the relative centrifugation force. Thus, in an embodiment speed of the impeller in storage 2 is at least, equal to, or any number in between about 50-1000 rpm, such as about 50-500 rpm, such as about 50-300 rpm, such as about 50-300 rpm, or such as about 100-200 rpm.

### Opening for Applying Uncoated Food

The vacuum infusion tank also has to be able to receive the food product (not yet infused) before the vacuum infusion begins. Thus, in yet another embodiment the vacuum infusion tank comprises at least one opening for applying the uncoated food product to said vacuum infusion tank. The food product (before infusion) may be transferred to the vacuum infusion tank directly from a drying device, which means that the un-infused food product may have a temperature above ambient temperature when it enters the vacuum infusion tank. Thus, in an embodiment the vacuum infusion tank is connected to a drying device. A higher amount of solutions/suspensions are being infused into the product when the product has a temperature of 20-50° C., such as 20-45° C., 25-50° C., 30-45° C. without resulting in significant loss of viability of the probiotics. That is, the infusion can be performed at a temperature of at least, equal to, or any number in between about 20, 21, 22, 23, 24, 25, 26, 27, 28, 29, 30, 31, 32, 33, 34, 35, 36, 37, 38, 39, 40, 41, 42, 43, 44, 45, 46, 47, 48, or 50° C. Such temperatures are conductive to coating process, because the kibble pores in this way are maximally opened and it creates a “sponge” effect which promotes the overall coating process.

### Pressure

The vacuum infusion tank may be constructed to decrease the pressure inside the tank to a vacuum. Thus, in an embodiment the pressure inside vacuum infusion tank can be adjusted to pressures in the range of at least, equal to, or any number in between about 0.01 bar-1.5 bar, such as about 0.01 bar-1.5 bar, such as about 0.05 bar-1.5 bar, such as about 0.05 bar-1 bar, such as about 0.1 bar-1 bar, such as about 0.05 bar-0.1 bar, such as about 0.1 bar-0.3 bar, such as about 0.3 bar-0.5 bar, such as about 0.5 bar-0.7 bar, or such as about 0.7 bar-0.9 bar. By having the possibility also to increase the pressure above 1 bar a larger pressure difference may be achieved following pressure release, which may result in a better vacuum infusion.

### Collection Tank

Following vacuum infusion the food product (now comprising probiotics) may require additional coatings, which is not vacuum-infused. Thus, in a further embodiment the vacuum infusion tank is further connected to a collection tank for passing the coated food product from the infusion tank to the collection tank, and wherein the collection tank is further connected to at least one vessel containing one or more substances to be applied to the collection vessel. Since not all solutions are suitable for being applied to a product through spraying, e.g. due to a high viscosity or because the solution comprises components which due to the size may clot the spraying nozzles other means for applying such solutions may be required. Furthermore, applying additional means for adding a solution to the vacuum infusion tank, may be inappropriate since high viscosity solutions may still result in damage to the spraying nozzles already positioned inside the vacuum infusion tank. The collection tank may receive a solution from one or more vessels by e.g. a standard tube, pipe or hose.

### Collection Tank Mixing Means

It may become difficult to get the one or more solutions evenly distributed on the vacuum infused food products. Thus, in yet a further embodiment the collection tank comprises at least one of the following means for mixing: a rotating impeller, a rotating mixing tank. The person skilled in the art would know of other means for mixing.

### Temperature Control

It is important to provide environmental conditions during the whole production, which are advantageous for the viability of the probiotics. Thus, in an embodiment at least the first storage tank and the first dosage tank comprise means for maintaining the temperature of the probiotic suspension in the range of 15°-29° C. (not exceeding 30° C.). That is, a temperature control device configured to maintain the temperature at least, equal to, or any number in between about 15, 16, 17, 18, 19, 20, 21, 22, 23, 24, 25, 25, 27, 28, 29, or 30° C. Alternatively the temperature is in the range 15-40° C., such as 20-40° C., 25-40° C. or such as 20-30° C. That is, the temperature control device is configured to maintain the temperature at least, equal to, or any number in between about 15, 16, 17, 18, 19, 20, 21, 22, 23, 24, 25, 25, 27, 28, 29, 30, 31, 32, 33, 34, 35, 36, 37, 38, 39, or 40° C. Probiotics are in general sensitive towards temperature variations therefore control of temperature is advantageous. Furthermore, to provide products which have a constant viability count between different productions sessions, temperature control of at least some of the tanks which comprises probiotics may be an advantage.

Since both the temperature of digest and animal fat can be higher than for the suspension, dependingly on the consistency and quality of the animal fat and digest, without influencing the quality of the end product, the temperature control interval may go up to 60° C.

Thus, in an embodiment the temperature of the animal fat is kept at an temperature range of 15-60°, such as 15-50° C., such as 15-40° C., within the animal fat storage tank. That is the temperature of the animal fat is maintained at a temperature of at least, equal to, or any number in between about 15, 16, 17, 18, 19, 20, 21, 22, 23, 24, 25, 25, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60° C.

In another embodiment the temperature of the digest is kept at an temperature range of 15-60° C., such as 15-50° C., such as 15-40° C., within the digest storage tank. That is the temperature of the digest is maintained at a temperature of at least, equal to, or any number in between about 15, 16, 17, 18, 19, 20, 21, 22, 23, 24, 25, 25, 27, 28, 29, 30, 31, 32, 33, 34, 35, 36, 37, 38, 39, or 40° C.

It may be difficult to control the production plant manually, since it comprises many individual components. Thus, in a further embodiment the plant further comprises a control unit for controlling at least one of the activities selected from the group consisting of: controlling the temperature in at least one of the storage tanks, controlling the temperature in at least one of the dosage tanks, controlling opening and closing of inlets and outlets between two or more of the tanks, controlling the amount of liquid sprayed through the nozzles from the individual dosage tanks, controlling the pressure in the vacuum tank and controlling the mixing speed and time.

### Feces Management

Pet food containing a probiotic oil suspension can be used for faeces management in pets. By one approach, probiotic oil suspension-infused pet food is used to manage defecation and improve faeces consistency and faeces condition in pets. The probiotic oil suspension-infused pet food changes and optimises the various scores of the PURINA system surprisingly well under high volume manufacturing and modern logistics. Numerous applications of defecation management or faeces management in pets are provided. It is an object of preferred embodiments of the present invention to provide means for defecation and/or faeces management in a pet comprising feeding the pet with a vacuum infused pet food kibble comprising within the kibble structure a mixture of probiotic micro-organisms and an oil or similar vehicle.

An embodiment of the present invention relates to a method wherein the kibble contains above 10³ CFU per gram of the kibble, such as above 10⁴ CFU per gram of the kibble, such as above 10⁵ CFU per gram of the kibble, such as above 10⁶ CFU per gram of the kibble, such as above 10⁷ CFU per gram of the kibble, such as above 10⁸ CFU per gram of the kibble, such as above 10⁹ CFU per gram of the kibble, such as above 10¹⁰ CFU per gram of the kibble, such as above 10¹¹ CFU per gram of the kibble, such as above 10¹² CFU per gram of the kibble, such as above 10¹³ CFU per gram of the kibble, such as above 10¹⁴ CFU per gram of the kibble, such as above 10¹⁵ CFU per gram of the kibble, such as above 10¹⁶ CFU per gram of the kibble, such as 10¹⁷ CFU per gram of the kibble. In another embodiment the kibble contains 10⁶-10¹⁹ CFU/kg, such as 10⁶-10¹⁶, such as 10⁶-10¹², such as 10⁷-10¹⁴, such as 10⁷-10¹², such as 10⁷-10¹⁰, or such as 10⁸-10¹⁰ CFU/kg.

### Defecation Management and Improvement

It should be understood that faeces consistency and faeces condition discussed in connection with the methods or uses according to the invention. Changes in consistency and/or condition can visually be observed when defecation management and improvement such as changes and optimization of the various scores of the PURINA system is the objective for the skilled addressee.

### Timing

The pet food of the present invention can be used at anytime of the animal's life but specific points of importance are, for example: immediately after birth to establish a correct microflora, after changes of feed or housing, pre and post anaesthesia, during and after antibiotic or steroid therapy, after vaccination in preparation for, during and after periods of stress.

As the aim with probiotics is to restore and maintain normal gut function, they should be used whenever gut balance is upset Situations likely to upset gut balance include, for example: gut infections, vomiting and diarrhea, antibiotic therapy, dietary changes, travel, stress, athletic competition, following surgery and anaesthesia, and poor appetite.

Strategic use of pet food of the present invention is during times of stress (vaccination, rehoming) nutritional changes (weaning), or after antibiotic use is very beneficial and an excellent way of introducing the concept of probiotic use.

Embodiments of the present invention relates to a method for defecation improvement in a dog comprising feeding the dog with a vacuum infused pet food kibble comprising within the kibble structure a mixture of probiotic micro-organisms and a fish oil.

One embodiment of the present invention relates to a method for improving defecation in a dog comprising feeding the dog with a vacuum infused pet food kibble comprising within the kibble structure a mixture of probiotic micro-organisms and a fish oil. This dog may e.g. suffer from constipation or diarrhea.

An embodiment of the present invention relates to a method wherein the change in faeces consistency or condition is reached in less than 3 weeks, such as less than 14 days, such as less than 13 days, less than 12 days, less than 11 days, less than 10 days, less than 9 days, less than 8 days, less than 7 days, less than 6 days, less than 5 days, less than 4 days, less than 3 days, less than 2 days, or less than 1 day.

### Laboratory Testing of Faeces

Feces will sometimes be required for microbiological testing, looking for an intestinal pathogen or other parasite or disease.

Biochemical tests done on feces include fecal elastase and fecal fat measurements, as well as tests for fecal occult blood.

It is recommended that the clinician correlate the symptoms and submit specimens according to laboratory guidelines to obtain results that are clinically significant. Formed stools often do not give satisfactory results and suggest little of actual pathological conditions.

Main types of microbiological tests commonly performed on feces include antibody-antigen type tests that look for a specific virus (e.g. rotavirus) and microscopic examination for intestinal parasites and their ova (eggs). The pet food of several embodiments reduces the parasite number.

### Bristol Stool Chart

The Bristol Stool Chart or Bristol Stool Scale is a medical aid designed to classify the form of human feces into seven categories. Sometimes referred to in the UK as the “Meyers Scale,” it was developed by Heaton and Lewis at the University of Bristol and was first published in the Scandinavian Journal of Gastroenterology in 1997. The form of the stool depends on the time it spends in the colon.

The seven types of stool are:
Type 1: Separate hard lumps, like nuts (hard to pass)
Type 2: Sausage-shaped, but lumpy
Type 3: Like a sausage but with cracks on its surface
Type 4: Like a sausage or snake, smooth and soft
Type 5: Soft blobs with clear cut edges (passed easily)
Type 6: Fluffy pieces with ragged edges, a mushy stool
Type 7: Entirely liquid

Types 1 and 2 indicate constipation, with 3 and 4 being the “ideal stools” especially the latter, as they are the easiest to pass, and 5-7 being further tending towards diarrhea or urgency.

### PURINA Faeces Scoring System

The Purina faeces scoring system was developed by Nestle for and similar scoring systems for pets and refers to the evaluation of stool samples based on visual characteristics. The scoring is from 1 to 7 going from hard and dry at 1 to no texture and watery at 7:

1 Very hard and dry, no residue left on the ground when picked up.
2 Firm, not hard. Little residue left on the ground when picked up.
3 Log-like, moist surface, leaves residues but holds form when picked up.
4 Very moist, long shape leaves residues and loses form if picked up.
5 Very moist, present in piles, distinct shape, leaves residues and loses form if picked up.
6 No defined shape, but has texture, occurs as spot or pile, leaves residues if picked up.
7 No texture, watery, flat, occurs as puddles.

The optimal score is considered to be 4.

In one embodiment of the present invention, the faeces condition of the dog is leveled to score 3 and 4 of the PURINA faeces scoring system.

An embodiment of the present invention relates to the use of a pet food kibble comprising within the kibble structure a mixture of probiotic micro-organisms and a fish oil for the manufacture of a composition for improving the faeces condition of a dog to score 3 and 4 of the PURINA faeces scoring system.

Another embodiment of the present invention relates to the use of a pet food kibble comprising within the kibble structure a mixture of probiotic micro-organisms and a fish oil for the manufacture of a composition for maintaining a faeces condition of a dog at score 3 and 4 of the PURINA faeces scoring system.

An embodiment of the present invention relates to vacuum infused pet food kibble comprising within the kibble structure a mixture of probiotic micro-organisms and a fish oil for use in improving the faeces condition of a dog to score 3 and 4 of the PURINA faeces scoring system.

A more specific embodiment of the present invention relates to a vacuum infused pet food kibble comprising within the kibble structure a mixture of probiotic micro-organisms and a fish oil for use in maintaining the faeces condition of a dog at score 3 and 4 of the PURINA feces scoring system.

An embodiment of the present invention relates to a method wherein the fish oil has dynamic viscosity of less than 0.08 pascal-second (Pa·s) at 20° C.

A vacuum infused kibble comprising within the kibble structure a mixture of probiotic micro-organisms and a fish oil for use as a medicament for in the improvement of the faeces condition of a dog to score 3 and 4 of the PURINA feces scoring system.

### Fecal Improvements or Benefits

### Food Allergy

Dog foods can be specially formulated for dogs allergic to common ingredients such as chicken, wheat, or corn. These foods usually contain “novel proteins” and substitute uncommon starches for the usual grains. Meats used in allergy formulas can range from the mundane, such as lamb, beef, or whitefish, to the unusual, such as venison or duck.

Carbohydrates in allergy formulas are usually a less common grain, such as rice or barley, but such ingredients as potato and quinoa are sometimes used.

Allergies are more likely to develop with consistent exposure to certain proteins (i.e. prolonged feeding of the same food).

Diets can possibly contain common ingredients that have been hydrolyzed to prevent them from triggering an immune response.

Sensitive digestive systems are often a side effect of these allergies in dogs.

Hence, an embodiment of the present invention relates to a method for defecation improvement in a dog with allergy, comprising feeding the dog with a vacuum infused pet food kibble comprising within the kibble structure a mixture of probiotic micro-organisms and a fish oil.

An embodiment of the present invention relates to the use of a vacuum infused pet food kibble according to the present invention in the treatment of allergy in a pet.

Another embodiment of the present invention relates to a vacuum infused pet food kibble according to the present invention for the manufacture of a medicament for treatment of allergy in a pet.

In a specific embodiment the allergy is selected from the group consisting of food allergy, medicinal allergy, lactose intolerance, bacterial food poisoning such as but not limited to staphylotoxin, pharmacologic allergies such as but not limited to scombroid (histamine) fish poisoning.

### Constipation

Constipation, costiveness, or irregularity, is a condition of the digestive system in which an animal experiences hard faeces that are difficult to expel. This usually happens because the colon absorbs too much water from the food. If the food moves through the gastro-intestinal tract too slowly, the colon may absorb too much water, resulting in faeces that are dry and hard.

Thus, an embodiment of the present invention relates to a method for increasing bowel transit time in a dog, comprising feeding the dog with a vacuum infused pet food kibble comprising within the kibble structure a mixture of probiotic micro-organisms and a fish oil.

In a more specific embodiment of the present invention is the bowel transit time in a dog is increased by at least 3 days, such as at least 2 days, such as at least 1 day, such as at least 16 hours, such as at least 12 hours, such as at least 8 hours, such as at least 6 hours, such as at least 4 hours, such as at least 2 hours, such as at least 1 hour, such as at least 30 min.

One way of measuring the bowel transit time in a dog is by adding beetroot to the dog food and measuring the time until the red colour of the beetroot can be seen in the faeces of the dog. This test is known as the home test.

For a home test, the dog will drink some red vegetable dye or eat a food like corn kernels or beets. It is then possible keep track of how long it takes for the dye or vegetable to show up in its stool.

Other tests include the dye test and the pellet test.

For a dye test, the dog will swallow a pill that has dye in it and keep track of how long it takes before the dye shows up in its stool.

For a pellet test, the dog swallows small pills (pellets) before having X-rays of its belly. The pellets look like white spots or rings in the X-ray pictures. The dog will have X-rays over time, typically 2 or 3 days to keep track of how fast the pellets move through its intestines.

Defecation may be extremely painful, and in severe cases (faecal impaction) lead to symptoms of bowel obstruction. The term obstipation is used for severe constipation that prevents passage of both stools and gas.

An embodiment of the present invention relates to a method for defecation improvement in a dog with constipation, comprising feeding the dog with a vacuum infused pet food kibble comprising within the kibble structure a mixture of probiotic micro-organisms and a fish oil.

It is an object of preferred embodiments of the present invention that the term constipation relates to dietary, symptoms of bowel obstruction, bowel obstruction, hormonal, anatomical, a side effect of medications (e.g. some opiates), or an illness or disorder.

The vacuum infused pet food kibble will have a positive effect on the constipation over time. Such a positive effect can be observed when a dog with constipation—typically with a Purina score of 1-2—shows optimization of the faeces condition e.g. where the Purina score is 3-4.

An embodiment of the present invention relates to a method wherein the positive effect on the constipation is reached in less than 3 weeks, such as less than 14 days, such as less than 13 days, less than 12 days, less than 11 days, less than 10 days, less than 9 days, less than 8 days, less than 7 days, less than 6 days, less than 5 days, less than 4 days, less than 3 days, less than 2 days, or less than 1 day.

An embodiment of the present invention relates to a vacuum infused pet food kibble according to the present invention for use in the treatment of constipation in a pet.

Another embodiment of the present invention relates to a vacuum infused pet food kibble according to the present invention for the manufacture of a medicament for treatment of constipation in a pet.

### Diarrhea

The presence of diarrhea in dogs should always be cause for concern. There are a plethora of causes of both acute and chronic diarrhea in dogs, including infectious causes, toxins, inflammation or disease of the intestinal tract and parasites. Diarrhea can have a devastating effect on the body due to its dehydrating effect, and left untreated it can lead to blood sugar depletion, circulatory collapse and death. Although mild cases of diarrhea may resolve without intervention, diarrhea accompanied by vomiting, lethargy or any other behavioural changes should be treated as a medical emergency. Because the severity of the cause of diarrhea is not immediately present at onset, prompt medical attention must be sought to quickly diagnose and treat the underlying problem.

Thus, an embodiment of the present invention relates to a method for decreasing bowel transit time in a dog, comprising feeding the dog with a vacuum infused pet food kibble comprising within the kibble structure a mixture of probiotic micro-organisms and a fish oil.

In a more specific embodiment of the present invention is the bowel transit time in a dog is decreased by at least 2 days, such as at least 1 day, such as at least 16 hours, such as at least 12 hours, such as at least 8 hours, such as at least 6 hours, such as at least 4 hours, such as at least 2 hours, such as at least 1 hour, such as at least 30 min.

Diarrhea is always a symptom of an underlying problem, and not a disease in itself. Diarrhea can be used to describe a varying severity of a problem, from occasional loose stools to a continuous watery stream of faeces. Unfortunately there are many potential causes of diarrhea in dogs.

An embodiment of the present invention relates to a method for defecation improvement in a dog with diarrhea, comprising feeding the dog with a vacuum infused pet food kibble comprising within the kibble structure a mixture of probiotic micro-organisms and a fish oil.

The vacuum infused pet food kibble will have a positive effect on the diarrhea over time. Such a positive effect can be observed when a dog with diarrhea—typically with a Purina score of 6-7—shows optimization of the faeces condition e.g. where the Purina score is 3-4.

An embodiment of the present invention relates to a method wherein the positive effect on the diarrhea is reached in less than 3 weeks, such as less than 14 days, such as less than 13 days, less than 12 days, less than 11 days, less than 10 days, less than 9 days, less than 8 days, less than 7 days, less than 6 days, less than 5 days, less than 4 days, less than 3 days, less than 2 days, or less than 1 day.

In a particular preferred embodiment the positive effect on the diarrhea is reached in less than 1 day, such as less than 16 hours, less than 12 hours, less than 8 hours, less than 4 hours, or less than 2 hours.

An embodiment of the present invention relates to the a vacuum infused pet food kibble according to the present invention for use in the treatment of diarrhea in a pet.

Another embodiment of the present invention relates to a vacuum infused pet food kibble according to the present invention for the manufacture of a medicament for treatment of diarrhea in a pet.

### Water Activity

The moisture content and water activity of faeces can be used for evaluation.

The term “Water activity (a_{W})” reflects the active part of moisture content or the part which, under normal circumstances, can be exchanged between the product and its environment. The active part of moisture content and, therefore, water activity, provide better information than the total moisture content regarding the micro-biological, chemical and enzymatic stability of perishable products such as foods and seeds. Water activity can be defined as:

a_{w}=p/ps and % ERH=100×a_{W}

In these equations “p” is the partial pressure of water vapor at the surface of the product, “p_{S}” is the saturation pressure, or the partial pressure of water vapor above pure water at the product temperature and “% ERH” is the equilibrium relative humidity.

Typically will the water activity be low in e.g. the faeces of a constipated dog and high in e.g. a dog with diarrhea.

Thus, it is an embodiment of the present invention to provide a method for changing the water activity in the faeces of a dog, comprising feeding the dog with a vacuum infused pet food kibble comprising within the kibble structure a mixture of probiotic micro-organisms and a fish oil.

An embodiment of the present invention relates to the use of an vacuum infused pet food kibble according to the present invention for the changing the water activity in the faeces of a pet.

### Intestinal Parasites

Intestinal parasites are a very common cause of diarrhea in dogs. There are many types of parasites that can infect dogs, and diarrhea is often one of the most common symptoms of a parasite infection.

Roundworms are one of the most commonly seen intestinal parasites in puppies. Although roundworms are not commonly active in most adult dogs, puppies are especially susceptible to their presence and side effects. A pot-bellied appearance, poor growth and a rough, dull hair coat are signs of a worm infestation. Diarrhea and vomiting may be present as well, and the dog may expel worms in their stool or vomits. If allowed to continue unchecked, the worms can cause pneumonia, intestinal obstructions and death.

Hookworms can be seen in dogs of all ages, but are most common in warmer, humid climates. Transmitted by ingestion of contaminated faeces, mature hookworms attach to the lining of the intestinal tract and feed on the blood supply there. In pregnant dogs, the hookworms migrate into the foetuses, and begin to infest the puppies before they are even born. Hookworms in puppies can be devastating, as they can cause severe anaemia, weakness and bloody diarrhea.

While not a worm, Giardia is an intestinal parasite caused by a single-celled organism that lives in the intestines of infected animals. Recent research has shown that Giardia is present in up to 11% of the general population of pets, and as many as 50% of puppies, Giardia can be transmitted from pet to pet, through contaminated feed or water, and through the soil. The most common symptom of Giardia is diarrhea of varying severity. However, many animals who are infected with Giardia can show no symptoms for extended periods of time, which makes routine testing even more important.

Coccidia is another single-celled organism that infects the small intestine of dogs. Dogs with coccidia may show know signs of illness, and some may have severe bouts of watery stools and bloody diarrhea, vomiting, depression and fever, and even death as a result of severe dehydration. These severe side effects of coccidia are most common in puppies and adult dogs suffering from other illnesses.

Thus, in one embodiment the present invention relates to the treatment of infection with intestinal parasites in a dog comprising feeding said dog with a vacuum infused pet food kibble of the present invention.

An embodiment of the present invention relates to the a vacuum infused pet food kibble according to the present invention for use in the treatment of intestinal parasites in a pet.

Another embodiment of the present invention relates to a vacuum infused pet food kibble according to the present invention for the manufacture of a medicament for treatment of intestinal parasites in a pet.

### Bacterial Infections

Other causes of acute diarrhea in dogs can include bacterial infections, such as salmonella and E. coli, toxin exposure, such as from insecticide and lead, and even stress.

Treatment of a dog suffering from diarrhea depends on what may be the cause. In cases of intestinal upset, a bland diet may be all that's needed to settle the stomach. Parasites can be treated with de-wormers, and a drug may be prescribed to help return the digestive system to working order. Treatment of severe diarrhea will begin with intravenous fluid therapy, and balancing of electrolyte levels to combat the fluid loss caused by the diarrhea. By combining the various treatments with vacuum infused pet food kibble of the present invention, the dog will recover much faster than with conventional pet food.

An embodiment of the present invention relates to a vacuum infused pet food kibble according to the present invention for use in the treatment of bacterial infections in a pet.

Another embodiment of the present invention relates to a vacuum infused pet food kibble according to the present invention for the manufacture of a medicament for treatment of bacterial infections in a pet.

### Chronic Problems

While acute cases of diarrhea can be cause for great concern, chronic diarrhea, while less common.

Diarrhea that persists for three or more weeks is considered chronic. Often the stool may begin to firm, only to become soft and unformed again. It is not uncommon to see mucous or even small amounts of blood in the sample. Because chronic diarrhea can lead to poor digestion and absorption of nutrients, often dogs will not eat well, have a low energy level and poor quality hair coat.

Food allergies and intolerances are a common cause of mild chronic diarrhea. Similar to lactose intolerance in people, dogs may have or develop allergies or sensitivities to variety of ingredients in dog food, leading to chronic inflammation in the intestinal tract.

An embodiment of the present invention relates to a vacuum infused pet food kibble according to the present invention for use in the treatment of chronic diarrhea in a pet.

Another embodiment of the present invention relates to a vacuum infused pet food kibble according to the present invention for the manufacture of a medicament for treatment of chronic diarrhea in a pet.

### Pancreatitis

Pancreatitis can present in dogs in both an acute form, as well as a chronic problem. The pancreatic gland is responsible for secreting hormones such as insulin and glucagons into the bloodstream to regulate blood sugar levels, as well as making the digestive enzymes that break down food for digestion. Pancreatitis, or inflammation of the pancreas, can cause these digestive enzymes to decrease, and in severe cases the enzymes may begin to digest the actual organs of the dog instead of digesta. Diarrhea, abdominal pain, vomiting and a poor appetite are the symptoms of pancreatitis, but because these symptoms are shared with so many other gastrointestinal problems, it can be hard to diagnose.

An embodiment of the present invention relates to a vacuum infused pet food kibble according to the present invention for use in the treatment of pancreatitis in a pet.

Another embodiment of the present invention relates to a vacuum infused pet food kibble according to the present invention for the manufacture of a medicament for treatment of pancreatitis in a pet.

### Inflammatory Bowel Disease (IBD)

Inflammatory bowel disease (IBD) can also be a cause of chronic diarrhea in dogs. In affected dogs, the intestine is taken over by inflammatory cells, eventually leading to scar tissue throughout the lining of the digestive system. Although the exact cause of IBD is unknown, nutrition, genetics and the immune system are thought to play a role in its development. Dogs with a long history of diarrhea or weight loss that have been found to be free of parasites and diarrhea causing agents should be considered for IBD. Diagnosis of IBD can be difficult, and often requires an intestinal biopsy to confirm. Treatment is aimed at reducing the inflammation, as well as dietary changes to provide a more easily digestible food source.

An embodiment of the present invention relates to a vacuum infused pet food kibble according to the present invention for use in the treatment of IBD in a pet.

Another embodiment of the present invention relates to a vacuum infused pet food kibble according to the present invention for the manufacture of a medicament for treatment of IBD in a pet.

Whether chronic or acute, diarrhea is almost always a sign of an underlying medical condition that needs to be addressed. Because diarrhea in itself has the potential to be life threatening, any dog suffering from more than a short-term bout of diarrhea, or dogs showing signs of other medical problems, should immediately be feed with vacuum infused pet food kibble of the present invention.

In addition, because young puppies are so susceptible to several potentially fatal viruses, the presence of diarrhea in any puppy should be treated as a medical emergency until proven otherwise.

Probiotic micro-organisms (hereinafter: probiotics) are living micro-organisms, which upon ingestion in certain numbers, exert health benefits beyond basic nutrition. The beneficial effects that probiotics may induce are numerous and form part of the knowledge of the skilled person. As few examples one may mention the reduction of lactose intolerance, the inhibition of pathogenic bacteria and parasites, the reduction of diarrhea, activity against Helicobacter pylori; the prevention of colon cancer, the improvement or prevention of constipation, the in situ production of vitamins, the modulation of blood lipids, and the modulation of host immune functions.

### General Health and Wellbeing

The various bowel problems described above can have a dramatic effect of the general health and wellbeing of a pet.

A pet can, in addition to the bowel problems, suffer from other accompanying problems like unrest, lack of sufficient energy uptake and decreasing effect of the immune defense system.

Thus, the use of a vacuum infused pet food kibble according to the present invention for maintaining a normal bacterial flora and restoring a balanced bacterial flora in the pet is an embodiment of the present invention.

An embodiment of the present invention relates to a vacuum infused pet food kibble according to the present invention for use in increasing the digestive uptake from the intestinal tract in the pet.

Another embodiment of the present invention relates to a vacuum infused pet food kibble according to the present invention for use in improving the immune defense system in the pet.

### Dosage Regime

One embodiment of the present invention relates to dosage regime packaging solution wherein the content of the daily feed is comprising ¼ of the new diet with probiotics and ¾ of the old food for the first 3 days, then feed a half portion new food and half old food for another three days and then ¼ old food and ¾ new probiotic food for another three days.

### Fecal Management

The management of faeces is an issue of hygiene, since faeces contribute to spreading of diseases and intestinal parasites.

### Animal Waste Collection

Animal waste collection as a pollution source control; involves using a combination of educational outreach and enforcement to encourage residents to clean up after their pets. The presence of pet waste in stormwater runoff has a number of implications for urban stream water quality with perhaps the greatest impact from fecal bacteria.

Non-human waste represents a significant source of bacterial contamination in urban watersheds. Genetic studies conclude that 95 percent of the fecal coliform found in urban stormwater was of non-human origin. Bacterial source tracking studies in a watershed in the Seattle, Wash. area also found that nearly 20% of the bacteria isolates that could be matched with host animals were matched with dogs.

Animal waste collection programs use awareness and education, signs, and pet waste control ordinances to alert residents to the proper disposal techniques for pet droppings, however the stool condition of the faeces represent a barrier for many pet owners that refuse to collect low-viscosity fecal material. Thus, one purpose of the present invention relates to minimize the amount of low-viscosity fecal material in pets in urban areas.

The pet food of the present invention enables easy and hygienic animal waste collection by optimizing the frequencies of score 3 and 4 of the PURINA faeces scoring system in the average population of pets feed with the vacuum infused pet food of the present invention.

### General

It should be noted that embodiments and features described in the context of one of the aspects of the present invention also apply to the other aspects of the invention.

All patent and non-patent references cited in the present application, are hereby incorporated by reference in their entirety. Reference to any prior art in this specification is not, and should not be taken as, an acknowledgment or any form of suggestion that this prior art forms part of the common general knowledge in any country.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In addition, singular reference do not exclude a plurality. Thus, references to “a”, “an”, “first”, “second” etc. do not preclude a plurality.

The invention will now be described in further details in the following non-limiting examples.

### EXAMPLES

### Example 1

### Process Description

Vacuum core liquid coating is the process, which is used to place the bacteria within the kibble/porous structure.

The manufacturing process is carried out in a sealed environment.

Firstly the non-coated product is coming out of dryer (vertical drying system with 2 levels) at a temperature of 45° C. to 60° C. (depending on data received from extruder). Then the non-coated product is going into the drum of the vacuum core coater. Coater is closing and starts moving (inside pressure 1 bar) the product and is creating the vacuum atmosphere. During the process vacuum liquid coating, fats are vaporised onto the product under vacuum condition (0.5 bar) Temperature of liquid during process is 20° C. to 25° C. optimum 22° C. and preservation in container is 22° C. Normal pressure (1 bar) condition is restored inside the coater. Fish oil mixed with probiotic product ingredient (Enterococcus faecum or other) is sprayed onto the product under a new vacuum condition (0.7 bar). Normal pressure (1 bar) condition is restored inside the coater. Digest is sprayed onto the product under the last vacuum condition (0.8 bar). Normal pressure (1 bar) is restored inside the coater. Finally coater is opened and the product released into the cooler.

### Example 2

Over a three year period, Probiotics International Ltd. carried out definitive work at Birmingham University investigating improved methods of protecting micro-organisms. This work has been applied in practice but is under constant review as further research findings come to hand.

This method describes the enumeration of Streptococcus and Enterococcus spp. by a surface inoculation technique.

The method is applicable to powder, pellet and oil based (including paste) food supplement such as probiotics.

For the purposes of this test, streptococcus (including Enterococcus) species are defined as bacteria forming typical colonies under the conditions of the test, are Gram-positive cocci and give a negative reaction in the catalase test.

Apparatus:
Automatic pipettor, 0.02 ml
Glass beads, sterile
Incubator set at 30+/−1° C. (or 37+/−1° C., or 22+/−1° C.)
Microscope
Pipettor calibrated to deliver 20 μl, 1.0 ml and 9.0 ml with associated sterile tips/graduated pipettes
Standard Methods (Plate Count) agar plates (SMA)
Sterile capped test-tubes
Sterile wide-mouthed, screw-topped containers
Stomacher and sterile stomacher bags
Top loader balance with tare facility, sensitivity 0.01 g
Vortex mixer

Media and Reagents:
2% (w/v) aqueous sodium citrate solution (for certain dairy products)
3% Hydrogen peroxide solution
Blood agar plates (BA)
Isopropyl myristate (myristic acid isopropyl ester)
KF Streptococcus agar (KF)
Maximum Recovery Diluent (MRD)—contains 0.1% peptone, 0.85% NaCl

### Method:

Prepare a 1/10 sample homogenate and further decimal dilutions as described in methods A:1a and A:1b below.

Starting with the highest dilution, apply two 0.02 volumes of each dilution to the surface of an appropriately marked segment of a KF plate and a BA plate (see A:2c).

Allow the inocula to dry. Invert the plates and incubate at 37° C. for 48+/−2 hours. Examine the plates after 48 hours and count. Colonies of most streptococci will normally appear as discrete small to medium grey or white colonies on blood agar medium. Colonies of enterococci appear maroon/dark pink on KF streptococcus agar, and will be apparent after one day of incubation. Streptococci other than enterococci will grow on the blood agar medium but may not grow on KF agar.

Count the colonies of streptococci/enterococci on both media at the end of the incubation period and record.

Confirm the presence of streptococci by colonial appearance and by performing Gram staining of different colonial forms if necessary. Further confirm identity by performing the catalase test. Gram positive cocci that give a negative reaction in the catalase test are considered as streptococci/enterococci.

### Reporting

To obtain the count per g, multiply the total number of colonies counted by the fraction of 5 colonies confirmed as streptococci (enterococci), then divide by the dilution used.

If a surface drop plate has been used, calculate the count per gram (g) from the confirmed colony count as described in Method A:2c above.

Report the count of streptococci (enterococci) per g (or ml) of sample. If the count is below 100, express the count to the nearest 5. If the count is 10 or more, express the count as two significant figures multiplied by the appropriate power of 10, with one figure before and one figure after the decimal point.

If no colonies are detected at the 10⁻¹ dilution, report the Total Viable Count (TVC) as <2.5×10²/g.

Limit of detection: 2.5×10²/g

### Method A:1a Preparation of Sample Homogenates

This method describes the preparation of samples to produce a homogenate suitable for enumeration purposes. The homogenate can be used for the preparation of further dilutions.

Preparation and initial dilution of the samples varies according to the nature of the sample being examined and each individual client's protocol. In general, a 10-25 g sample is accurately weighed using aseptic techniques and homogenized in sufficient diluent to obtain either a 1/10.

### Powder and Pelleted Preparations

Thoroughly shake or mix the sample if possible in its container before taking the laboratory aliquot.

Aseptically weigh at least 10 g accurately into a tared stomacher bag.

Add approximately twice the weight of isopropyl myristate

Add a weight of MRD numerically equal to nine times the weight of sample to prepare a 1/10 dilution. Record the final weight of sample plus diluent, which should be 10 times the weight of the sample ±5%, e.g. if 10.5 g of sample has been weighed out the final weight should be 105 ml±5% or in the range 100.3-110.2 ml.

Allow to rehydrate for 30 minutes before homogenizing.

Place the bag in the stomacher and operate the machine for 1-2 minutes.

Transfer to a sterile wide-mouthed screw-topped container.

Use this 10⁻¹ homogenate to make further decimal dilutions as described below. The time lapse between preparing the 10⁻¹ homogenate and inoculation of the culture media should not exceed 45 minutes.

### Method A.1b Preparation of Decimal Dilutions

All dilutions prepared from the 10⁻¹ homogenate should be prepared within 15 minutes of preparation of the homogenate. The nature of the sample under investigation will determine the number of dilutions required in order to obtain a count (TVC) per gram.

### Method

Using MRD, prepare a series of 9±0.1 ml dilution blanks in sterile test tubes for each sample.

Label the series with the sample laboratory number and identify the dilution tubes.

Mix the sample homogenate by vortexing and allow any large particles to settle before removing an aliquot. If there is a fat layer, take the aliquot from the aqueous layer.

The time lapse between preparation of the sample homogenate and inoculation of the growth media shall not exceed 45 minutes.

Dilution from a 1/10 Homogenate

(i) Add 1 ml of the 1/10 homogenate to the first 9 ml dilution blank. Replace the cap on the test tube.

(ii) Vortex to mix the contents. This tube forms the 10⁻² dilution.

(iii) Using a fresh tip each time, repeat the process to obtain further decimal dilutions.

### Method A:2c Aerobic Plate Count—Surface Drop Method

This method describes the enumeration of aerobic mesophilic organisms by a surface drop technique. The method describes incubation at 30° C., but may be applied to other temperatures e.g. 22° C., 37° C. A surface method of enumeration is used in preference to a pour plate method to obtain maximum recovery of obligately aerobic organisms, and to avoid the possibility of heat stress which may be introduced using molten agar in poured plate methods. The drop plate method minimizes operator fatigue and hence inaccuracies in enumeration, reduces problems encountered due to spreading colonies produced by some strains of Bacillus spp., and facilitates differentiation between colonies and food particles. However, because of the small volumes of sample dilutions used, it is most suitable for use where levels of organisms are expected to exceed 3000 CFU per gram.

### Method

Prepare the sample homogenate and further decimal dilutions as described in methods A:1a and A:1b above.

Mark the plates on the bottom with the laboratory sample number. Divide the plate into segments (maximum four per plate) and mark each segment with the dilution to be used. Use SMA plates.

Inoculate the plate media within 45 minutes of preparing the sample homogenate. Use the 20 μl pipettor with sterile tip and the reverse pipetting technique. Start with the highest dilution and deliver two separate drops on to the surface of the relevant segment of the plate. Repeat with the next lowest dilution until all dilutions have been applied to the plates.

If counts are expected to be low, 5 or 10 drops of the food homogenate (10⁴ dilution) or liquid sample may be applied to a half or whole plate to decrease the limit of detection.

Replace the lids, allow the drops to dry at room temperature.

Invert the plates and place in an incubator set at 30° C. for 72+/−3 hours (or 22° C. for 72+/−3 hours, 37° C. for 24+/−2 hours or 48° C.+/−2 hours as required by client).

At the end of the incubation period count and mark the colonies at all dilutions that have countable colonies. Record the counts. The number of countable colonies per drop will normally be less than 20, but for some organisms that form small colonies it is easily possible to count more (e.g. lactic acid bacteria).

### Calculations and Expression of Results

If only one dilution has countable colonies, the count per gram is given by the formula:

N=Mean count per drop×1/d×50, where N=count/g, d=dilution

If there are two or more colonies at two successive dilutions with countable colonies, use the weighted mean formula below to obtain the count per gram. Include the counts for all drips at the chosen dilutions including drops with no colonies.

$$\frac{N * \sum C}{( {v}_{1} + 0.1 {v}_{2} ) d}$$

Where ΣC=Sum of colonies on all drops counted
v₁=total volume of drops in first dilution counted
v₂=total volume of drips in second dilution counted
d=dilution from which first count was obtained

NOTE: Where there is evidence of inhibition, only count the colonies of the highest dilution yielding 2 or more colonies per drop.

### Reporting

Report the count per gram (g) or ml of sample to two significant figures. Also report the conditions of performance of the test e.g.: 30° C./72 hr. Round up if the third digit of the count is 5 or more, round down if the third digit is 4 or less. If the count is greater than 100, record the count to the power of 10, with one number each side of the decimal point.

If no colonies are present even at the lowest dilution of the sample, report a value of less than the limit of detection per gram (g) or ml.

If the drops at the highest dilution contain too many colonies to count, report the count as greater than the countable number of colonies to the appropriate power of 10.

NOTE: It is helpful to the client to indicate a range within which the count lies.

### Limit of Detection

Using 2 drops of 10⁻¹: 2.5×10²/g or ml

Using 5 drops of 10⁴: 1.0×10²/g or ml

Using 10 drops of 10: 50/g or ml

A: 16a Methodology for the enumeration of Streptococci and Enterococci spp.

Prepared by Probiotics International, Matts Lane, Stoke sub Hamdon, Somerset, TA14 6QE. All the test were carried out in the laboratory Microcheck Technical Services Ltd 10 Sandown Centre, White Horse Business Park, Trowbridge, Wiltshire BA14 0XD.

### Example 3

### Measuring the Viscosity of Selected Oils

Equipment: Dynamic rheometers Physica MCR 301 (Anton Paar GmbH, Germany), C-PTD200 Peltie temperature control and CC27 coaxial cylinder measuring system (in/out diameter 26.66 and 28.92 mm)

Method: The viscosity of the oils was measured at turning speed of 180 rpm; at temperature range of 5 to 50° C., heating rate was 0.5° C./min, viscosity was registered after each 1° C. Two parallels of samples were measured. The table of FIG. 2 lists the average viscosity (Pa·s) of the oils.

UPP, Belgium supplied:
1. Crude fish oil
2. Salmon oil A
3. Refined maize oil
4. Cod liver oil

Vobra Special Petfoods BV, Netherlands Supplied:
5. Salmon oil B
6. Soybean oil (with antioxidant)
7. Sunflower oil (with antioxidant)
8. Linseed oil
9. Borage oil

Results: One of the oils, Salmon oil A (supplied by United Petfoods (UPP) Belgium), displays unique viscosity properties over the remaining oils tested in the present experiment. Although the viscosity of Salmon oil A at refrigerating temperatures is higher than the remaining fish oils, in the temperature range of range 20-25° C. Salmon oil A loose viscosity much faster with increasing temperature than the remaining oils tested. Accordingly, the change in the viscosity (ΔPa·s/° C.) Salmon oil A with temperature (within the temperature range 20-25° C.) of Salmon oil A is different from the remaining oils tested in the experiment. The change in the viscosity (ΔPa·s/° C.) of crude fish oil (supplied by United Petfoods (UPP) Belgium), cod liver oil (supplied by United Petfoods (UPP) Belgium) and salmon oil B (Vobra Special Petfoods BV, Netherlands) is basically the same within the temperature range of 20-25° C.

Salmon oil A was chosen as carrier oil (vehicle) for preparation of a probiotic/oil suspension for manufacturing a probiotic extrusion product by vacuum inclusion of the suspension. Salmon oil A was preferred over the remaining oils due to the unique viscosity properties in the temperature range 20-25° C. The manufacturing process is performed in temperature range 20-25° C. and the use of Salmon A oil will avoid the clotting of a spraying tip (nozzle) of a vacuum coater and improve homogenous distribution of probiotics in the carrier oil. Additionally oil/probiotic mixture is constantly mixed in the tank before introduction into a vacuum coater, thus formation of a probiotic flakes (non suitable for a vacuum coating) is avoided during the bacteria addition to the oil.

The viscosity of the analysed oils are equal at high temperatures (starting from 40° C.), but such high temperatures have severe effects on the viability of probiotic bacteria, and consequently on the CFU/kg of the final food product.

Taken together, viscosity of oils is influenced by the source of the oil and substances added to the oil. The substances added to the oil affects the properties of the oils such as the viscosity. Accordingly, the properties of the oil have to be taken into account when choosing an oil as a vehicle for infusion of probiotic micro-organism. Since, care should also be taken to ensure that the substances added to the oil in the preparation of the oil/probiotic suspension does not severely affect important parameters of the suspension such as the viscosity.

### Example 4

### Mixing of Probiotics and an Oil Solution to Obtain a Probiotic Suspension

The suspension can be obtained by mixing one probiotic micro-organism, in a dry powder form having a total concentration of 10⁹-10¹⁶ CFU/kg dry powder, into an oil. The inclusion rate for the final suspension should be 0.3-15 kg of the probiotic powder per 100 kg oil. When the probiotics are mixed into an oil the probiotics may precipitate if the powder is not mixed slowly into to oil. Thus, not all of the freeze-dried powder should be added at once. To maintain the viability of the probiotics, the temperature of the suspension should not exceed 30° C. The mixing may be performed in a mixing tank, such as an IBC container, under continuously stirring. This mixing may be performed manually. Preferably the obtained suspension is transferred to a storage tank comprising mixing means. The transfer from the mixing tank to the storage tank is preferably done through a bottom outlet in the mixing tank into the storage tank (thus the mixing tank is physically positioned above the storage tank). The suspension is then mixed in the storage tank at a temperature of 15-29° C., not exceeding 30° C. (the mixing may be performed by rotation at 5-350 RPM) to obtain a suspension of homogenously dispersed probiotic micro-organism. The suspension should not be stored for longer than 3 hours in the storage tank before it is used in a vacuum infusion. If the suspension is stored for a longer time the suspension may become contaminated.

### Example 5

### Suspension/Oil Vehicle for Dog Food

The right choice of an oil as a probiotic compound carrier (oil vehicle) is based on the viscosity of the specific oil and the temperature which is needed to be implemented to achieve a particular viscosity. Together with the physical/chemical parameters of the oil which can have an influence on the viability of the probiotics, the organoleptic parameter of the specific oil also is a dramatic factor on an overall product taste and odor. In addition nutritional parameters also need to be considered. Thus, to find an oil vehicle which fulfils all these parameters is not an easy task.

### Organoleptic Parameters:

In case of a probiotic dog food, a suspension with a salmon oil carrier is used to produce an extruded dry dog food, the choice of the salmon oil was based on a fact that dogs eat for 90% with his smell and have a smell 30 times more than humans. Thus, it is very crucial to find the particular oil vehicle for a probiotic compound which will not have an influence on a palatability of the final product (dog food) based on a smell as major organoleptic parameter (especially for a dogs).

### Nutritional Parameters:

Together with above mentioned parameters, an oil used as an oil vehicle for probiotics needs to be “healthy”. High content of a saturated fatty acids, trans fatty acids and etc are generally considered as “unhealthy”. The high concentration of such fats furthermore minimizes the probiotic effect of the ready product and increases the risk of coronary heart disease by raising levels of “bad” LDL cholesterol and lowering levels of “good” HDL cholesterol. Salmon oil out of the animal fats is well known for its unique composition of poly unsaturated fatty acids (omega 3 and omega 6) and thus is generally considered as, healthy” fat.

To be able to provide a product having the above mentioned properties and the same be optimal for vacuum infusion it has been discovered that the viscosity of the oil vehicle is important.

### Viscosity:

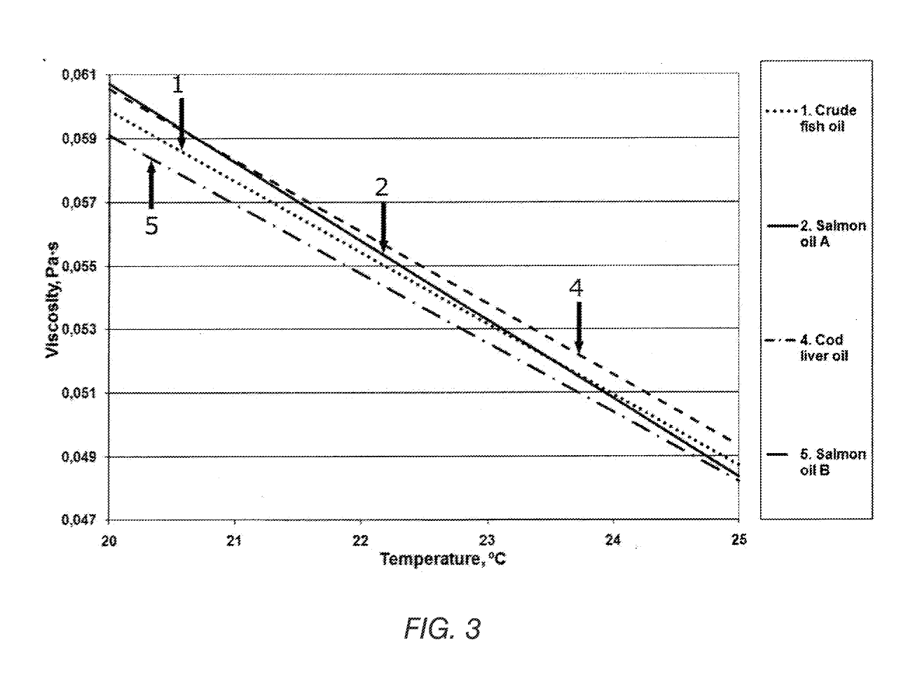

To find a salmon oil which also fulfils the criteria for being suited for vacuum infusion, viscosity of different salmon oils were compared. As shown in FIGS. 2 and 3 not all salmon oils have the same viscosity properties. The viscosity of salmon A decreases faster between 20° C. and 25° C. than does salmon oil B giving an extra advantage of usage of salmon oil A as a carrier (oil vehicle) of a probiotic compound. Salmon oils with such viscosity behaviour improve the mixing ability of the suspension together with equalized dispersal of the probiotic compound in the ready product and reduces sedimentation/wastes during the manufacturing stage with improvement of stability of the probiotic compound within the suspension and thus within the ready product.

Taken together salmon oil A becomes a suited oil vehicle for vacuum infusion of probiotics for animal food such as dog food.

It is to be understood that although the present example refers to dog food it does not mean that salmon oil A cannot be used in other animal products or human products.

### Example 6

### Oil Vehicle/Suspension for Human Food Products

The right choice of an oil as a probiotic compound carrier (oil vehicle) is based on the viscosity of the specific oil and the temperature which is needed to be implemented to achieve a particular viscosity. Together with the physical/chemical parameters of the oil which can have an influence on the viability of the probiotics, the organoleptic parameter of the specific oil also is a dramatic factor on an overall product taste and odor. In addition nutritional parameters also need to be considered. Thus, to find an oil vehicle which fulfils all these parameters is not an easy task.

### Organoleptic Parameters

Usage of animal fats/oils in a human product is limited because of the organoleptic parameters which can have an overall effect on a palatability of the ready product. Thus, such animal oils, like different type of fish oils, may lead to resistance by the end consumer towards such products, even if oil meets the health criterias (e.g. as described in Example 5). Thus, the oil used as a probiotic oil vehicle in a human product needs to meet the viscosity criteria required for optimal vacuum infusion but with different organoleptic parameters than the oils used for animal products. Vegetable oils may be suitable candidates.

### Nutritional Parameters:

Instead of using animal oil it may be advantageous also to be able to have a suitable oil vehicle with vegetable origin. Several vegetable oils have positive health parameters. Linseed oil (Vobra Special Petfoods BV, Netherlands) compared with soy bean oil, maize oil and sunflower oil is considered as “healthy” oil with high concentration of poly unsaturated fatty acids (omega 3 and omega 6) and mild nutty taste. These parameters make linseed oil a suitable candidate as an oil vehicle for human product manufacturing.

### Viscosity:

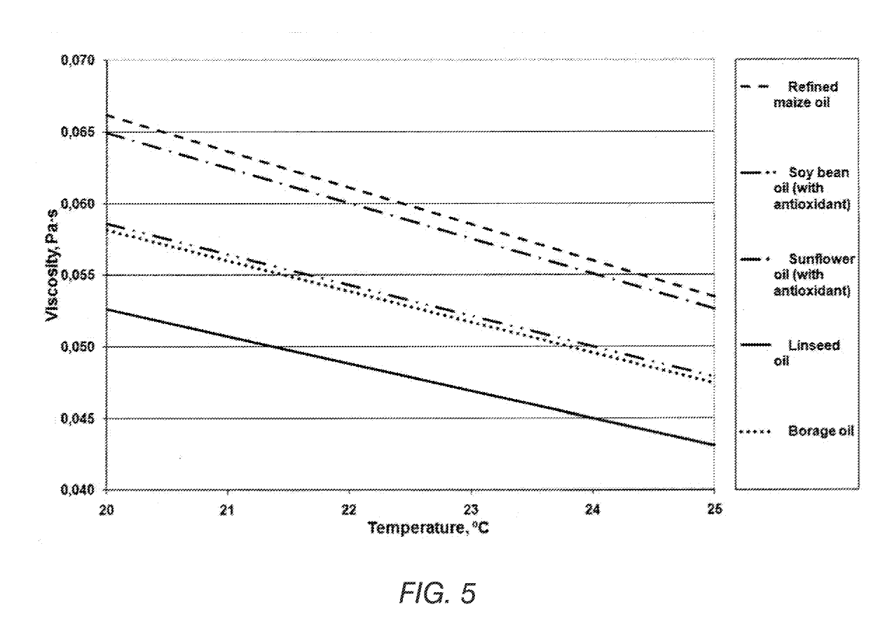

When comparing the viscosity of different oils with vegetable origin in the range of 20° C. and 25° C., it becomes apparent that linseed oil has unique properties for being used as an oil vehicle for vacuum infusion of probiotics (FIGS. 2 and 5). Linseed oil has the lowest viscosity at both 20° C. and 25° C. out of the vegetable oils analyzed. The curve of the linseed has got a small slope (low delta viscosity) but a low viscosity when compared to the other oils. Even when compared to the animal oils (FIGS. 2 and 4), linseed oils has the lowest viscosity at both 20° C. and 25° C.

Taken together, the viscosity of the linseed oil together with its unique physical/chemical and organoleptic parameters makes linseed oil a good candidate for usage as a probiotic oil vehicle for human product manufacturing.

It is to be understood that although the present example refers to human products it does not mean that linseed oil cannot be used in animal products.

### Example 7

### Viscosity of Suspension

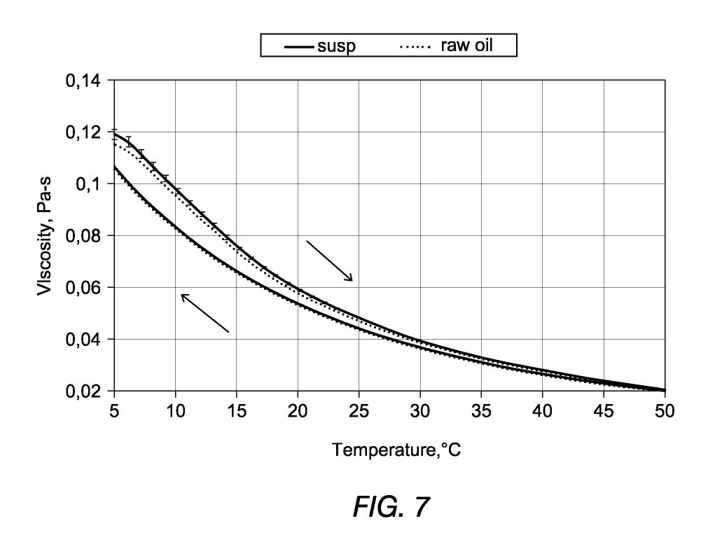

Since the viscosity of the final suspension is a key parameter when the suspension is going to be vacuum infused, the influence of the bacteria on the viscosity of the oil should be tested. FIG. 2 (lines 10-13) and FIG. 7 clearly show that the influence of the bacteria on the final viscosity at different temperatures is minimal. “Susp” (solid line) is salmon oil A with probiotics with a concentration/inclusion rate 1.2 kg/ton of final product. Raw oil (dashed line) is salmon oil A without probiotics. Top lines show the viscosity when the temperature is increased from 5-50° C., whereas the bottom lines show the viscosity when the temperature is decreased from 50-5° C. In the bottom lines the dashed and solid lines are practically positioned on top of each other.

The difference is between the cooling and heating is likely due to residual heat in the analyzed samples.

FIG. 2 (lines 10-13) shows the viscosity of the raw salmon oil vs suspension viscosity at heating from 5° C. to 50° C. and backwards cooling from 50° C. to 5° C. At current inclusion rate which was used the viscosity difference between both samples is minor with average of 0.001 Pa·s at each temperature step between both samples.

Δ visc. (20° C.-25° C.) of raw oil is 0.011 Pa·s at heating phase and 0.009 Pa·s at cooling phase.

Δ visc. (20° C.-25° C.) of suspension is 0.011 Pa·s at heating phase and 0.010 Pa·s at cooling phase.

Overall conclusion can be made that change of Δ visc. (20° C.-25° C.) of both samples at cooling and heating phases are minor and makes a 0.01 Pa·s in average.

In general there will be a difference between different measurements of the viscosity of a specific type of oil. This is likely due to the precise batch used and small variation in the way the samples are handled. Though such small variations are unavoidable the current invention clearly shows that the viscosity of the oil/suspension is indeed important for the viability of the probiotics in the final product.

### Example 8

### Production Plant, Reference to FIG. 8

The plant may comprise one or more storage tanks 2-6 which can be used to store individual solutions, such as a probiotic suspension, a solution of fat, and a solution of digest. The storage tank 2 may be further connected to a mixing tank 1. The reason is that mixing of an oil/fat suspension with a freeze-dried probiotic powder, may result in precipitation of the probiotics if the powder is not mixed slowly into to oil/fat suspension. This mixing may be performed manually. The mixing tank 1 may be physically positioned above the storage tank 2. In this way the suspension in the mixing tank 1 may be transferred to the storage tank 2 through an outlet positioned at the bottom of mixing tank 1. Alternatively, the outlet may be positioned otherwise such as on side of the mixing tank 1. The mixing tank may be adapted to allow emptying the tank from e.g. an outlet positioned on side of the mixing tank 1.

Furthermore, this setup means that the transfer can be performed only by the force of gravity, which may be beneficial for the viability of the probiotics in the suspension.

The storage tank 2 and the dosage unit tank 7 for storing and dosing a probiotic suspension may comprise means for mixing the suspension such as an impeller or a rotational tank or a combination of both. The other storage and dosage tanks may comprise similar means for mixing. Each of the storage tanks 2-6 may then be further connected to individual dosage tanks 7-9. In another embodiment, at least two storage tanks share a dosage tank. Each of the dosage tanks 7-9 may then be further connected to a single vacuum infusion tank 13. In one embodiment these connections comprise at least one spaying nozzle connecting each dosage individually to the vacuum infusion tank 13. In a further embodiment, these connections are sets of spraying nozzles 10-12 connection each dosage tank individually to the vacuum infusion tank 13, allowing for spraying the content of each of the dosage unit tanks individually on the food products present in the vacuum infusion tank 13. This is important to avoid mixing of the oil/fat suspension comprising probiotics with one or more of the other solutions, since intermixing may lower the viability of the probiotics. Thus, at least the spraying nozzles leading from the probiotic-oil/fat suspension to the vacuum infusion tank should not be connected to any of the other dosage tanks.

The precise shape of the spraying nozzles may vary, since the form and shape of the nozzles have to be optimized to the solution/suspension which is going to be sprayed through the nozzles.

The vacuum infusion tank 13 may furthermore comprise one or more openings 16 for receiving a food product. When the food product is in place in the tank the following steps may take place:
a) reduction of the pressure in the vacuum infusion tank to 0.2-0.95 bar,
b) introducing one of the solutions from one of the dosage unit tanks 7-9 through the corresponding one or more sets of spraying nozzles 10-12 at e.g. a temperature of 15-29 C, and
c) restore pressure to 1 bar,

Steps a)-c) may then be repeated with other solutions (or the same solution) to further vacuum infusions into the food product. This is important for getting the subsequent solutions infused into the product. The release of the vacuum may be performed slowly to avoid abrupt changes in pressure which may be harmful to the product and/or the probiotics.

Some vacuum tanks are designed to release the pressure in the vacuum tank using an inert gas, which may actually be effect the stability of fats and thus be harmful for the viability of the probiotics. Thus, in an embodiment the pressure release is not performed with an inert gas such as nitrogen and carbondioxide. It is to be understood that release of the pressure using atmospheric air is part of the invention though atmospheric air comprises nitrogen and carbondioxide.

To get the sprayed solutions evenly distributed in the infusion tank some kind of mixing may be required. Thus the mixing tank may be able to rotate or comprise an impeller or the like. Therefore it may be advantageous if the mixing is performed during the inclusion steps or after each step of ingredient(s) inclusion (in vacuum infusion tank 13).

The vacuum infusion tank may also comprise an outlet leading to a collection vessel 14. The collection tank 14 may be particular useful, when a coating is also required on the food product (which is not going to be vacuum infused). Such a coating may be stored in a vessel 15 connected to the collection tank 14. Examples of coatings could be suspensions comprising honey, natural sweeteners, artificial sweeteners, vitamins, tartar or other additives or the like.

### Example 9

### Probiotic Dog Food Production

The numbering refers to FIG. 9, but the person skilled in the art would easily be able to convert this numbering to the numbering indicated in FIG. 8 where appropriate.

### Set Up Parameters—Input

All ingredients used in the dry meal were grinded with a sieve of 1 mm and the average particle size not exceeded 1.5 mm. Moisture level was at 10.48% in the meal.

The extrusion speed was set up to 3800 kg/h to receive kibbles with a density from 360-380 g/l. Dryer temperature was set up to 120° C. and the moisture of kibbles after sieving stage was 6.20%.

The ratio of probiotic bacteria in the end product was set at 1.2 kg per ton of product. Freeze-dried Enterococcus faecium NCIMB 10415 EC No. 13 (E1707 (new classification)) probiotic bacteria powder with 1×10¹³ CFU/kg (from suppliers certificate of analysis) was pre order for the production (Probiotics International Ltd UK). Laboratory analysis of freeze-dried E. faecium probiotic bacteria powder gave an average concentration of 1.4×10¹³ CFU/kg in the raw probiotic powder used in the particular production.

The preparation of the suspension (oil and bacteria mixture) was done at the earliest one hour before the first vacuum infusion procedure to minimize the risk of oxidation. The storage tank (2) comprising an impeller was completely empty before filling it with the suspension. All residue of a production were eliminated and were not used anymore.

Before the production the animal fat and digest were placed into separate storage tanks (storage tank (3) and storage tank (4) correspondingly).

For each batch of 500 kg of salmon oil, 18 kg of bacteria powder was added and suspension was mixed for not less than 1 hour in a separate, specialized storage tank (2) comprising an impeller in it to form a ready suspension. Mixing speed was set to 180 rpm. At the stage of bacteria powder addition into the salmon oil the temperature of oil was 26° C. and during mixing in storage tank (2), suspension temperature was not less than 22° C. The oil used in this particular production batch was a salmon oil (International Quality Ingredients BV (Netherlands)).

Pressure parameters for the vacuum infusion tank (14) were set up to 650 mbar for chicken fat and digest and 850 mbar for the suspension. The spraying of the added liquids and suspension was done in 3 stages:

Stage 1—animal fat comprising chondroition & glucoseamine,
Stage 2—salmon oil/bacteria suspension, and
Stage 3—digest.

The animal fat and digest were pumped into separate weighing boxes (dosage tank (7) and dosage tank (8) correspondingly) right prior the vacuum infusion.

The suspension was pumped into a separate weighing box (dosage tank (6) with an implemented impeller in it to keep the suspension homogeneous until vacuum infusion in vacuum infusin tank (14). In this way suspension never comes into contact with the digest and the fat before vacuum infusion in vacuum infusin tank (14).

### Measured Parameters—Output

Accordingly to the production batch and factory setup parameters correct amount of suspension was used for the vacuum infusion procedure. Suspension makes a 3% of the end product. E. faecium probiotic bacteria concentration in the suspension was measured prior to vacuum infusion procedure with an average of 1.08×10¹¹ CFU/kg of the suspension.

Samples for probiotic count immediately after vacuum infusion were taken and gave a 2.05×10⁹ CFU/kg of the product.

Vacuum infused dog food kibbles afterwards went to the cooling stage. Samples after the cooling gave result above 1.27×10⁹ CFU/kg of the product right after the cooling procedure with kibble temperature of 21° C. in average at the end of the cooling stage. Moisture after cooling stage was recorded at 8.50%.

At the last production stage the product was placed in silo before packaging and a sample from silo product was sent to laboratory for Weende analysis. Results of Weende analysis are shown in Table 1.

### Additionally—Probiotic Stability Measurement

The product was packed within 3 days after production to avoid all contact with air and any possible loss of bacteria quality/stability. The product was kept in a silo with controlled environmental parameters. The empty silo temperature was 19-20° C., whereas the filled silo temperature was 22° C. with a product moisture level of 7.73%.

After production the kibbles were submitted to different analysis in order to guarantee the quality of the products and the probiotic component. Analysis showed that the kibbles had an average concentration of probiotic bacteria within the range from 1.2×10⁹ CFU/kg to 1×10¹⁰ CFU/kg in the ready product.

Shelf-life test of the produced probiotic dog food confirmed the stability of the dog food for 15 months at room temperature. Probiotic dog food had a probiotic count on a level of 1.06×10⁹ CFU/kg in average during the product shelf-life period (15 months), which corresponds with the product stability.

TABLE 1
Weende analysis

| | Laboratory |
|---|---|
| | results |
| Weende Analysis: | |
| Moisture: | 7.80 |
| Dry matter: | 92.20 |
| Crude ash: | 7.52 |
| Crude fiber: | 2.31 |
| Crude protein: | 24.68 |
| Crude fat: | 11.91 |
| Sugar: | 0.61 |
| Starch: | 47.37 |
| Hygienic parameters: | |
| Salmonella: | absent/25 g |
| Enterobacteriaceae (5*) (/g): | <10/g |
| Clostridium perfringens (/g): | <10/g |

### Example 10

### Production of a Vacuum Infused Probiotic Product Comprising Probiotic Bacteria Optimized for Human Consumption

### Set-Up.

Two commercially available breakfast cereals: 4 grain snack—breakfast cereals “Neljavilja-krõbuskid” (AS BalSnack International Holding, Estonia) and Breakfast cereals—Flakes with cinnamon “Oho” (UAB Naujasis Nevė\check{z}is, Lithuania) were vacuum infused by usage of a probiotic/linseed oil suspension. Oil used in particular trial was linseed oil (OÜ Tervix, Estonia). Probiotic vacuum infused product was finally coated by low in glycemic index syrups. Commercially available probiotic bacteria formulation Protexin BALANCE (Protexin Health Care, UK) and two different low in glycemic index syrups of Agave (Allos GmbH, Germany) and Maple (Cofradex ApS Denmark) were used. Vacuum infusion was done by usage of Zepter VG-010 Vacsy Vacuum Pump with glass container VG-011-19 (Zepter International Group).

### Methods

150 grams of breakfast cereals per each product and per each batch were used. Daily dose of probiotics (1 capsules containing 1×10⁸ CFU, accordingly to the producer of probiotic compound) was added per 4.5 gr of the carrier (linseed oil) making a 3% (usual production ratio) out of the product amount to be infused.

Protexin BALANCE multi strain probiotic bacteria was gradually introduced into the carrier to receive a homogeneous suspension. Prepared suspensions (oil and probiotics) were continuously mixed on a Vortex prior the spraying to guarantee the homogeneity of the suspensions.

The sparing of the suspensions and syrups was done by usage of sprinklers. Before the vacuum infusion process the number of sprayings (by weight) was determined to receive a 3% coating by the bacteria suspension and 5% coating by the agave or maple syrup coating as a final layer (ratio taken from usual production data).

Prepared suspensions were used for a vacuum infusion into the matrix of a ready for consumption (extruded) human products. Multi-strain probiotic containing different suspensions were sprayed on different breakfast cereals appropriately in ratio of 4.5 gr to 150 gr of the product (3%). Afterwards product was coated by different syrups (agave vs maple) sprayed on different breakfast cereals appropriately in ratio of 7.5 gr to 150 gr of the product (5%). Product was mixed simultaneously with spraying to guarantee the equal dispersion of sprayed suspensions and coating syrups onto the different products used in the trial.

Spraying of the suspensions and mixing was done in one and the same vacuum infusion glass bowl sterilized prior the trial to eliminate the probiotic count reduction and contamination between intermediate processes. Glass bowel was closed with a special vacuum control lid and vacuum atmosphere (500 mBar and 630 liters/s) was created for approx. 40 seconds in the glass bowl containing the product (until the red indicator turning on the pump).

All syrups used for final layer coating (stage 2 coating) in particular trial were preheated up to 50° C. prior the coating process to have the best viscosity for spraying. Sprayings of appropriate suspensions and final coating layers were done in 2 separate stages corresponding to the suspension (linseed oil) and syrup type (agave vs maple).

Stage 1 (3% of product weight). During the process of vacuum coating, the prepared probiotic suspension was vaporized onto the appropriate product and vacuum pressure of 500 mbar was created for approx. 40 seconds. Normal atmospheric pressure (1 bar) conditions were restored inside the vacuum infusion device (glass bowl) by gradual opening of the pressure control system.

Stage 2 (5% of product weight). Preheated up to 50° C. final coating layer (agave vs maple syrup) was vaporized onto the product and vacuum pressure of 500 mbar was created for a 20 seconds. Normal atmospheric pressure (1 bar) conditions were restored inside the vacuum infusion device (glass bowl) by gradual opening of the pressure control system.

All different products coatings with different suspensions were done at 3 parallels.

All experiments were done at room temperature.

Coated with different suspensions products were sent to laboratory for a Total Viable Count (TVC) analysis and a shelf-life trial of 1 months. All samples were shipped in sterile Falcon tubes each containing approx. 5 g of sample.

### Measurements

Each parallel was measured for 0 day (immediate) count, 2 weeks, 1 month interval. Each parallel was placed under 3 different storage conditions: refrigerated condition temperature of 6-8° C., standard condition temperature of 18-24° C., and condition temperature 36-38° C. Accelerated temperature conditions were considered as ×3 times faster, meaning that 1 month result of accelerated condition temperature equals to 3 month result at standard temperature condition, thus giving product stability at room temperature for 3 months.

All the TVC measurements of used raw materials are given in Table 1 and all TVC measurements of performed shelf-life trial are given in the Table 2.

TABLE 1
TVC measurements of used raw materials
Raw ingredients, TVC CFU/g

| | |
|---|---|
| Pillows bulk | 40 |
| Kibbles bulk | 10 |
| Raw bacteria powder | 9.00E+10 |
| Linseed/bacteria suspension | 1.60E+08 |

TABLE 2
TVC measurements of shelf-life trial, pillows vs kibbles

| Probiotic | Final | Storage | Bacteria count at different time | | |
|---|---|---|---|---|---|
| suspension | coating | condition | stages | | |
| carrier | layer | temp., ° C. | Day 0 | 2 week | 1 month |

Pillows, TVC CFU/g

| | | | | | |
|---|---|---|---|---|---|
| Linseed oil | Agave | 6-8 | 9.60E+05 | 9.20E+05 | 9.13E+05 |
| | | 18-24 | 9.60E+05 | 1.00E+06 | 1.25E+06 |
| | | 36-38 | 9.60E+05 | 7.23E+05 | 6.47E+05 |
| | Maple | 6-8 | 3.16E+06 | 2.23E+06 | 1.50E+06 |
| | | 18-24 | 3.16E+06 | 2.54E+06 | 1.95E+06 |
| | | 36-38 | 3.16E+06 | 8.93E+05 | 8.07E+05 |

Kibbles, TVC CFU/g

| | | | | | |
|---|---|---|---|---|---|
| Linseed oil | Agave | 6-8 | 7.73E+05 | 7.97E+05 | 7.47E+05 |
| | | 18-24 | 7.73E+05 | 8.80E+05 | 9.93E+05 |
| | | 36-38 | 7.73E+05 | 5.63E+05 | 4.63E+05 |
| | Maple | 6-8 | 1.63E+06 | 1.16E+06 | 1.13E+06 |
| | | 18-24 | 1.63E+06 | 1.00E+06 | 1.02E+06 |
| | | 36-38 | 1.63E+06 | 6.53E+05 | 5.57E+05 |

### Conclusions

Trial results clearly indicate that in initial Total Viable Count of bulk commercially available breakfast products (see Table 1, Pillows bulk and Kibbles bulk) showed dramatically lower counts than at the end of the trial after introducing the probiotic bacteria within the matrix of products under the trial (Table 2, 0 day count). This clearly indicates that the particular technology used for the vacuum infusion of the breakfast products (kibbles and pillows) described in the methods is suitable for the probiotic breakfast product manufacturing. Additionally the shelf-life study results (see Table 2) clearly indicate that both products used in particular trial (pillows and kibbles) have a good stability up to 3 months at the room temperature and all the Total Viable Count (TVC) fluctuations at different storage temperatures of different suspension carriers and final coating layers stay within 1 log.

Finalizing the trial results, all the products used in current trial together with different suspension carriers and final coating layers used, maintained the probiotic count on a sufficient level during the entire shelf-life trial period, which assures survivability of the sufficient amount of probiotic compound (daily dosage) through the stomach acids passage and further positive probiotic function implementation on a host (human) organism. These results clearly indicate that different types of extruded food products (e.g. kibbles and pillows) may be vacuum infused with probiotics and maintain a high TVC over a longer period of time.

### Example 11

### Highly Digestible Functional Probiotic Food, for Dogs of all Ages with Sensitive Digestion, Allergies and Adverse Reaction to Other Foods

### Ingredients

Lamb, rice, maize, chicken, animal fat, chicken protein, vegetable pulp, maize gluten, egg, yeast, linseed, fish oil, yucca extract, hydrolysed crustaceans, hydrolysed cartilage, FOS, lecithin, vitamins & minerals, no colorants. Antioxidant: according to EU regulations.

Product contains Enterococcus faecium NCIMB 10415 EC No. 13 (E1707 (new classification)). (registered in EU for use in dogs) viable probiotic strain with average concentration of 10⁹ CFU/kg respectively in complete feed.

Enterococcus faecium is a scientifically investigated and widely used probiotic culture that is added to food to exert beneficial effects on the host by regulating the host intestinal microbial balance.

### Effects and Benefits

### Balances Sensitive Gut Flora

Special balanced content of the SENSITIVE helps to establish balanced and beneficial microflora in dog intestine with sensitive digestion.

### Antimicrobial Effect

Competitive exclusion for space with bacteriocins and lactic acid production by Enterococcus faecium helps to avoid contamination and reproduction of harmful and pathogenic bacteria.

### Reduces Stress

Lactic acid produced by Enterococcus faecium lowers pH level and as a result reduces the effects of stress.

### Reduces Diarrhea and Other Digestive Upsets

Metabolic activity of Enterococcus faecium bacteria increases digestibility rate of intestinal tract by producing enzymes, vitamins and lactic acid.

### Average Nutrient Content

### Composition

| | |
|---|---|
| Crude protein | 23% |
| Crude fat | 12% |
| Crude ashes | 7% |
| Crude fibre | 3% |
| Humidity | 9% |
| Ca | 1.0% |
| P | 0.8% |

### Vitamins

| | | |
|---|---|---|
| Vitamin A | 20000 | IU/kg |
| Vitamin D3 | 2000 | IU/kg |
| Vitamin E | 150 | mg/kg |
| Vitamin C | 100 | mg/kg |
| Vitamin B1 | 6 | mg/kg |

### Minerals

| | |
|---|---|
| I | 1 mg/kg |
| Co | 1.5 mg/kg |
| Se | 0.2 mg/kg |
| Cu | 20 mg/kg |
| Zn | 110 mg/kg |
| Fe | 100 mg/kg |

### Fatty Acids

| | |
|---|---|
| Omega 3 | 1.8 g/kg |
| Omega 6 | 14 g/kg |

Metabolic energy value 3800 kcal/kg

### Daily Feeding Amounts (Gram Per Day)

| | Dog weight, kg | | | | | | | | |
|---|---|---|---|---|---|---|---|---|---|
| | 2-5 | 5-10 | 10-20 | 20-30 | 30-40 | 40-50 | 50-60 | 60-70 | 70-80 |
| Maintenance | 55-105 | 105-165 | 165-265 | 265-365 | 365-465 | 465-565 | 565-670 | 670-770 | 770-870 |
| Performance | 70-125 | 125-205 | 205-325 | 325-445 | 445-565 | 565-685 | 685-830 | 830-920 | 920-1030 |

### Example 12

### Functional Probiotic Food for Ageing Dogs

### Ingredients

Chicken, maize, rice, animal fat, chicken protein, maize gluten, vegetable pulp, yeast, egg, fish oil, linseed, hydrolyzed crustaceans, hydrolyzed cartilage, yucca extract, FOS, lecithin, vitamins & minerals, no colorants. Antioxidant: according to EU regulations.

Product contains Enterococcus faecium NCIMB 10415 EC No. 13 (E1707 (new classification)) (registered in EU for use in dogs) viable probiotic strain with average concentration of 10⁹ CFU/kg respectively in complete feed.

Enterococcus faecium is a scientifically investigated and widely used probiotic culture that is added to food to exert beneficial effects on the host by regulating the host intestinal microbial balance.

### Effects and Benefits

### Soothes the Gut

Balanced content of SENIOR helps to soothe the ageing dog intestine.

### Improves Digestion

Metabolic activity of Enterococcus faecium bacteria increases digestibility rate of intestinal tract by production of enzymes, vitamins and lactic acid.

### Antimicrobial Effect

Competitive exclusion for space with bacteriocins and lactic acid production by Enterococcus faecium helps to avoid contamination and reproduction of harmful and pathogenic bacteria.

### Reduces Stress

Lactic acid produced by Enterococcus faecium lowers pH level and as a result reduces the effects of stress.

### Average Nutrient Content

### Composition

| | |
|---|---|
| Crude protein | 22% |
| Crude fat | 10% |
| Crude ashes | 6.5% |
| Crude fibre | 3% |
| Humidity | 9% |
| Ca | 1.1% |
| P | 0.8% |

### Vitamins

| | | |
|---|---|---|
| Vitamin A | 15000 | IU/kg |
| Vitamin D3 | 1500 | IU/kg |
| Vitamin E | 100 | mg/kg |
| Vitamin C | 70 | mg/kg |
| Vitamin B1 | 6 | mg/kg |

### Minerals

| | |
|---|---|
| I | 1 mg/kg |
| Co | 1.2 mg/kg |
| Se | 0.3 mg/kg |
| Cu | 15 mg/kg |
| Zn | 100 mg/kg |
| Fe | 100 mg/kg |

### Fatty Acids

| | |
|---|---|
| Omega 3 | 2 g/kg |
| Omega 6 | 23 g/kg |

Metabolic energy value 3600 kcal/kg

### Daily Feeding Amounts (Gram Per Day)

| | Dog weight, kg | | | | | | | | |
|---|---|---|---|---|---|---|---|---|---|
| | 2-5 | 5-10 | 10-20 | 20-30 | 30-40 | 40-50 | 50-60 | 60-70 | 70-80 |
| Maintenance | 50-100 | 100-160 | 160-260 | 160-260 | 360-460 | 460-560 | 560-660 | 660-760 | 760-860 |

### Example 13

### Functional Probiotic Food for Puppies from 5 Weeks to 6-9 Months of Age

### Ingredients

Chicken, lamb, fish, rice, maize, animal fat (chicken), maize gluten, egg, vegetable pulp, chicken protein, yeast, fish oil, yucca extract, inulin, hydrolyzed crustaceans, hydrolyzed cartilage, lecithin, FOS, vitamins & minerals, no colorants.

Antioxidant: according to EU regulations. Product contains Enterococcus faecium NCIMB 10415 EC No. 13 (E1707 (new classification)) (registered in EU for use in dogs) viable probiotic strain with average concentration of 10⁹ CFU/kg respectively in complete feed.

Enterococcus faecium is a scientifically investigated and widely used probiotic culture that is added to food to exert beneficial effects on the host by regulating the host intestinal microbial balance.

### Effects and Benefits

### Establishes Balanced Microflora

Since early age, while puppies intestine is relatively sterile PUPPY establishes the balanced and beneficial microflora in the gut.

### Develops Immunity

Enterococcus faecium stimulates antibody production and increases macrophage activity that helps to develop immunity.

### Improves Digestion

Metabolic activity of Enterococcus faecium bacteria increases digestibility rate of intestinal tract by production of enzymes, vitamins and lactic acid.

### Reduces Stress

Lactic acid produced by Enterococcus faecium lowers pH level and as a result reduces the effects of stress.

### Reduces Diarrhea and Other Digestive Upsets

Metabolic activity of Enterococcus faecium bacteria increases digestibility rate of intestinal tract by producing enzymes, vitamins and lactic acid.

### Average Nutrient Content

### Composition

| | |
|---|---|
| Crude protein | 28% |
| Crude fat | 16% |
| Crude ashes | 7% |
| Crude fibre | 2.5% |
| Humidity | 9% |
| Ca | 1% |
| P | 0.9% |

### Vitamins

| | | |
|---|---|---|
| Vitamin A | 20000 | IU/kg |
| Vitamin D3 | 2000 | IU/kg |
| Vitamin E | 150 | mg/kg |
| Vitamin C | 100 | mg/kg |
| Vitamin B1 | 6 | mg/kg |

### Minerals

| | |
|---|---|
| I | 1 mg/kg |
| Co | 1.5 mg/kg |
| Se | 0.2 mg/kg |
| Cu | 20 mg/kg |
| Zn | 110 mg/kg |
| Fe | 100 mg/kg |

### Fatty Acids

| | |
|---|---|
| Omega 3 | 1.61 g/kg |
| Omega 6 | 17 g/kg |

Metabolic energy value 4100 kcal/kg

### Daily Feeding Amounts (Gram Per Day)

| Breed | 0-4 month | 4-6 month | 6-9 month |
|---|---|---|---|
| Small breeds | 30-260 | 60-280 | 20-360 |
| 0-20 kg | | | |
| Medium breeds | 200-500 | 260-530 | 350-400 |
| 20-50 kg | | | |
| Big breeds | 350-600 | 500-630 | 650 |
| >50 kg | | | |

### Example 14

### Functional Probiotic Food or Adult Dogs with Active Lifestyle

### Ingredients

Chicken, maize, rice, animal fat, chicken protein, vegetable pulp, yeast, maize gluten, fish, egg, fish oil, yucca extract, hydrolyzed crustaceans, hydrolyzed cartilage, FOS, lecithin, vitamins & minerals, no colorants. Antioxidant: according to EU regulations.

Product contains Enterococcus faecium NCIMB 10415 EC No. 13 (E1707 (new classification)). (registered in EU for use in dogs) viable probiotic strain with average concentration of 10⁹ CFU/kg respectively in complete feed.

Enterococcus faecium is a scientifically investigated and widely used probiotic culture that is added to food to exert beneficial effects on the host by regulating the host intestinal microbial balance.

### Effects and Benefits

### Restores Energy Levels

Probiotic activity increases the intake of nutritional compounds with extra sources of energy to meet all the demands of the dog with active lifestyle.

### Increases Vitality

With probiotic effect, consumption of ADULT PLUS reduces the effects of stress, maintains good condition of the animal and helps the organism to achieve the top state of health and mood.

### Improves Digestion

Metabolic activity of Enterococcus faecium bacteria increases digestibility rate of intestinal tract by producing enzymes, vitamins and lactic acid.

### Maintains Good Skin and Coat Condition

Consumption of probiotics decreases risk of irritations or allergic reactions therefore helps to maintain healthy skin and shiny coat.

### Average Nutrient Content

### Composition

| | |
|---|---|
| Crude protein | 27% |
| Crude fat | 15% |
| Crude ashes | 7% |
| Crude fibre | 2.8% |
| Humidity | 9% |
| Ca | 1.4% |
| P | 0.9% |

### Vitamins

| | | |
|---|---|---|
| Vitamin A | 20000 | IU/kg |
| Vitamin D3 | 2000 | IU/kg |
| Vitamin E | 150 | mg/kg |
| Vitamin C | 100 | mg/kg |
| Vitamin B1 | 6 | mg/kg |

### Minerals

| | |
|---|---|
| I | 1 mg/kg |
| Co | 1.5 mg/kg |
| Se | 0.2 mg/kg |
| Cu | 20 mg/kg |
| Zn | 110 mg/kg |
| Fe | 100 mg/kg |

### Fatty Acids

| | |
|---|---|
| Omega 3 | 2 g/kg |
| Omega 6 | 20 g/kg |

Metabolic energy value 4000 kcal/kg

### Daily Feeding Amounts (Gram Per Day)

| | Dog weight, kg | | | | | | | | |
|---|---|---|---|---|---|---|---|---|---|
| | 2-5 | 5-10 | 10-20 | 20-30 | 30-40 | 40-50 | 50-60 | 60-70 | 70-80 |
| Maintenance | 50-100 | 100-160 | 160-260 | 160-260 | 360-460 | 460-560 | 560-660 | 660-760 | 760-860 |
| Performance | 65-120 | 120-200 | 200-320 | 320-440 | 440-560 | 560-680 | 680-820 | 820-910 | 910-1010 |

### Example 15

### Functional Probiotic Food for Adult Dogs with Normal Activity to Meet all Needs of Healthy Organism

### Ingredients

Chicken, maize, rice, animal fat, chicken protein, vegetable pulp, maize gluten, yeast, egg, fish oil, linseed, yucca extract, hydrolyzed crustaceans, hydrolyzed cartilage, FOS, lecithin, vitamins & minerals, no colorants.

Antioxidant: according to EU regulations. Product contains Enterococcus faecium NCIMB 10415 EC No. 13 (E1707 (new classification)) (registered in EU for use in dogs) viable probiotic strain with average concentration of 10⁹ CFU/kg respectively in complete feed.

Enterococcus faecium is a scientifically investigated and widely used probiotic culture that is added to food to exert beneficial effects on the host by regulating the host intestinal microbial balance.

### Effects and Benefits

### Increases Vitality

With probiotic effect, consumption of ADULT PLUS reduces the effects of stress, maintains good condition of the animal and helps the organism to achieve the top state of health and mood.

### Improves Digestion

Metabolic activity of Enterococcus faecium bacteria increases digestibility rate of intestinal tract by producing enzymes, vitamins and lactic acid.

### Maintains Strong Immunity

Enterococcus faecium helps to maintain strong immunity by increasing antibody production and stimulating macrophage activity.

### Maintains Good Skin and Coat Condition

Consumption of probiotics decreases risk of irritations or allergic reactions therefore helps to maintain healthy skin and shiny coat.

### Average Nutrient Content

### Composition

| | |
|---|---|
| Crude protein | 24% |
| Crude fat | 14% |
| Crude ashes | 7% |
| Crude fibre | 3% |
| Humidity | 9% |
| Ca | 1.2% |
| P | 0.9% |

### Vitamins

| | |
|---|---|
| Vitamin A | 20000 IU/kg |
| Vitamin D3 | 2000 IU/kg |
| Vitamin E | 150 mg/kg |
| Vitamin C | 100 mg/kg |
| Vitamin B1 | 6 mg/kg |

### Minerals

| | |
|---|---|
| I | 1 mg/kg |
| Co | 1.5 mg/kg |
| Se | 0.2 mg/kg |
| Cu | 20 mg/kg |
| Zn | 110 mg/kg |
| Fe | 100 mg/kg |

### Fatty Acids

| | |
|---|---|
| Omega 3 | 1.8 g/kg |
| Omega 6 | 18.5 g/kg |

Metabolic energy value 3920 kcal/kg

### Daily Feeding Amounts (Gram Per Day)

| | Dog weight, kg | | | | | | | | |
|---|---|---|---|---|---|---|---|---|---|
| | 2-5 | 5-10 | 10-20 | 20-30 | 30-40 | 40-50 | 50-60 | 60-70 | 70-80 |
| Maintenance | 50-100 | 100-160 | 160-260 | 160-260 | 360-460 | 460-560 | 560-660 | 660-760 | 760-860 |
| Performance | 65-120 | 120-200 | 200-320 | 320-440 | 440-560 | 560-680 | 680-820 | 820-910 | 910-1010 |

### Example 16

### Trial Information

### Setup of the Trial-Panel

Eight dogs were selected based on specific individual health problems. The nature of their disease, which was determined by the veterinary, was the main criteria of the selection of these dogs

### Time Schedule of the Trials

The selected panel received only the kibbles described in Example 11 for the entire duration of the 5 week testing period.

### Controls During Trials

For the entire duration of the trials the following people have checked that the protocol was exactly executed:

### Veterinarian

Full check-up of all the dogs before the trials started
Determination of the possible disease
Every week 3 complete health check-ups have been done on all dogs
Evaluation of the faeces during the entire period of the trials
Control of the check-lists
Evaluation of skin condition
Evaluation of coat condition
Evaluation of vitality level
Taking pictures of dogs and all visual aspects of the trials

### Official Investigators

Feeding-method was checked daily by official investigators
Weighing of feed and faeces was done by official controllers under supervision of the veterinarian.
All data is filled into the appropriate forms by the investigators.

### Statistical Analysis:

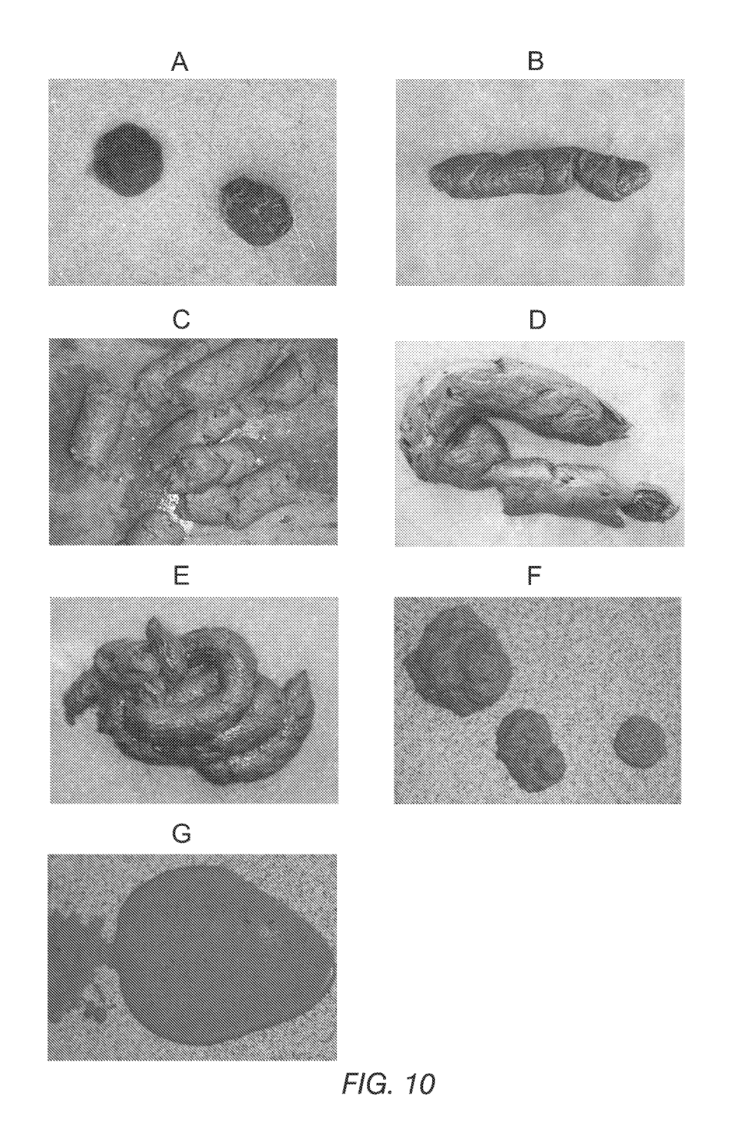

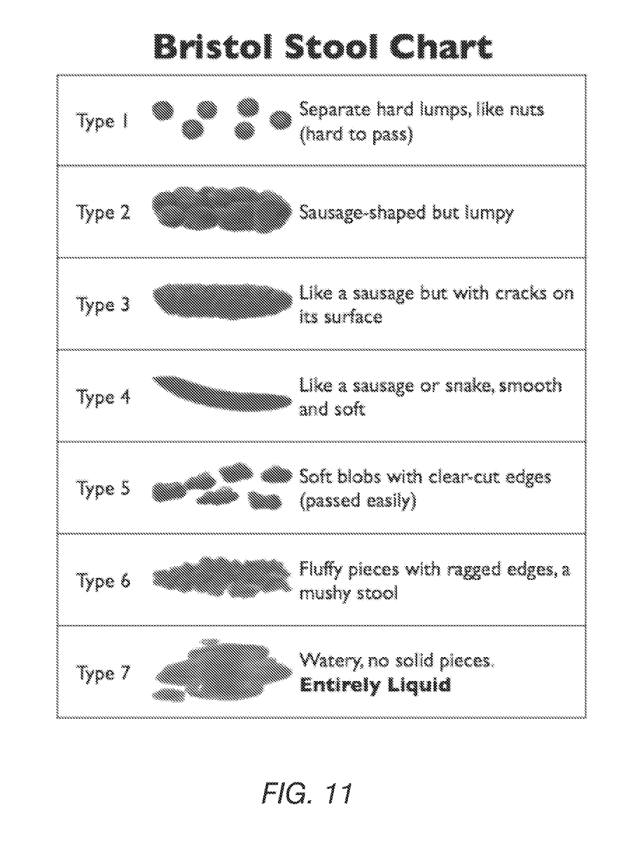

The following aspects were checked during this test
Faeces quality: based on the quotation system of Proplan—Purina. The Bristol Stool Chart is similar to this quotation system (FIGS. 10 and 11)
General health improvement
Skin condition
Coat condition
Behaviour
Vitality

### Results Chart

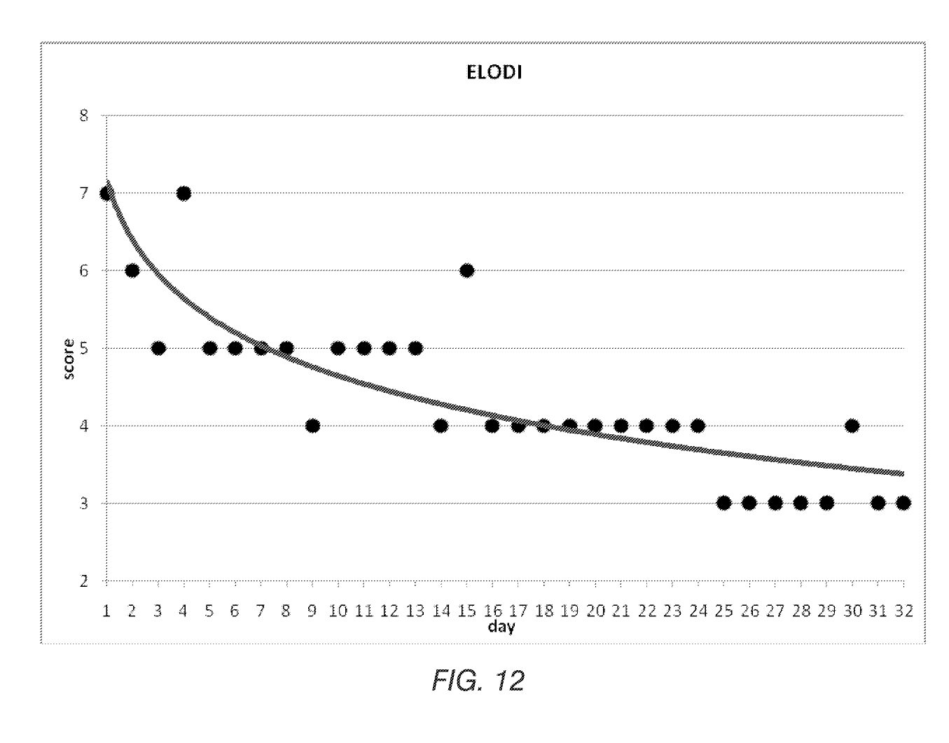

Charts are made from all the obtained faeces scores per dog (FIGS. 12-19)
Logarithmic trend line represents the faeces consistency change in time.

Dog No. 1—Elodi

Pre-trial period

| | |
|---|---|
| Breed: | Boxer |
| Gender: | female |
| Age: | 3 years |
| Weight: | 22 kg |
| Stools rating: | 6-7 |
| Standard food: | Crok 23/11 United Petfood |
| General condition: | Good |

### Veterinarian Comment

This dog had a very poor faeces quality. The dog had a normal weight and has no problems maintaining it. From time to time the dog has blood in the faeces.

After the check-up the cause of the diarrhea was determined as stress diarrhea.

### Test Results (Faeces Quotation in FIG. 12)

The dog was fed with a feeding rate: 200 gr. in the morning and 200 gr. in the evening.

### Conclusion

FIG. 12 shows a clear improvement of the quality of the faeces during the trial period. After 20 days of feeding the Formula Probiotic Sensitive (Example 11) the faeces of the dog was almost optimal and stayed like this until the end of the trial.

The weight of the dog remained the same for the entire feeding period.

The living conditions of the dog have not been altered during the test to avoid a change in the stress situation of the dog. This leads to the conclusion that the dog has overcome his problem of stress diarrhea thanks to the Formula Probiotic Sensitive.

### Additional Info

Sample IgA in μg/g faeces end of test period: 12.98

Dog No. 2—Galicia

Pre-trial period

| | |
|---|---|
| Breed: | Boxer |
| Gender: | female |
| Age: | 9 months |
| Weight: | 23 kg |
| Stools rating: | 5-6 |
| Standard food: | Crok 23/11 United Petfood |
| General condition: | Very large dog with a good health |
| | although it is a little too skinny. |

### Veterinarian Comment

This dog eats an average of 800 gr per day of her standard food and is still underweight. Until the age of 8 months this dog was eating Europremium Junior. The dog had almost continuously diarrhea. From the 8th month on the breeder switched to the adult food which the dog was still receiving up to the date of the trial. Since the switch, the dog was taking on weight but still had very frequent diarrhea.

The general diagnose of the dog: bad digestive system and possible food intolerance which causes problems to take the energy out of the food.

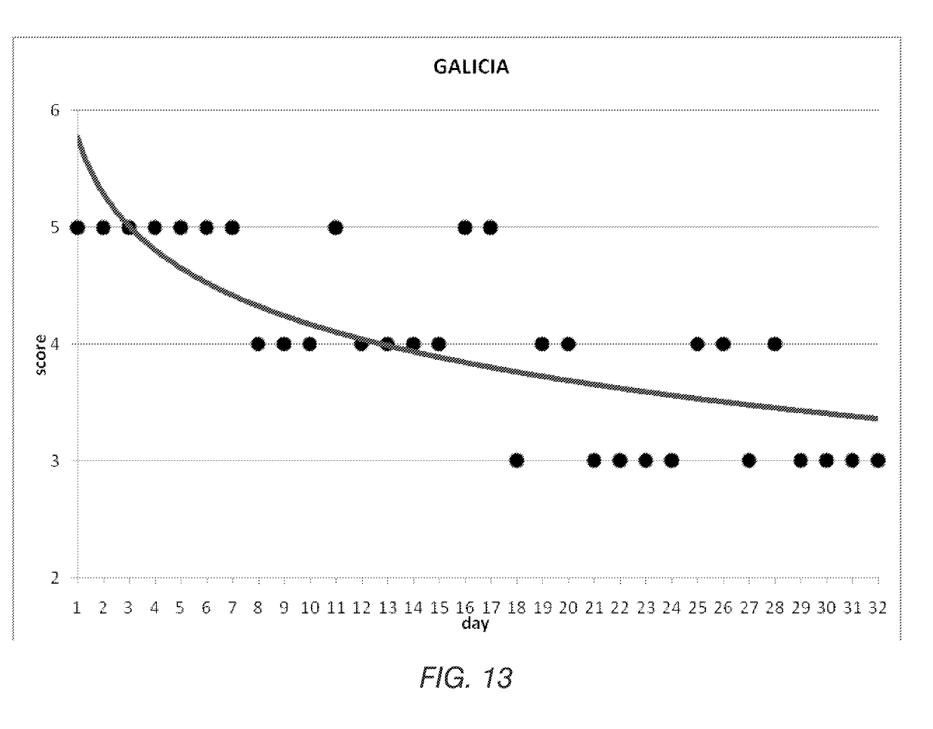

### Test Results (Faeces Quotation in FIG. 13)

The dog was fed with a feeding rate: 250 gr in the morning and 250 gr in the evening. The feeding quantity per day was changed on the 11th day, since the dog was still losing weight. From the 11th day the dog received 2 times 300 gr/day instead of 2 times 250 gr/day.

### Conclusion

FIG. 13 shows that the quality of the faeces improved from 5 to 3 in 16 days. After the 16th day it reaches the 3 level, with a few exceptions. The feeding with Formula Probiotic Sensitive (Example 11) can be given as the reason of this improvement since the living situations of this dog did not change during the trial period. The change in the result can also be linked to the fact that the dog was given a larger quantity of food per day since the improvement started to show on the 12th day, or one day after the changing of the daily feeding quantity.

After the trial period the weight of the dog went up to 25 kg, which gives the dog a better general condition. This leads to conclude that the digestive problem was solved thanks to the use of Formula Probiotic Sensitive (Example 11).

### Additional Information

Sample IgA in μg/g faeces end of test period: 44.18

Dog No. 3—Georges

Pre-trial period

| | |
|---|---|
| Breed: | Boxer |
| Gender: | Male |
| Age: | 9 months |
| Weight: | 24 kg |
| Stools rating: | 5 |
| Standard food: | Crok 25/12 United Petfood + |
| | Duck (frozen meat) |
| General conditions: | Good when the dog receives |
| | the additional frozen meat. |

### Veterinarian Comment:

The dog had chronic diarrhea before he received the additional frozen meat. The additional food gave the dog a more stable stool, but still at a level 5. The dog received before the test 1 kg of frozen meat and 200 gr Crok 25/12 per day.

The diagnoses showed stress diarrhea and food intolerance. The dog is also underweight. His optimal weight should be 28 to 30 kg.

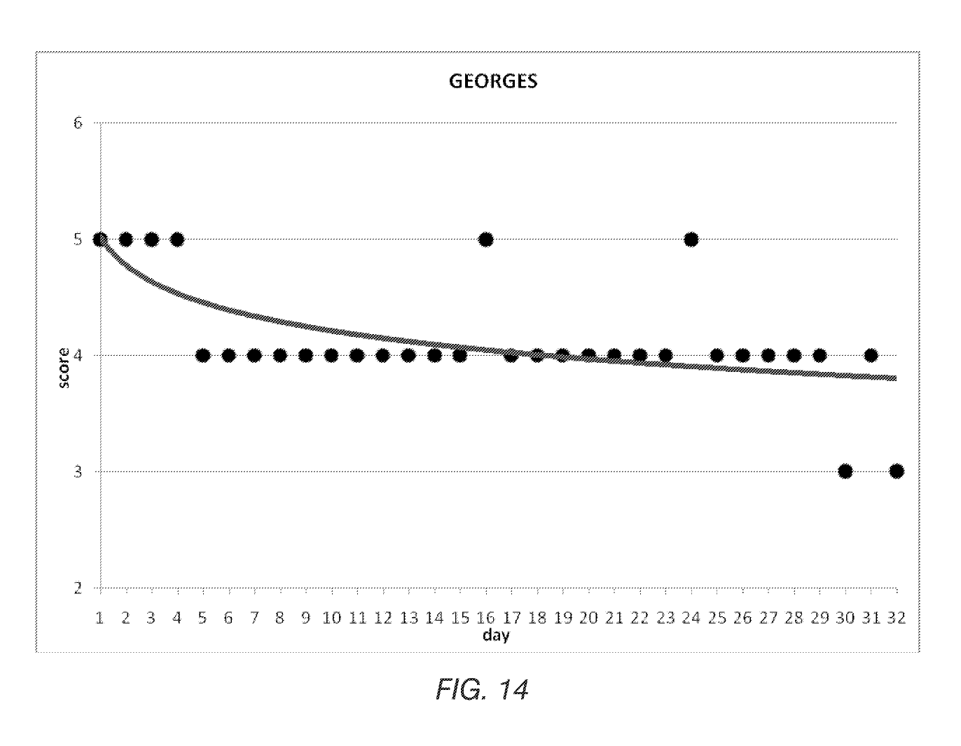

### Test Results (Faeces Quotations in FIG. 14)

The dog was fed with a feeding rate: 250 gr/day in the morning and 250 gr/day in the evening

### Conclusion

FIG. 14 shows that after only 4 days an improvement of the faeces quality was established. The dog went from level 5 to level 4. But even more spectacular was the fact the dog went from a daily feeding of 1.25 kg (frozen meat and dry petfood combined) to a 500 gr portion per day of the Formula Probiotic Sensitive (Example 11). Even with such a big difference of daily feeding the dog did not lose weight during the trial period. In fact, he even improved his weight with 1.5 kg.

The living conditions of the dog were not altered during the trial period. This allows us to conclude that the problem of stress diarrhea and food intolerance was solved thanks to the feeding with Formula Probiotic. As a result of the Formula Probiotic feeding the dog also gained weight, which shows that the product is well digested.

### Additional Information

Sample IgA in μg/g feces end of test period: 40.18

Dog No. 4—Esteban

Pre-trial period

| | |
|---|---|
| Breed: | Boxer |
| Gender: | male |
| Age: | 3 years |
| Weight: | 33 kg |
| Stools rating: | 4 |
| Standard food: | Crok 25/12 United Petfood |
| General condition: | Good |

### Veterinarian Comment:

This dog ate 900 gr/day of his standard food to maintain a good weight according to his size. The quality of the faeces is acceptable. Esteban is a large size dog, which partially explains his bigger nutritional needs compared to other Boxer dogs. Reducing his feeding quantity affects his general condition.

The diagnoses showed a possible digestive problem, which causes the dog to need large quantities of food to be able to meet his nutritional requirements. The dog is very active even when he is in his kennel.

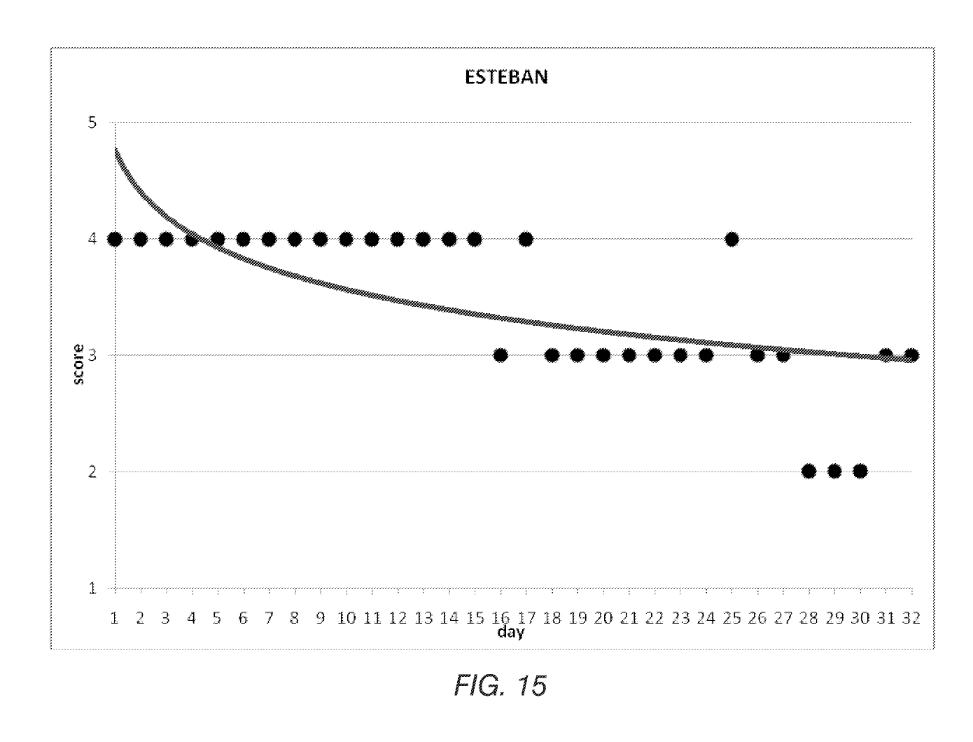

### Test Results (Faeces Quotation in FIG. 15)

The dog was fed with a feeding rate: 250 gr in the morning and 250 gr in the evening.

The feeding quantity was dropped from 900 gr/day of his standard food to 500 gr/day of the Formula Probiotic Sensitive (Example 11). On the 15th day the feeding quantity was changed to 600 gr/day since the dog was losing weight. From that moment on the dog went back to his normal weight after a period of one week.

### Conclusion

FIG. 15 shows no difference in the faeces quality during the first 15 days. Its only when the feeding quantity is set to a higher level that an improvement of the faeces quality can be seen.

The feeding with the Formula Probiotic Sensitive (Example 11) solved the digestive problem of this dog, since he can now meet his nutritional requirements with 30% less food. The level of activity of this dog changed also during the trials, the dog was calmer at the end of the trial. This could mean that the dog was active before the trial due to a feeling of hunger.

### Additional Information

Sample IgA in μg/g feces end of test period: 207.58

Dog No. 5—Doyka

Pre-trial period

| | |
|---|---|
| Breed: | Malinois Sheppard |
| Gender: | female |
| Age: | 4 years |
| Weight: | 25 kg |
| Stools rating: | 4 |
| Standard food: | Proplan Salmon & Rice |
| General condition: | good |

### Veterinarian Comment

The diagnoses showed possible small intestine diarrhea, which causes the dog to have soft stools. Also in case of stress the dog has stress diarrhea. The breeder was aware of this problem and was able to reduce it with Proplan Salmon & Rice, if the dog receives another food he has diarrhea.

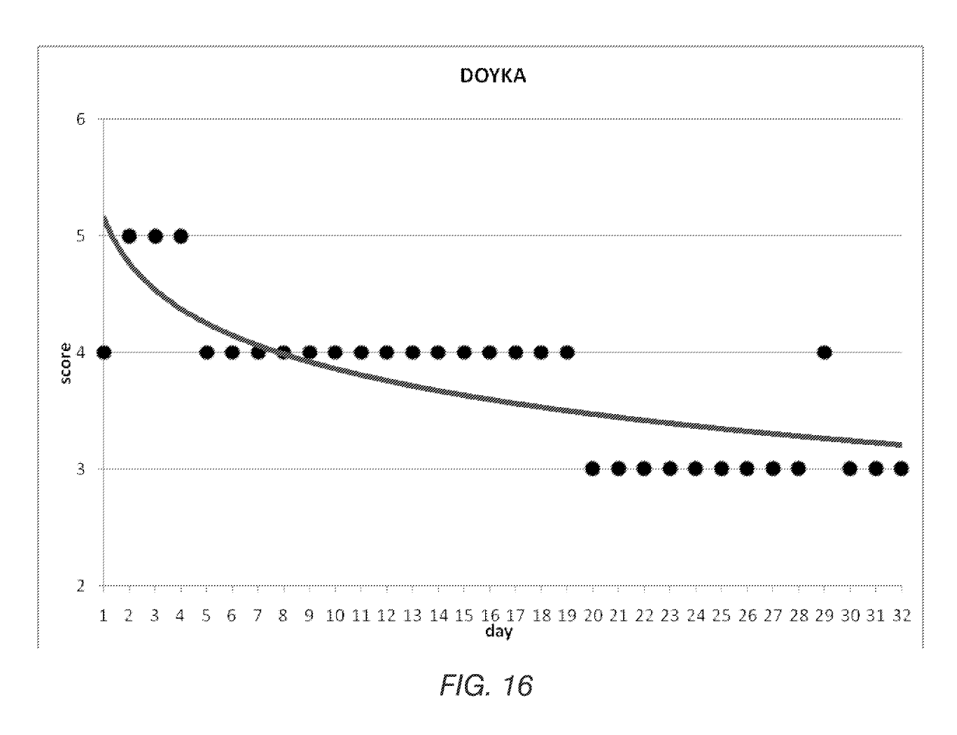

### Test Results (Faeces Quotation in FIG. 16)

The dog was fed with a feeding rate: 400 gr in the morning and 400 gr in the evening.

During the first 4 days of the feeding with Formula Probiotic Sensitive (Example 11), the dog has a very light reaction to the food. Comments from the breeder indicate that such a light reaction is exceptional for this dog.

After 18 days of feeding we see slight improvement from level 4 to level 3.

### Conclusion

The data in FIG. 16 show no difference in the faeces quality during the first 15 days. The consistency is completely stable with a mild improvement form the 18th day.

The feeding with the Formula Probiotic Sensitive gave the same result as with the Proplan Salmon & Rice. The living conditions of this dog didn't change during the trials, so we can conclude that Formula Probiotic Sensitive provides the adequate solution for the small intestine diarrhea.

### Additional Information

Sample IgA in μg/g feces end of test period: 20.28

Dog No. 6—Grisa

Pre-trial period

| | |
|---|---|
| Breed: | Malinois Sheppard |
| Gender: | female |
| Age: | 2 years |
| Weight: | 26 kg |
| Stools rating: | 6 |
| Standard food: | Duck frozen meat |
| General condition: | good |

### Veterinarian Comment:

The diagnoses showed a possible small intestine diarrhea, which causes the dog to have very soft stools. Also in case of stress the dog has stress diarrhea. The breeder was aware of this problem and tried to solve the problem with Proplan Salmon & Rice, but he changed it to Duck frozen meat. Even with this type of food he still had level 6 stools.

The fact that the breeder switched to frozen meat as diet for this dog also indicates bad digestive system which causes the dog to have problems digesting dry petfood

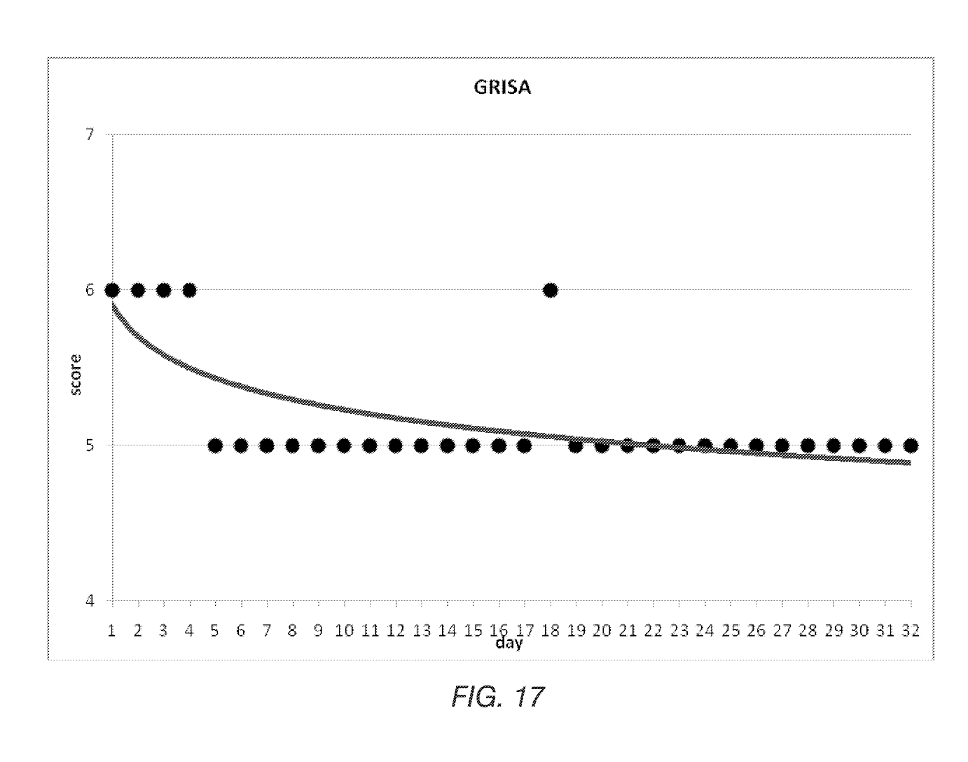

### Test Results (Faeces Quotation in FIG. 17)

The dog was fed with a feeding rate: 400 gr in the morning and 400 gr in the evening.

Transferring a dog from a frozen meat diet to a dry petfood diet can lead to digestive problems. But in the case of this dog we see no reaction. After 4 days of feeding the dog with Formula Probiotic we can even see a small improvement on the feces quality, from level 6 to level 5.

### Conclusion

The transfer of the frozen meat diet to the Formula Probiotic Sensitive was done successfully (FIG. 17). The product had a better result than when the dog was given Proplan Salmon & Rice. Even with Formula Probiotic Sensitive it was not possible to improve the stools to an acceptable level. The living conditions of this dog did not change during the trials, so it can be concluded that Formula Probiotic Sensitive provides a solution for the small intestine diarrhea.

That the stools improved only with one level can be due to the bad digestive system of the dog. An extra reason for the less good stool quality can be the fact that the dogs eats very quickly, which leads to a bad intake of the food.

As general conclusion it can be stated that the Formula Probiotic Sensitive was the first dry petfood which gave an acceptable result on the dog.

### Additional Information

Sample IgA in μg/g feces end of test period: 167.38

Dog No. 7—Gripala

Pre-trial period

| | |
|---|---|
| Breed: | Malinois Sheppard |
| Gender: | male |
| Age: | 1 year |
| Weight: | 24 kg |
| Stools rating: | 6-7 |
| Standard food: | Duck frozen meat + rice |
| General condition: | Good, occasional diarrhea |

### Veterinarian Comment:

The diagnoses showed a possible small intestine diarrhea, which is occurring occasionally. It is also linked to stress situations, since the dog is only in the kennel since 2 months, stress diarrhea. The weight of this dog is correct according to his size. This dog received the frozen meat diet as a precaution.

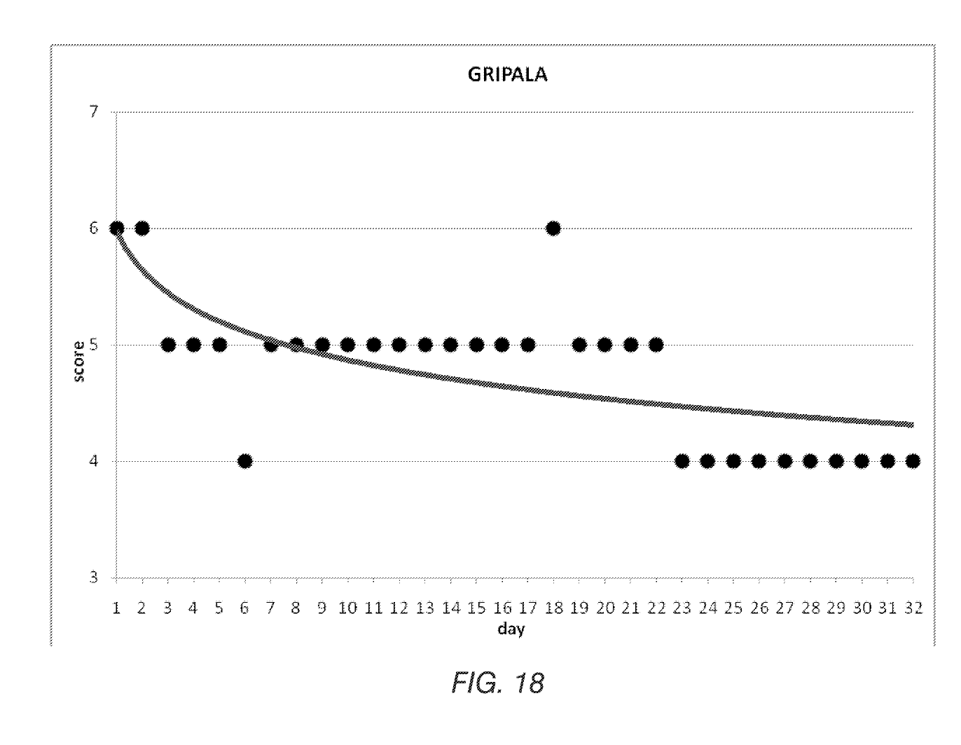

### Test Results (Faeces Quotation in FIG. 18)

The dog was fed with a feeding rate: 400 gr in the morning and 400 gr in the evening.

Transferring a dog from a frozen meat diet to a dry petfood diet can lead to digestive problems. But in the case of this dog we see no reaction. After 2 days of feeding the dog with Formula Probiotic we can even see a small improvement on the faeces quality, from level 7 to level 6 and even further to level 5.

### Conclusion

The transfer of the frozen meat diet to the Formula Probiotic Sensitive was done successfully (FIG. 18).

The living conditions of this dog didn't change during the trials, so we can conclude that Formula Probiotic Sensitive provides a solution for the small intestine diarrhea.

That the stools improved only with one or two levels can be due to the fact that the dog is very nervous. According to the veterinarian the dog has also problems linked to his status within his new living environment.

As a general conclusion we can state the Formula Probiotic Sensitive offers the necessary comfort to the dog to provide with stable faeces during his adapting period.

### Additional Information

Sample IgA in μg/g feces end of test period: 23.88

Dog No. 8—Weimie

Pre-trial period

| | |
|---|---|
| Breed: | Weimaraner |
| Gender: | female |
| Age: | 1 year |
| Weight: | 22 kg |
| Stools rating: | 6 |
| Standard food: | Crok 23/11 United Petfood |
| General condition: | good |

### Veterinarian Comment:

The diagnoses showed chronically stress diarrhea. The dog has a very nervous character. The weight of the dog is a little low, the perfect weight for this type of dog should be 26 to 28 kg. This can indicate also a bad digestive system due to stress.

Skin and coat condition is rather low. The dog has no shiny coat; this can be explained with the bad digestive system, which causes a loss of the nutritional values of the food.

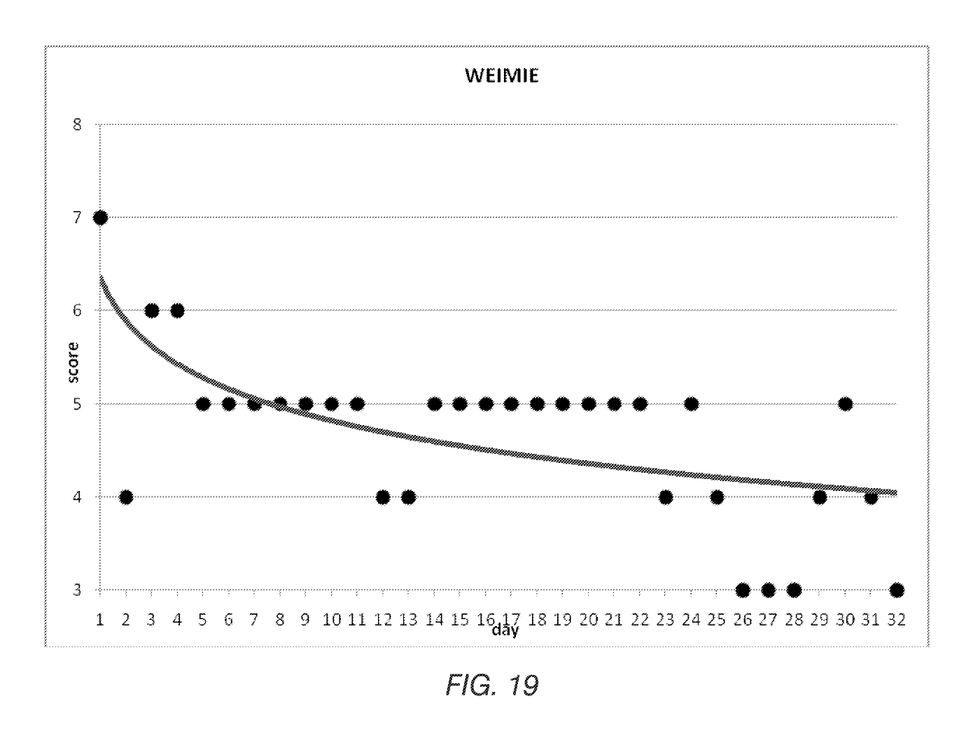

### Test Results (Faeces Quotation in FIG. 19)

The dog was feed with a feeding rate: 350 gr per day

These data show a very quick response to the Formula Probiotic Sensitive. Starting from the first day, the dog shows a clear improvement of his faeces quality. From the 5th day on the dog comes to level 5 stools. From the 20th day on we can register an even better stool quality with a best of level 3.

### Conclusion

The transfer from his normal diet to Formula Probiotic Sensitive was done without any problems (FIG. 19). The improvement of the stools started from the first day of admission. From the 20th day we also see an improvement of the stools quality towards level 3. If the dog continues the Formula Probiotic diet, we feel that the level 3 stools could become the normal stools.

The weight of the dog increased after 15 days, to end after the complete trial at a weight of 24.5 kg. We can conclude that if the feeding with Formula Probiotic Sensitive would continue, the dog could reach his perfect weight (26 kg) within a period an extra month. The gain in weight shows also that the dog is now able to take all the nutritional value out of his diet. Skin and coat quality improved drastically. The dog had a shiny coat after 20 days of feeding him with Formula Probiotic Sensitive. The living conditions of this dog didn't change during the trials, so we can conclude that Formula Probiotic Sensitive provides a solution for all the problems which this dog had.

### Additional Information

Sample IgA in μg/g faeces end of test period: not tested

### General Conclusions

In the attempt to prove the health effect of the Formula Probiotic these trials were based on the following diseases and symptoms:

### Diarrhea

Several dogs which were used in these trials were diagnosed with diarrhea. The purpose was to prove the effect of the probiotic ingredient on the intestinal flora of these dogs and so prove that we could improve the faeces quality

### Stress Diarrhea

The effect of Formula Probiotic on stress diarrhea has been proven through different dogs, where we were able to improve drastically the faeces quality. Stress diarrhea is very common with dogs which are living in breeding farms or dogs which are participating in competitions.

### Chronic Diarrhea

The reason of chronic diarrhea is often a food intolerance which leads to a bad digestive system. These are very common problems with modern dogs, especially when they are pure breed. During these trials we solved almost all the problem cases.

### Food Intolerance

It is only when we have a food intolerance towards one ingredient that the probiotic ingredient is not sufficient. To be able to prove the effect on food intolerance we advice to make a selection of dogs, where the allergy has been determined without any doubt.

### Bad Digestive System

There are several breeds of dogs which have a bad digestive system. The main breeds where this problem occurs are for example the Sheppard breeds, the Bulldog and Boxers. For this reason these dogs were all included in the trails. These dogs have a short digestive system, which causes them to have problems to digest completely the given food.

As we have seen through these test results, the probiotic ingredient helps these dogs to digest better there food. It also allows the dog owner to give lesser quantities of the food. So we can conclude that the nutritional rentability of the food given to the dog is much higher.

### Skin Problems

The main cause of skin problems is immunity deficiency. The first result on a dog with a low immunity level is the poor skin quality.

The results of these trials show that the probiotic ingredient cannot take away an actual disease such as demodex. But we were able to reduce the symptoms and the inconvenience for the dog.

When we look to the overall state of the skin and coat of the different dogs which participated in these trails, we can conclude that all dogs showed a better skin and coat quality at the end of the trials.

### Vitality Problems

Dogs with a low immunity level show a low vitality level. The problem is here that it is close to impossible to measure the level of vitality of a dog. For this result we had to rely on the opinion of the breeder.

The overall opinion of the several breeders which participated in these trials was that the vitality of the dogs was good. On the dog which received only half of his daily feeding, thanks to the Formula Probiotic, we were able to see a significant improvement of his vitality.

Trial results table

| | ELODI | GALICIA | ESTEBAN | GEORGES | DOYKA | GRISA | GRIPALA | WEIMIE |
|---|---|---|---|---|---|---|---|---|
| day | score | score | score | score | score | score | score | score |
| 1 | 7 | 5 | 4 | 5 | 4 | 6 | 6 | 7 |
| 2 | 6 | 5 | 4 | 5 | 5 | 6 | 6 | 4 |
| 3 | 5 | 5 | 4 | 5 | 5 | 6 | 5 | 6 |
| 4 | 7 | 5 | 4 | 5 | 5 | 6 | 5 | 6 |
| 5 | 5 | 5 | 4 | 4 | 4 | 5 | 5 | 5 |
| 6 | 5 | 5 | 4 | 4 | 4 | 5 | 4 | 5 |
| 7 | 5 | 5 | 4 | 4 | 4 | 5 | 5 | 5 |
| 8 | 5 | 4 | 4 | 4 | 4 | 5 | 5 | 5 |
| 9 | 4 | 4 | 4 | 4 | 4 | 5 | 5 | 5 |
| 10 | 5 | 4 | 4 | 4 | 4 | 5 | 5 | 5 |
| 11 | 5 | 5 | 4 | 4 | 4 | 5 | 5 | 5 |
| 12 | 5 | 4 | 4 | 4 | 4 | 5 | 5 | 4 |
| 13 | 5 | 4 | 4 | 4 | 4 | 5 | 5 | 4 |
| 14 | 4 | 4 | 4 | 4 | 4 | 5 | 5 | 5 |
| 15 | 6 | 4 | 4 | 4 | 4 | 5 | 5 | 5 |
| 16 | 4 | 5 | 3 | 5 | 4 | 5 | 5 | 5 |
| 17 | 4 | 5 | 4 | 4 | 4 | 5 | 5 | 5 |
| 18 | 4 | 3 | 3 | 4 | 4 | 6 | 6 | 5 |
| 19 | 4 | 4 | 3 | 4 | 4 | 5 | 5 | 5 |
| 20 | 4 | 4 | 3 | 4 | 3 | 5 | 5 | 5 |
| 21 | 4 | 3 | 3 | 4 | 3 | 5 | 5 | 5 |
| 22 | 4 | 3 | 3 | 4 | 3 | 5 | 5 | 5 |
| 23 | 4 | 3 | 3 | 4 | 3 | 5 | 4 | 4 |
| 24 | 4 | 3 | 3 | 5 | 3 | 5 | 4 | 5 |
| 25 | 3 | 4 | 4 | 4 | 3 | 5 | 4 | 4 |
| 26 | 3 | 4 | 3 | 4 | 3 | 5 | 4 | 3 |
| 27 | 3 | 3 | 3 | 4 | 3 | 5 | 4 | 3 |
| 28 | 3 | 4 | 2 | 4 | 3 | 5 | 4 | 3 |
| 29 | 3 | 3 | 2 | 4 | 4 | 5 | 4 | 4 |
| 30 | 4 | 3 | 2 | 3 | 3 | 5 | 4 | 5 |
| 31 | 3 | 3 | 3 | 4 | 3 | 5 | 4 | 4 |
| 32 | 3 | 3 | 3 | 3 | 3 | 5 | 4 | 3 |

Scoring System (FIG. 10)

| Score | Feces quality |
|---|---|
| 1 | Very hard and dry, no residue left on the ground when picked up. |
| 2 | Firm, not hard. Little residue left on the ground when picked up. |
| 3 | Log-like, moist surface, leaves residues but holds form when |
| | picked up |
| 4 | Very moist, long shape leaves residues and loses form if picked up. |
| 5 | Very moist, present in piles, distinct shape, leaves residues |
| | and loses form if picked up. |
| 6 | No defined shape, but has texture, occurs as spot or pile, leaves |
| | residues if picked up. |
| 7 | No texture, watery, flat, occurs as puddles |

### Example 17

A dog was fed with a kibble of the present invention in a trail and the following was stated:
“The dog has a very sensitive stomach and has only been fed moist “intestinal products”
“The dog is doing much better with your dry food now and likes it very much.”

### Example 18

Two dogs were fed with a kibble of the present invention in a trail and the following was stated:
“I have two dogs, both German Shorthaired Pointers, the younger one will be four in November has had digestive problems since birth. Over the years, he has suffered from skin problems, chewing his pawls, licking his skin a lot, bad body odour, bad breath, a lot of gas in his stomach and diarrhea. With some dog food, he had such a volume of waste that he had to use his bowels several times a day. We have had a lot of problems with him. With the Formula Probiotic for the younger dog, the following result was achieved:
   1. No body odor
   2. No bad breath
   3. No chewing paws or licking himself
   4. No diarrhea or large bowel movements
   5. No gas problems
   6. His energy levels are good”

### Example 19

A dog was fed with kibbles of the present invention in a trail and the following was stated:
“For our Labrador (3 years), we have tried different types of food, but the allergy on the skin did not disappear. Once we fed our dog with your probiotic food, the allergy disappeared. We were very happy.”
“Now we are back to the old food and the allergies are back as well . . . ”

### Example 20

### Comparative Studies of Changes in Purina Score

An embodiment of the present invention relates to a method wherein the positive effect on the constipation is reached in less than 3 weeks, such as less than 14 days, such as less than 13 days, less than 12 days, less than 11 days, less than 10 days, less than 9 days, less than 8 days, less than 7 days, less than 6 days, less than 5 days, less than 4 days, less than 3 days, less than 2 days, or less than 1 day.

What is claimed is:

1. A pet food comprising a mixture of at least one probiotic micro-organism and oil, wherein the pet food is vacuum coated with said mixture.

2. The pet food according to claim 1, wherein the probiotic micro-organism is freeze dried.

3. The pet food according to claim 2, wherein the at least one probiotic micro-organism comprises Enterococcus faecium or Saccharomyces cerevisiae.

4. The pet food according to claim 3, wherein the Saccharomyces cerevisiae minimal amount of the pet food is 2.5×10⁷ CFU/Kg to 7.5×10¹⁴ CFU/Kg.

5. The pet food according to claim 3, whereby the Enterococcus faecium minimal amount of the pet food is 1.0×10⁷ CFU/Kg to 1.0×10¹⁴CFU/Kg.

6. The pet food according to claim 1, wherein the mixture is a suspension comprising an oil and at least one probiotic micro-organism in the concentration of 10⁶-10¹⁶ CFU/kg of said oil, and said suspension having a dynamic viscosity of less than 0.08 pascal-second (Pa·s) at 20° C.

7. The pet food according to claim 1, wherein the oil is a fish oil selected from the group consisting of mackerel, lake trout, herring, sardine, salmon, and albacore tuna oil.

8. The pet food according to claim 7, wherein the fish oil is heated to 20° C. to 25° C.

9. A method of making the pet food of claim 1 comprising mixing the at least one probiotic micro-organism with the oil and vacuum coating the conventional pet food with the mixture.

10. The method according to claim 9 wherein the oil is heated to 20° C. to 25° C. prior to mixing.

11. The method according to claim 9 wherein the coating is carried out in a sealed environment under the pressure of 1 bar or less.

12. A production plant for making the pet food of claim 1, comprising:
a first storage tank for storing the mixture of claim 1 as a first solution, said first storage tank being connected to a first dosage tank for dosing the mixture of claim 1; and
a second storage tank for storing a second solution, said second storage tank being connected to a second dosage tank for dosing the second solution, wherein the first dosage tank and the second dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

13. The production plant according to claim 12, further comprising at least a third storage tank for storing a solution, said third storage tank being connected to a third dosage tank for dosing the third solution through one or more spraying nozzles.

14. The production plant according to claim 13, further comprising at least a fourth storage tank for storing a solution, said fourth storage tank being connected to a fourth dosage tank for dosing a solution through one or more spraying nozzles.

15. A production plant according to claim 1, wherein the orifice of each of the spraying nozzles has a cross-sectional area of 1-250 mm².

16. A production plant according to claim 12, further comprising a first mixing tank connected to the first storage tank through a bottom outlet in the first mixing tank, wherein the mixture is capable of being passed from the first mixing tank to the first storage tank by gravity.

17. A production plant according to claim 16, wherein the connection between the first mixing tank and the first storage tank does not comprise a vacuum suction unit.

18. A method of managing defecation in a dog comprising providing the dog with the pet food of claim 1.

19. The method according to claim 18, wherein the feces condition of the dog is changed to score 3 or 4 of the PURINA feces scoring system.

20. The method according to claim 19, wherein the change in feces consistency is reached in less than 14 days.
